(19) United States
(12) Patent Application Publication
(10) Pub. No.: US 2011/0312613 A1
(43) Pub. Date: Dec. 22, 2011

(54) CARRIERS FOR COMBINATORIAL COMPOUND LIBRARIES

(75) Inventors: Bronwyn Jean Battersby, Queensland (AU); Darryn Edward Bryant, Queensland (AU); Matt Trau, Queensland (AU)

(73) Assignee: NANOMICS BIOSYSTEMS PTY LTD, St. Lucia (AU)

(21) Appl. No.: 13/107,628

(22) Filed: May 13, 2011

Related U.S. Application Data
(62) Division of application No. 09/856,859, filed on Sep. 6, 2001, now abandoned.

(30) Foreign Application Priority Data
Nov. 30, 1998 (AU) PP7372

(51) Int. Cl. C40B 50/00

(52) U.S. Cl. 506/23

(57) ABSTRACT

A carrier pre-encoded with information sufficient to distinguish it from a heterogeneous population of carriers is disclosed on which a compound can be synthesised. The carrier has two attributes integrally associated therewith, which attributes are detectable and/or quantifiable during synthesis of the compound and which define a code identifying the carrier before, during and after said synthesis, with the proviso that one of said attributes is other than shape, or surface deformation(s) of the carrier. The invention also encompasses a plurality of carriers that are pre-encoded as above and a method of synthesising and deconvoluting a combinatorial library using such carriers.

### FIELD OF THE INVENTION

THIS INVENTION relates generally to combinatorial compound libraries. In particular, the present invention relates to carriers having distinctive codes for use in combinatorial compound synthesis as well as to combinatorial compound libraries produced with those carriers. The invention is also concerned with a novel method for structural deconvolution of a combinatorial library member.

### BACKGROUND OF THE INVENTION

Recently, there has been substantial interest in devising facile combinatorial technologies to synthesise molecular libraries of immense diversity. A major utility of such libraries is that they can be screened for various biological, pharmacological or chemical activities in the pursuit of novel lead compounds.

In essence, combinatorial technologies are predicated on systematic assembly of a collection of chemical building blocks or synthons in many combinations using chemical, biological or biosynthetic procedures. The potential number “N” of different individual library members produced by such an assembly can be calculated as a function of the number of different synthons available for each step “b” and the number of synthetic steps in the reaction scheme “x”, according to the following formula: N=b^{x}. Thus, a library of nonapeptides constructed using 20 different amino acids (i.e., the synthons) could include as many as 20⁹ or 5.1×10¹¹ different library members.

Combinatorial libraries may be assembled by a number of methods including the “split-process-recombine” or “split synthesis” method described first by Furka et al. (1988, 14th Int. Congr. Biochem., Prague, Czechoslovakia 5: 47; 1991, Int. J. Pept. Protein Res. 37: 487-493) and Lam et al. (1991, Nature 354:82-84), and reviewed later by Eichler et al. (1995, Medicinal Research Reviews 15(6): 481-496) and Balkenhohl et al. (1996, Angew. Chem. Int. Ed. Engl. 35: 2288-2337). The split synthesis method involves dividing a plurality of solid supports such as polymer beads into n equal fractions representative of the number of available synthons for each step of the synthesis (e.g., 20 L-amino acids, 4 different nucleotides etc), coupling a single respective synthon to each polymer bead of a corresponding fraction, and then thoroughly mixing the polymer beads of all the fractions together. This process is repeated for a total of x cycles to produce a stochastic collection of up to N^{x} different compounds. Thus, by employing syntheses where the coupling involves the addition of synthons such as amino acids, nucleotides, sugars, lipids or heterocyclic compounds, where the synthons may be naturally-occurring, synthetic or combinations thereof, one may create a large number of molecularly diverse compounds.

The molecular libraries so produced can then be screened for the identification of novel ligands that interact with a receptor target of interest. For any given receptor target, the probability of successfully identifying a potent ligand through a process of randomly screening molecular repertoires will undoubtedly increase as the size and structural diversity of the library is also increased. However, an inherent difficulty of producing large libraries of this type is the ability to determine the reaction history of any chosen combinatorial library member to thereby deconvolute its structure. For large numbers of solid supports and large numbers of steps and/or processing methods, this “deconvolution” procedure is particularly difficult. In many practical cases, where high throughput and fast analysis is required, this problem is intractable by conventional methods.

The conventional split synthesis technologies referred to above present difficulties when it is desired to detect and isolate a combinatorial library member of interest. In this regard, it is necessary to first cleave the member from its solid support before identifying the member by techniques such as mass spectroscopy or HPLC. This is time consuming and cumbersome and in some cases, cleavage is not possible.

A number of groups have attempted to overcome these prior art deficiencies by use of chemical encoding which relies on reactions different and orthogonal from those used in the synthesis of the combinatorial library member. For example, Janda (1994, Proc. Natl. Acad. Sci. USA 91: 10779-10785) describes a method in which each synthesis step of a combinatorial library member is followed by an independent coupling of an identifier tag to a solid support. Through a series of sequential chemical steps, a sequence of identifier tags are built up in parallel with the compounds being synthesised on the solid support. When the combinatorial synthesis is complete, the sequence of operations any particular solid support has gone through may be retraced by separately analysing the tag sequence. Accordingly, use of identifier tags in this manner provides a means whereby one can identify which synthon reaction an individual solid support has experienced in the synthesis of a combinatorial library member. The identifier tag also records the step in the synthesis series in which the solid support visited that synthon reaction. In this regard, reference may be made to International Publication WO93/06121 in which Dower et al. disclose a general stochastic method for synthesising a combinatorial compound library on solid supports from which library members may be cleaved to provide a soluble library. The identifier tag may be attached directly to a member of the library with or without an accompanying particle, to a linker attached to the member, to the solid support on which the member is synthesised or to a second particle attached to the member-carrying particle.

However, while Dower et al. (supra) refer very broadly to the types of identifier tags that may be utilised in combinatorial library formation, the only experimental evidence that they provide is the use of oligonucleotides as tags which are identifiable by sequencing or hybridisation. They also make reference to amplifying the oligonucleotide tag by PCR if only trace amounts of oligonucleotide are available for analysis. However, it will be appreciated that such identification methods are time consuming and inefficient. For example, use of PCR may result in PCR product contamination making it necessary to introduce further measures to overcome this problem as described by Dower et al. (supra). It is also necessary to sequence amplified DNA and this involves an additional step in the identification procedure.

In U.S. Pat. No. 5,721,099, Still et al. disclose a process of constructing complex combinatorial chemical libraries of compounds wherein each compound is produced by a single reaction series and is bound to an individual solid support on which is bound a combination of four distinguishable identifiers which differ from one another. The combination provides a specific formula comprising a tag component capable of analysis and a linking component capable of being selectively cleaved to release the tag component. Each identifier or combination thereof encodes information at a particular stage in the reaction series for the compound bound to the solid support. The identifiers are used in combination with one another to form a binary or higher order encoding system permitting a relatively small number of identifiers to be used to encode a relatively large number of reaction products. However, the method of Still et al. (supra) does not provide for direct identification of the tag component on the solid support. In this regard, it is essential prior to analysis of a combinatorial library that each tag component be cleaved from the support thus creating at least one additional step which is time consuming and inefficient. Accordingly, the same disadvantages relevant to the method of Dower et al. also apply to that of Still et al.

In addition to the disadvantages mentioned above, chemical encoding techniques such as those described by Junda (1994, supra), Dower et al. (supra) and Still et al. (supra) rely on parallel, orthogonal synthesis of identifier tags which adds substantially to the time taken for completion of a combinatorial synthesis and has the potential to interfere with the synthesis.

Spectrometric encoding methods have also been described in which decoding of a library member is permitted by placing a solid support directly into a spectrometer for analysis. This eliminates the need for a chemical cleavage step. For example, Geysen et al. (1996, Chem. Biol. 3: 679-688) describe a method in which isotopically varied tags are used to encode a reaction history. A mass spectrometer is used to decode the reaction history by measuring the ratiometric signal afforded by the multiply isotopically labelled tags. A disadvantage of this method is the relatively small number of multiply isotopically labeled reagents that are commercially available.

Optical encoding techniques have also been described in which a solid support's absorption or fluorescence emission spectrum is measured. For example, reference may be made to Sebestyén et al. (1993, Pept. 1992 Proc. 22nd Eur. Pept. Symp. 63-64), Campian et al. (1994, In Innovation and Perspectives on Solid Phase Synthesis Epton, R., Birmingham: Mayflower, 469-472) and Egner et al. (1997, Chem. Commun. 735-736) who describe the use of both chromophoric and/or fluorescent tags for bead labeling in peptide combinatorial synthesis. Although this use provides advantage for deconvoluting a library member's structure by simply reading a bead's absorption or fluorescence emission spectrum, the encoding of a large library would require the use of many chromophores or fluorophores where spectral superimposition would be a likely drawback.

Yamashita and Weinstock (International Publication WO 95/32425) disclose the coupling on beads of (i) fluorescently labelled tags having intensities that differ by a factor of at least 2, and/or (ii) multiple different fluorescent tags that can be used in varying ratios, to encode a combinatorial library. Such beads may be used in concert with flow cytometry to construct a series of combinatorial libraries by split synthesis procedure. In this regard, a first combinatorial library is prepared by conducting a specified set of reaction sequences on tagged beads according to (i) and (ii) to encode each choice of synthon in the first stage of combinatorial synthesis (the term “stage” corresponds to a step of a sequential synthesis of a combinatorial library member). A second combinatorial library is prepared from substantially the same specified set of reaction sequences as the first library wherein the tagged beads are combined and separated prior to the first reaction sequence and the beads are sorted prior to the second reaction sequence to encode each choice of synthon in the second stage. The sorting step is characterised in that the beads are sorted into groups of similarly tagged beads. Additional libraries are prepared according to the preparation of the second library except that the sort step is performed prior to a different stage in the combinatorial synthesis. The number of libraries constructed in the series will therefore equal to the total number of stages in the combinatorial synthesis wherein a different stage is encoded in each library. After synthesis is complete, each library is tested for biological activity and a population analysis analogous to Structure Activity Relationship (SAR) studies is conducted for each library to reveal which variable synthon(s) are important for activity and which are not. Although this method has advantages in relation to providing a lead structure, it is necessary to construct and analyse multiple libraries commensurate with the number of stages used for the combinatorial synthesis, which is cumbersome and time consuming.

Kaye and Tracey (International Publication WO 97/15390) describe a physical encoding system in which chemically inert solid particles are each labelled with a unique machine readable code. The code may be a binary code although higher codes and alphanumerics are contemplated. The code may consist of surface deformations including pits, holes, hollows, grooves or notches or any combination of these. Such deformations are applied by micromachining. Alternatively, the code may reside in the shape of the particle itself. Solid particles comprising a first phase for combinatorial synthesis and a second phase containing a machine readable code are exemplified wherein the second phase may be superimposed on, or encapsulated within, the first phase. The microscopic code on the particles may be interrogated and read using a microscope-based image capture and processing system. The encoding system of Kaye and Tracey provides advantage in that the machine readable code may be read “on-the-fly” between process steps of a combinatorial synthesis thus allowing the process sequence, or audit trail, for each bead to be recorded. However, this system suffers from a number of drawbacks in that specialised purpose-built machinery is required for producing the solid particles and for reading the code. For example, the application of code deformations onto the solid particles requires expensive micromachining technology, computer aided design (CAD) tools for designing the required particle geometry, as well as manufacture of appropriate photolithographic masks for delineating the particle shapes. In addition, there is a need to utilise specialised image processing systems and software for observing a particle from several different directions to accurately determine and verify a given code.

Many of the disadvantages of the known methods described above as well as many of the needs not met by them are addressed by the present invention, which, as described more fully hereinafter, provides numerous advantages over the above-described methods.

### SUMMARY OF THE INVENTION

According to one aspect of the invention, there is provided a carrier on which a compound can be synthesised, wherein said carrier has at least two attributes integrally associated therewith, which attributes are detectable and/or quantifiable during synthesis of the compound and which define a code identifying the carrier before, during and after said synthesis, with the proviso that one of said attributes is other than shape, or surface deformation(s) of the carrier.

Preferably, at least one of said attributes is comprised within or internally of the carrier.

Suitably, at least one of said attributes is an electromagnetic radiation-related attribute.

Preferably, the electromagnetic radiation-related attribute is selected from the group consisting of fluorescence emission, luminescence, phosphorescence, infrared radiation, electromagnetic scattering including light and X-ray scattering, light transmittance, light absorbance and electrical impedance.

Preferably, the electromagnetic radiation-related attribute is a light emitting, light transmitting or light absorbing attribute detectable by illuminating the carrier with incident light of one or more selected wavelengths or of one or more selected vectors.

In another aspect, the invention provides a plurality of carriers on which a plurality of different compounds can be synthesised, including a population of detectably distinct carriers each having a code, which distinctively identifies a respective carrier before, during and after said synthesis from other carriers, and which is characterised by at least two detectable and/or quantifiable attributes integrally associated with the carrier, with the proviso that one of said attributes is other than shape, or surface deformation(s) of the carrier.

In yet another aspect, the invention resides in a method of producing a plurality of carriers including a population having detectably distinct carriers, comprising the steps of:
(a) preparing a plurality of carriers having different codes wherein each code is characterised by at least two detectable and/or quantifiable attributes integrally associated with a respective carrier;
(b) detecting and/or quantifying the said attributes of each carrier to thereby assign a code for each carrier;
(c) identifying carriers having distinctive codes;
(d) identifying carriers having similar codes; and
(e) sorting the carriers having distinctive codes from the carriers having non-distinctive codes to thereby provide a plurality of carriers including a population having detectably distinct codes.

In yet another aspect, the invention resides in a plurality of carriers having detectably distinct codes resulting from the method as broadly described above.

In a further aspect, the invention provides a method of synthesising and deconvoluting a combinatorial library comprising the steps of:
(a) apportioning in a stochastic manner among a plurality of reaction vessels a plurality of carriers on which a plurality of different compounds can be synthesised, wherein said plurality of carriers includes a population of detectably distinct carriers each having a code, which distinctively identifies a respective carrier before, during and after said synthesis from other carriers, and which is characterised by at least two detectable and/or quantifiable attributes integrally associated with the carrier, with the proviso that one of said attributes is other than shape, or surface deformation(s) of the carrier;
(b) determining and recording the codes of said plurality of carriers in order to track the movement of individual detectably distinct carriers into particular reaction vessels of said plurality of reaction vessels, wherein said codes are determined prior to step (d);
(c) reacting the carriers in each reaction vessel with a synthon;
(d) pooling the carriers from each reaction vessel;
(e) apportioning the carriers in a stochastic manner among the plurality of reaction vessels;
(f) reacting the carriers in each reaction vessel with another synthon;
(g) recording the codes of said plurality of carriers in order to track the movement of individual detectably distinct carriers into particular reaction vessels of said plurality of reaction vessels, wherein said codes are recorded after step (e) or step (f);
(h) pooling the carriers from each reaction vessel;
(i) iterating steps (e) through (h) as necessary to create a combinatorial compound library wherein member compounds of the library are associated with the detectably distinct carriers and wherein codes of the detectably distinct carriers are deconvolutable using tracking data provided by said recordal steps to identify the sequence of reactions experienced by the said detectably distinct carriers.

The invention in yet a further aspect refers to a combinatorial compound library produced by the aforementioned method.

The invention in a still further aspect resides in a kit comprising:
(a) a combinatorial compound library including a plurality of different compounds wherein each compound is attached to at least one of a plurality of carriers, which includes a population of detectably distinct carriers each having a distinctive code, which distinctively identifies a respective carrier before, during and after synthesis of a corresponding compound from other carriers, and which is characterised by at least two detectable and/or quantifiable attributes integrally associated with the carrier, with the proviso that one of said attributes is other than shape, or surface deformation(s) of the carrier; and
(b) tracking data on each distinctive code to identify the sequence of reactions experienced by a respective detectably distinct carrier.

### BRIEF DESCRIPTION OF THE DRAWINGS

FIG. 1 is a schematic representation of a modern flow cytometer. The core (sample) stream is hydrodynamically focused before intercepting the laser beam at the observation point. MilliQ™ water was used as sheath fluid in the present investigation. The laser beam, core stream and optical array are mutually orthogonal at the observation point. A beam stop is placed before the FS detector to remove transmitted light.

FIG. 2 is a schematic representation of one step in a split-process-recombine procedure, e.g. as discussed in the prior art in relation to the synthesis of peptide libraries.

FIG. 3 is a schematic representation of the entire iterative split-process-recombine procedure referred to in FIG. 1.

FIG. 4 is a schematic representation of a division of two-dimensional parameter space into gridspaces. Note that the width of each gridspace can be different for each parameter.

FIG. 5 is an example of a real-time algorithm for selecting optically unique microspheres. In panel (a), five microspheres have already been collected and hence the corresponding gridspace labels have been labelled full. In panel (b), a new microsphere occupies a vacant gridspace and hence is sorted in panel (c). In panel (d), another new microsphere occupies a full gridspace and hence is rejected from the system in panel (e).

FIG. 6 is a schematic representation of a refined method of selecting optically unique microspheres. Only microspheres that occupy the internal sort region are collected. No microspheres are collected from the buffer region.

FIG. 7 is a reaction scheme for the coupling of isothiocyanates to primary amines.

FIG. 8 shows fluorescence micrographs of (a) FITC-coated 2.5 μm microspheres (S1) and (b) QFITC-coated 2.5 μm microspheres (S2). Both micrographs are after six centrifugation-redispersion cycles using a U-MWB filter. Doublets and triplets are present from the original commercial synthesis.

FIG. 9 show scanning electron micrographs of: (a) uncoated 2.5 μm microspheres, (b) FITC-coated 2.5 μm microspheres (S1), (c) uncoated 4 μm blue-greenF microspheres, and (d) QFITC-coated 4 μm blue-greenF microspheres (R7).

FIG. 10 is a graph depicting Calibration of flow cytometer using Flow-Check™ microspheres. Each diluted sample (total volume 1 mL) was run for 2.00 minutes on MED flow rate (35±5 μL min⁻¹). Calculated concentration of microspheres is 1.03×10⁶ microspheres mL⁻¹.

FIG. 11 is a graph showing three distinct populations in a mixture of 10 μm greenF, 10 μm redF and 12 μm red-greenF microspheres

FIG. 12 is a graph showing a polygonal gate to collect 10 μm greenF population only. 100000 microspheres collected in 50-mL sheath fluid (MilliQ™ water).

FIG. 13 is a graph showing a polygonal gate to collect 12 μm red-greenF population only. 100000 microspheres collected in 50-mL sheath fluid (MilliQ™ water).

FIG. 14 is a fluorescence micrograph of an original mixture of three different microspheres. Green, red and orange (red-green) microspheres are distinguishable and well dispersed.

FIG. 15 is a graphical representation of a mixture of fluorescently coated samples S1 (FITC), S2 (QFITC) and the non-fluorescent uncoated 2.5 μm microspheres. The ratio of red fluorescence to green fluorescence is fixed at low concentrations for a given fluorophore, hence the correlation within samples.

FIG. 16 shows histograms of (a) FL1 values for non-fluorescent (black) and S1 (green). 25^{th}-75^{th} percentiles are 21-30 and 438-877 channel numbers for non-fluorescent and S1 respectively, and (b) FL3 values for non-fluorescent (black) and S2 (red). 25^{th}-75^{th} percentiles are 7-47 and 73-162 channel numbers for non-fluorescent and S2 respectively.

FIG. 17 is a bivariate plot of FL1 and FL3 for uncoated 4 μm blue-greenF microspheres and three different concentrations of QFITC-coated microspheres (R1, R8, R9). Four micrometer blue-redF microspheres are included to represent QFITC-coated microspheres containing no green fluorescence. This mixture of microspheres is approaching optical diversity.

FIG. 18 is a graph of increase in red fluorescence intensity with increasing amount of QFITC-APS added. The linearity of the graph suggests FRET is not occurring at these concentrations.

FIG. 19 shows bivariate plots of the well-defined sorting gates and subsequent re-analysis for the two precision experiments (refer also Table E and FIG. 23) using Flow-Check™ microspheres. The aggregate populations were caused by the <1000 rpm centrifugation required to concentrate the sorted microspheres from 50 mL to 0.5 mL. The size of the population recovered from the initial 200000 sorted microspheres is 10-20%.

FIG. 20 is an example of a frequency histogram used to determine rl for FL3. Note the effect that turbulence in the flow system has on the value of rl. By discarding the first 5000 events recorded, the turbulent data was removed. Greater than 99.9% of the remaining single microspheres had a deviation less than 47 channel numbers from the lowest channel number in the initial sort (ie. 423), hence rl=47, whereas before the turbulent data was removed, rl>75.

FIG. 21 is a graph showing the relationship between processing time and population size for the post-acquisition algorithm.

FIG. 22 is a graph showing the theoretical limit for maximum number of unique microspheres (Ep=50).

FIG. 23 is a graph showing the relationship between processing time and number of iterations for the real-time algorithm.

FIG. 24 is a graph showing the time for one iteration of the real-time algorithm for a given number of parameters.

FIG. 25 is a graph showing the number of unique microspheres obtained as a function of population size for random data. The total number of available gridspaces is 10000.

FIG. 26 is a graphical plot of an optodiverse population of QFITC-coated 4 μm blue-greenF microspheres on two parameters (FL1 and FL3) before pre-encoding.

FIG. 27 is a schematic representation of the gridspaces of 56 optically unique microspheres extracted from population in FIG. 29 (rl=rh=30).

FIG. 28 is a graph showing that the optimum value of wᵢ for U is 110 using conditions described above.

FIG. 29 is a graph showing the prediction of the number of optically unique microspheres that can be extracted after a given period of time using Equation 5.4.

FIG. 30 shows reproducibility of the mean values of the scattering/fluorescence signals of fluorescent silica particles. Seven bivariate plots are shown corresponding to seven passes through a flow cytometer of identical aliquots of the same sample of microspheres.

FIG. 31 shows non-fluorescent 10.2 μm microspheres collected and repassed through a flow cytometer give reproducible scattering values. Two bivariate plots are shown of a well-defined sorting gate and subsequent reanalysis of the gated non-fluorescent microspheres.

FIG. 32 shows non-fluorescent 10.2 and 21 μm microsphere mixtures collected and repassed through a flow cytometer give reproducible scattering values. Four bivariate plots are shown of well-defined sorting gates and subsequent reanalysis of the gated mixtures of non-fluorescent microspheres.

FIG. 33 shows fluorescent green polystyrene microspheres collected and repassed through the flow cytometer give reproducible scattering and fluorescence values. Four bivariate plots are shown of well-defined sorting gates and subsequent reanalysis of the gated fluorescent green microspheres.

FIG. 34 shows non-fluorescent polystyrene/divinylbenzene (DVB) microspheres swelled in DMF for 3 hours and returned to Milli-Q water give scattering values similar to those that have not been subjected to DMF. Two bivariate plots of gated fluorescent polystyrene microspheres are illustrated, one population representing a control (Panel A) and the other representing microspheres exposed to DMF treatment (Panel B).

FIG. 35 shows fluorescent red silica microspheres swelled in DMF for 3 hours and returned to Milli-Q water give scattering and fluorescence values similar to those that have not been subjected to DMF. Two bivariate plots of gated fluorescent silica microspheres are shown, one population representing a control (Panel A) and the other representing microspheres exposed to DMF treatment (Panel B).

FIG. 36 shows two bivariate plots of gated fluorescent Tentagel microspheres, one population representing a control (Panel A) and the other representing microspheres having one amino acid coupled thereto (Panel B).

FIG. 37 shows four bivariate plots of gated fluorescent silica microspheres, one population (Panel A, red fluorescence and side scatter; Panel C, red fluorescence and forward scatter) being collected, having a glycine coupled thereto and subsequently passed through a flow cytometer (Panel B, red fluorescence and side scatter; Panel D, red fluorescence and forward scatter).

FIG. 38 shows three bivariate plots of gated fluorescent green (Panel A), fluorescent orange (Panel B) and fluorescent red (Panel C), 10.2 μm polyelectrolyte coated microspheres.

### DETAILED DESCRIPTION OF THE INVENTION

### 1. Definitions

The term “carrier” as used herein embraces a solid support with appropriate sites for compound synthesis and, in some embodiments, tag attachment. The carrier may have any suitable size or shape or composition. Preferably, carriers are heterogeneous in size, shape, or composition. In general, the carrier size is in the range of between about 1 nm to 1 mm. The carrier may be shaped in the form of spheres, cubes, rectangular prisms, pyramids, cones, ovoids, sheets or cylinders.

The term “compound” as used herein refers to molecules comprising a sequence of synthons, which includes any structural unit that can be formed and/or assembled by known or conceivable synthetic operations. Thus, the compounds of the present invention are formed from the chemical or enzymatic addition of synthons. Such compounds include, for example, both linear, cyclic, and branched oligomers or polymers of nucleic acids, polysaccharides, phospholipids, and peptides having, for example, either α-, β-, or ω-amino acids, heteropolymers in which, for example, a known drug is covalently bound to any of the above, polyurethanes, polyesters, polycarbonates, polyureas, polyamides, polyethyleneimines, polyarylene sulphides, polysiloxanes, polyimides, polyacetates, or other polymers which will be readily apparent to one skilled in the art upon review of this disclosure. The number quoted and the types of compounds listed are merely illustrative and are not limiting.

By “features integrally associated with the carrier” or “features integrally associated therewith” is meant features of the carrier and/or features of one or more elements, molecules, groups, tags and the like attached to the carrier.

By “marker” is meant any molecule or groups of molecules having one or more recognisable attribute including, but not restricted to, shape, size, colour, optical density, differential absorbance or emission of light, chemical reactivity, magnetic or electronic encoded information, or any other distinguishable attribute.

As used herein “synthon” includes any member of a set of molecules which can be joined together to form a desired compound. For example, synthons may include amino acids, carbonates, sulphones, sulfoxides, nucleosides, carbohydrates, ureas, phosphonates, lipids, and esters. Alternatively, the synthons may comprise inorganic units such as for example silicates and aluminosilicates. Accordingly, a set of synthons useful in the present invention includes, but is not restricted to, for the example of peptide synthesis, the set of L-amino acids, D-amino acids, or synthetic amino acids. It will also be understood that different basis sets of synthons may be used at successive steps in the synthesis of a compound of the invention.

Throughout this specification and the appendant claims, unless the context requires otherwise, the words “comprise”, “comprises” and “comprising” will be understood to imply the inclusion of a stated integer or step or group of integers or steps but not the exclusion of any other integer or step or group of integers or steps.

### 2. Carriers of the Invention

The present invention resides, at least in part, in a carrier on which a compound can be synthesised, wherein the carrier has at least two attributes integrally associated therewith, which attributes are detectable and/or quantifiable during synthesis of the compound. The attributes define a code identifying the carrier before, during and after synthesis of a compound, with the proviso that one of the attributes is other than shape, or surface deformation(s) of the carrier. Through the use of its plurality of detectable and/or quantifiable attributes, preferably optically detectable and/or quantifiable attributes, the carrier of the present invention provides more “pre-encoded” information compared to other carriers of the prior art and thus provides larger combinational library sizes that can be encoded. This “pre-encoded” information may be read by conventional flow cytometers and can be used to track the synthetic history of an individual carrier in a combinatorial process as described hereinafter. The present inventors have found that the larger the diversity of detectable and/or quantifiable attributes of a carrier, the greater the degree of decipherability or resolution of the carrier in a large population of carriers. In this regard, each detectable and/or quantifiable attribute of a carrier provides at least a part of the information required to distinctively identify the carrier. The larger the number of such attributes, the more detailed the identifying information that is compilable for a given carrier, which may be used to distinguish that carrier from other carriers.

The invention also encompasses a plurality of carriers including a population that are pre-encoded as above. Accordingly, each carrier of that population has a code, which distinctively identifies a respective carrier before, during and after said synthesis from other carriers, and which is characterised by at least two detectable and/or quantifiable attributes integrally associated with the carrier, with the proviso that one of said attributes is other than shape, or surface deformation(s) of the carrier. The diversity of the said population of carriers, therefore, resides in carriers of said population having relative to each other different combinations of detectable attributes, which are used to provide distinctive codes for each of those carriers.

The carriers of the invention may be used in many applications, such as combinatorial chemistry procedures that do not involve a split-process-recombine procedure. Preferably, however, such assemblies are used in combinatorial chemistries, which involve a split-process-recombine procedure.

The carriers may comprise any solid material capable of providing a base for combinatorial synthesis. For example, the carriers may be polymeric supports such as polymeric beads, which are preferably formed from polystyrene cross-linked with 1-5% divinylbenzene. Polymeric beads may also be formed from hexamethylenediamine-polyacryl resins and related polymers, poly[N-{2-(4-hydroxylphenyl)ethyl}]acrylamide (i.e., (one Q)), silica, cellulose beads, polystyrene beads poly(halomethylstyrene) beads, poly(halostyrene) beads, poly(acetoxystyrene) beads, latex beads, grafted copolymer beads such as polyethylene glycol/polystyrene, porous silicates for example controlled pore-glass beads, polyacrylamide beads for example poly(acryloylsarcosine methyl ester) beads, dimethylacrylamide beads optionally cross-linked with N,N′-bis-acrylolyl ethylene diamine, glass particles coated with a hydrophobic polymer inclusive of cross-linked polystyrene or a fluorinated ethylene polymer which provides a material having a rigid or semi-rigid surface, poly(N-acryloylpyrrolidine) resins, Wang™ resins, Pam resins, Merrifield™ resins, PAP and SPARE polyamide resins, polyethylene functionalised with acrylic acid, kieselguhr/polyamide (Pepsyn K), polyHipe™, PS/polydimethylacrylamide copolymers, CPG, PS macrobeads and Tentagel™, PEG-PS/DVB copolymers.

It will also be appreciated that the polymeric beads may be replaced by other suitable supports such as pins or chips as is known in the art, e.g. as discussed in Gordon et al. (1994, J. Med. Chem. 37(10):1385-1401). The beads may also comprise pellets, discs, capillaries, hollow fibres or needles as is known in the art. Reference also may be made to International Publication WO93/06121, incorporated herein by reference, which describes a broad range of supports that may constitute carriers for use in present invention. By way of example, these carriers may be formed from appropriate materials inclusive of latex, glass, gold or other colloidal metal particles and the like. Reference may also be made to International Publications WO95/25737 or WO97/15390, incorporated herein by reference, which disclose examples of suitable carriers.

A plurality of carriers according to the invention may be prepared by any suitable method. Preferably, when colloidal particles including polymeric and ceramic particles are used as carriers, the colloid dispersion of such carriers is stabilised. Exemplary methods imparting colloidal stabilisation are described for example in Hunter, R. J. (1986, “Foundation of Colloid Science”, Oxford University Press, Melbourne) and Napper, D. H. (1983, “Polymeric stabilisation of Colloidal Dispersions” Academic Press, London), the disclosures of which are incorporated herein by reference. In this regard, the most widely exploited effect of nonionic polymers on colloid stability is steric stabilisation, in which stability is imparted by polymer molecules that are absorbed onto, or attached to, the surface of the colloid particles. Persons of skill in the art will recognise that it is possible to impart stability by combinations of different stabilisation mechanisms: e.g., surface charge on the particles can impact colloidal stability via electrostatic stabilisation, and an attached polyelectrolyte can impart stability by a combination of electrostatic and steric mechanisms (electrosteric stabilisation). Polymer that is in free solution can also influence colloid stability. Stabilisation by free polymer is well-documented (Napper 1983, supra) and is called depletion stabilisation.

Preferably, steric stabilisation of colloid dispersions is employed. In this regard, steric stabilisation is widely exploited because it offers several distinct advantages over electrostatic stabilisation. For example, one advantage is that aqueous sterically stabilised dispersions are comparatively insensitive to the presence of electrolytes because the dimensions of non-ionic chains vary relatively little with the electrolyte concentration. This contrasts sharply with the spatial extensions of electrical double layers, which are strongly dependent upon the ionic strength. It is apparent that at ionic strengths greater than ca. 10⁻² mol dm⁻³, electrical double layer thicknesses have shrunk to such an extent that the electrostatic repulsion may no longer outweigh the van der Waals attraction. This accounts for the coagulation of electrostatically stabilised dispersions on the addition of electrolyte. Another advantage is that it is equally effective in both aqueous and non-aqueous dispersion media. This contrasts with electrostatic stabilisation, which is relatively ineffective in non-polar dispersion media. In addition, steric stabilisation is equally effective at both high and low volume fractions of the dispersed phase; the high volume fraction dispersions displaying relatively low viscosities. Other advantages of sterically stabilised dispersions include good freeze-thaw stability, which can be a desirable attribute in some applications, and the ability to be flocculated reversibly, which is less common with electrostatically stabilised dispersions.

Any suitable stabilising moiety may be used for stabilising colloidal dispersions. Exemplary stabilising moieties that impact on colloidal stability are given in Table A.

TABLE A
Classification of some sterically stabilised
dispersions at room temperature and pressure

| | Dispersion medium | | | Type of |
|---|---|---|---|---|
| Stabilising Moieties | Type | Example | Flocculation | Stabilisation |
| Poly(oxyethlene) | aqueous | 0.39M MgSO₄ | heating to UCFT | enthalpic |
| Poly(vinyl alcohol) | aqueous | 2M NaCl | heating to UCFT | enthalpic |
| Poly(acrylic acid | aqueous | 0.2M HCl | cooling to LCFT | entropic |
| Poly(acrylamide) | aqueous | 2.1M (NH4)₂SO₄ | cooling to LCFT | entropic |
| Polystyrene | non- | cyclopentane | cooling to LCFT | entropic |
| | aqueous | | | |
| Poly(iso-butylene) | non- | 2-methylbutane | heating to UCFT | enthalpic |
| | aqueous | | | |

A significant advance of the present invention over the prior art is the provision of a carrier with a combination of at least two detectable and/or quantifiable attributes with the proviso that one of said attributes is other than shape, or surface deformation(s) of the carrier. The said attributes characterise a code that permits facile deconvolution of a plurality of reaction steps experienced by the carrier by methods as described, for example, hereinafter. In a preferred embodiment, at least one of said attributes is comprised within or internally of the carrier. This reduces exposure of the attribute to solvents required for compound synthesis on the carrier and thus, the encoded information corresponding to the attribute is more stable providing for greater reproducibility of the code.

It is preferred that at least one of the attributes of a carrier is an electromagnetic radiation-related attribute suitably selected from the group consisting of atomic or molecular fluorescence emission, luminescence, phosphorescence, infrared radiation, electromagnetic scattering including light and X-ray scattering, light transmittance, light absorbance and electrical impedance.

The fluorescence emission may result from excitation of one or more fluorescent markers attached to, or contained within, the carrier. In the case of two or more fluorescent markers being utilised, the markers may be the same wherein the markers contain varying amounts of a fluorophore and are therefore intensity-differentiated. Alternatively, the markers may be different wherein they are present in a ratio of 1:1 or varying ratios. Reference may be made in this regard to Yamashita et al. (International Publication WO 95/32425) which is incorporated herein by reference.

Exemplary fluorophores which may be used in accordance with the present invention include those discussed by Dower et al. (International Publication WO 93/06121 which is incorporated by reference herein). Preferably, fluorescent dyes are employed. Any suitable fluorescent dye may be used for incorporation into the carrier of the invention. For example, reference may be made to U.S. Pat. No. 5,573,909 (Singer et al., which is incorporated herein by reference) and U.S. Pat. No. 5,326,692 (Brinkley et al., which is incorporated herein by reference) which describe a plethora of fluorescent dyes. Reference may also be made to fluorescent dyes described in U.S. Pat. Nos. 5,227,487, 5,274,113, 5,405,975, 5,433,896, 5,442,045, 5,451,663, 5,453,517, 5,459,276, 5,516,864, 5,648,270 and 5,723,218 which are all incorporated herein by reference.

One or more of the fluorescent dyes are preferably incorporated into a microparticle, such as a polymeric microparticle or ceramic microparticle. Such microparticles may be attached to the carrier by use of colloidal interactions as for example disclosed by Trau and Bryant in copending International Application PCT/AU98/00944, incorporated herein by reference. Preferably, the fluorescent polymeric or ceramic microparticle comprises the carrier for combinatorial synthesis.

The polymeric microparticle can be prepared from a variety of polymerisable monomers, including styrenes, acrylates and unsaturated chlorides, esters, acetates, amides and alcohols, including, but not limited to, polystyrene (including high density polystyrene latexes such as brominated polystyrene), polymethylmethacrylate and other polyacrylic acids, polyacrylonitrile, polyacrylamide, polyacrolein, polydimethylsiloxane, polybutadiene, polyisoprene, polyurethane, polyvinylacetate, polyvinylchloride, polyvinylpyridine, polyvinylbenzylchloride, polyvinyltoluene, polyvinylidenechloride and polydivinylbenzene. The microparticles may be prepared from styrene monomers. Ceramic microparticles may be comprised of silica, alumina, titania or any other suitable transparent material. Preferably, silica particles are employed. A suitable method of making silica microparticles is described, for example in “The Colloid Chemistry of Silica and Silicates” (Cornell University Press) by Ralph K Iler 1955 and U.S. Pat. No. 5,439,624, the disclosures of which are incorporated herein by reference.

Fluorescent dyes may be incorporated into microparticles by any suitable method known in the art, such as copolymerisation of a polymerisable monomer and a dye-containing co-monomer or addition of a suitable dye derivative in a suitable organic solvent to an aqueous suspension as for example disclosed in Singer et al., (supra including references cited therein), Campion et al. (1994, In “Innovation and Perspectives on Solid Phase Synthesis” Epton, R., Birmingham: Mayflower, 469-472, incorporated herein by reference) and Egner et al. (1997, Chem. Commun. 735-736, incorporated herein by reference). Alternatively, fluorescent microparticles may be produced having at least one fluorescent spherical zone. Such particles may be prepared as for example described in U.S. Pat. No. 5,786,219 (Zhang et al.), which is incorporated herein by reference. In a preferred embodiment, one or more fluorescent dyes are incorporated within a microparticle. Compared to surface attachment of fluorescent dyes, incorporation of dyes within microparticles reduces the physical exposure of the fluorescent dye(s) to various solvents used in combinatorial synthesis and thus increases the stability of the carrier-fluorescent dye complexes.

Microparticles may also be prepared comprising different polymeric materials and/or different ceramic materials. For example, such microparticles may comprise a plurality of layers of one or more different polymers as for example described in Caruso et al. (1998, J. Am. Chem. Soc. 120: 8523-8524), which is incorporated herein by reference. Polymeric particles of this type may be prepared having different refractive indices or opacities, which may be used as detectable attributes according to the present invention. Alternatively, microparticles may comprise a plurality of layers, preferably composite multilayers, of ceramic materials as for example described in van Blaaderen et al. (1992, Langmuir 8: 2921-2931), which is incorporated herein by reference. The atomic ratio of different ceramic materials may be used as a detectable and/or quantifiable attribute of the invention. In this regard, reference may be made to U.S. Pat. No. 5,439,624, which discloses measurement of Si/Al ratio of particles, by wavelength dispersive spectroscopy.

Any suitable method of analysing fluorescence emission is encompassed by the present invention. In this regard, the invention contemplates techniques including, but not restricted to, 2-photon and 3-photon time resolved fluorescence spectroscopy as for example disclosed by Lakowicz et al. (1997, Biophys. J., 72: 567, incorporated herein by reference), fluorescence lifetime imaging as for example disclosed by Eriksson et al. (1993, Biophys. J, 2: 64, incorporated herein by reference), and fluorescence resonance energy transfer as for example disclosed by Youvan et al. (1997, Biotechnology et alia 3: 1-18).

Luminescence and phosphorescence may result respectively from a suitable luminescent or phosphorescent label as is known in the art. Any optical means of identifying such label may be used in this regard.

Infrared radiation may result from a suitable infrared dye. Exemplary infrared dyes that may be employed in the invention include, but are not restricted to, those disclosed in Lewis et al. (1999, Dyes Pigm. 42(2): 197), Tawa et al. (1998, Mater. Res. Soc. Symp. Proc. 488 (Electrical, Optical, and Magnetic Properties of Organic Solid-State Materials IV), 885-890), Daneshvar, et al. (1999, J. Immunol. Methods 226(1-2): 119-128), Rapaport et al. (1999, Appl. Phys. Lett. 74(3): 329-331) and Durig et al. (1993, J. Raman Spectrosc. 24(5): 281-5), which are incorporated herein by reference. Any suitable infrared spectroscopic method may be employed to interrogate the infrared dye. For instance, fourier transform infrared spectroscopy as for example described by Rahman et al. (1998, J. Org. Chem., 63: 6196, incorporated herein by reference) may be used in this regard.

Suitably, electromagnetic scattering may result from diffraction, reflection, polarisation or refraction of the incident electromagnetic radiation including light and X-rays. In this regard, the carriers may be formed of different materials to provide a set of carriers with varying scattering properties such as different refractive indexes as for example described supra. Any suitable art recognised method of detecting and/or quantifying electromagnetic scatter may be employed. In this regard, the invention also contemplates methods employing contrast variation in light scattering as, for example, described in van Helden and Vrij (1980, Journal of Colloidal and Interface Science 76: 419-433), which is incorporated herein by reference.

Of course it will be appreciated that attributes other than electromagnetic radiation-related attributes may be utilised. Such attributes include size and shape of the carrier. For example, carriers, preferably particles, more preferably microparticles, may be shaped in the form of spheres, cubes, rectangular prisms, pyramids, cones, ovoids, sheets or cylinders. Typically, when microparticles are employed, these preferably have a diameter of about 0.01 μm to about 150 μm. In this regard, electrical impedance across a carrier may be measured to provide an estimate of the carrier volume (Coulter volume).

Alternatively, a detectable and/or quantifiable attribute of the carrier may comprise one or more surface deformations of the carrier inclusive of pits, holes, hollows, grooves or notches or any combination thereof.

The attribute may also reside in a chromophoric label. Suitable carriers comprising such chromophores are described for example in Tentorio et al. (1980, Journal of Colloidal and Interface Science 77: 419-426), which is incorporated herein by reference. A suitable method for non-destructive analysis of organic pigments and dyes, using a Raman microprobe, microfluorometer or absorption microspectrophotometer, is described for example in Guineau, B. (1989, Cent. Rech. Conserv. Documents Graph., CNRS, Paris, Fr. Stud. Conserv 34(1): 38-44), which is incorporated herein by reference.

Alternatively, the attribute may comprise a magnetic material inclusive of iron and magnetite, or an attribute that is detectable by acoustic backscatter as is known in the art.

It will be understood from the foregoing that the number of carriers having different detectable codes will be dependent on the number of different detectable and/or quantifiable attributes integrally associated with the carriers. For example, code heterogeneity may be achieved simply by use of carriers of different shapes and/or sizes, and/or by use of carriers which are formed of different materials as described above. Alternatively, the code heterogeneity may be facilitated by use of carriers having different markers and/or different combinations of markers integrally associated therewith. Code heterogeneity may also be enhanced by use of carriers having two or more linked solid supports (e.g., bead or particle).

The carriers of the invention are applicable to any type of chemical reaction that can be carried out on a solid support. Such chemical reaction includes, for example:
1. [2+2] cycloadditions including trapping of butadiene;
2. [2+3] cycloadditions including synthesis of isoxazolines, furans and modified peptides;
3. acetal formation including immobilization of diols, aldehydes and ketones;
4. aldol condensation including derivatization of aldehydes, synthesis of propanediols;
5. benzoin condensation including derivatization of aldehydes;
6. cyclocondensations including benzodiazepines and hydantoins, thiazolidines, -turn mimetics, porphyrins, phthalocyanines;
7. Dieckmann cyclization including cyclization of diesters;
8. Diels-Alder reaction including derivitisation of acrylic acid;
9. Electrophilic addition including addition of alcohols to alkenes;
10. Grignard reaction including derivitisation of aldehydes;
11. Heck reaction including synthesis of disubstituted alkenes;
12. Henry reaction including synthesis of nitrile oxides in situ (see [2+3] cycloaddition);
13. catalytic hydrogenation including synthesis of pheromones and peptides (hydrogenation of alkenes);
14. Michael reaction including synthesis of sulfanyl ketones, bicyclo]2.2.2]octanes;
15. Mitsunobu reaction including synthesis of aryl ethers, peptidyl phosphonates and thioethers;
16. nucleophilic aromatic substitutions including synthesis of quinolones;
17. oxidation including synthesis of aldehydes and ketones;
18. Pausen-Khand cycloaddition including cyclization of norbornadiene with pentynol;
19. photochemical cyclisation including synthesis of helicenes;
20. reactions with organo-metallic compounds including derivitisation of aldehydes and acyl chlorides;
21. reduction with complex hydrides and Sn compounds including reduction of carbonyl, carboxylic acids, esters and nitro groups;
22. Soai reaction including reduction of carboxyl groups;
23. Stille reactions including synthesis of biphenyl derivatives;
24. Stork reaction including synthesis of substituted cyclohexanones;
25. reductive amination including synthesis of quinolones;
26. Suzuki reaction including synthesis of phenylacetic acid derivatives; and
27. Wittig, Wittig-Horner reaction including reactions of aldehydes; pheromones and sulfanyl ketones.

Reference may also be made to Patel et al., (April 1996, DDT 1(4): 134-144) who describe the manufacture or synthesis of N-substituted glycines, polycarbamates, mercaptoacylprolines, diketopiperazines, HIV protease inhibitors, 1-3 diols, hydroxystilbenes, B-lactams, 1,4-benzodiazepine-2-5-diones, dihydropyridines and dihydropyrimidines.

Reference may also be made to synthesis of polyketides as discussed, for example, in Rohr (1995, Angew. Int. Ed. Engl. 34: 881-884).

Chemical or enzymatic synthesis of the compound libraries of the present invention takes place on carriers. Thus, those of skill in the art will appreciate that the materials used to construct the carriers are limited primarily by their capacity for derivitisation to attach any of a number of chemically reactive groups and compatibility with the chemistry of compound synthesis. Except as otherwise noted, the chemically reactive groups with which such carriers may be derivatised are those commonly used for solid state synthesis of the respective compound and thus will be well known to those skilled in the art. For example, these carrier materials may be derivatised to contain functionalities or linkers including —NH₂, —COOH, —SOH, —SSH or sulphate groups.

Linkers for use with the carriers may be selected from base stable anchor groups as described in Table 2 of Fruchtel et al. (1996, supra, the entire disclosure of which is incorporated herein by reference) or acid stable anchor groups as described in Table 3 of Fruchtel et al. (1996, supra). Suitable linkers are also described in International Publication WO93/06121, which is incorporated herein by reference.

Generally the anchors developed for peptide chemistry are stable to either bases or weak acids but for the most part, they are suitable only for the immobilisation of carboxylic acids. However, for the reversible attachment of special functional groups, known anchors have to be derivatised and optimised or, when necessary, completely new anchors must be developed. For example, an anchor group for immobilisation of alcohols is (6 hydroxymethyl)-3,4 dihydro-2H-pyran, whereby the sodium salt is covalently bonded to chloromethylated Merrifield™ resin by a nucleophilic substitution reaction. The alcohol is coupled to the support by electrophilic addition in the presence of pyridinium toluene-4 sulphonate (PPTS) in dichloromethane. The resulting tetrahydropyranyl ether is stable to base but can be cleaved by transetherification with 95% trifluoroacetic acid.

Benzyl halides may be coupled to a photolabile sulfanyl-substituted phenyl ketone anchor.

It will also be appreciated that compounds prepared with the carriers and/or process of the present invention may be screened for an activity of interest by methods well known in the art. For example, such screening may be effected by flow cytometry as for example described by Needels et al. (1993, Proc. Natl. Acad. Sci. USA 90: 10700-10704, incorporated herein by reference), Dower et al. (supra), and Kaye and Tracey (International Application WO 97/15390, incorporated herein by reference).

Compounds that may be so screened include agonists and antagonists for cell membrane receptors, toxins, venoms, viral epitopes, hormones, sugars, cofactors, peptides, enzyme substrates, drugs inclusive of opiates and steroids, proteins including antibodies, monoclonal antibodies, antisera reactive with specific antigenic determinants, nucleic acids, lectins, polysaccharides, cellular membranes and organelles.

The present invention also encompasses as compounds a plurality of unique polynucleotide or oligonucleotide sequences for sequence by hybridisation (SBH) or gene expression analyses. Persons of skill in the art will recognise that SBH uses a set of short oligonucleotide probes of defined sequence to search for complementary sequences on a longer target strand of DNA. The hybridisation pattern is used to reconstruct the target DNA sequence. Accordingly, in the context of the present invention, an aqueous solution of fluorescently labelled single stranded DNA (ssDNA) of unknown sequence may be passed over the library of polynucleotide or oligonucleotide compounds and adsorption (hybridisation) of the ssDNA will occur only on carriers which contain polynucleotide or oligonucleotide sequences complementary to those on the ssDNA. These carriers may be identified, for example, by flow cytometry, fluorescence optical microscopy or any other suitable technique.

Once a compound having the desired activity is obtained, the sequence of reaction steps experienced by the carrier on which the compound was synthesised may be deconvoluted simply by analysing the tracking data for that carrier as described, for example, hereinafter. The sequence of synthons defining the compound of interest may thus be ascertained and a molecule comprising this sequence can by synthesised by conventional means (e.g., amino acid synthesis or oligonucleotide synthesis) as is known in the art.

### 3. Enriching for Uniquely Encoded Carriers

In yet another aspect, the invention resides in a method of producing a plurality of carriers including a population of carriers having detectably distinct carriers. The method includes: (a) preparing a plurality of carriers having different codes wherein each code is characterised by at least two detectable and/or quantifiable attributes integrally associated with a respective carrier, (b) detecting the said attributes of each carrier using a suitable detection/quantification means to thereby assign a code for each carrier, (c) identifying carriers having distinctive codes that are detectably and/or quantifiably decipherable or resolvable by the detection/quantification means, (d) identifying carriers having similar or non-distinctive codes and (e) sorting carriers having distinctive codes from the carriers having non-distinctive codes to thereby provide a plurality of carriers including a population having detectably distinct codes.

Provision of a plurality of detectably unique carriers is dependent on the number of parameters detectable and/or quantifiable by the detection/quantification means, and the resolution of its detection/quantification. The inventors have found in this regard that the larger the number of attributes that can be detected/quantified by the detection/quantification means the greater the number of carriers that will have a detectably distinct code and the larger the library that can be encoded. Put another way, the larger the number of parameters that are detectable/quantifiable by the detection/quantification means, the more information that is obtainable for each carrier and, thus, the larger the number of distinctive codes distinguishable or decipherable by the said means. Accordingly, the step of detecting and quantifying (step (b)) is preferably further characterised in that at least three, preferably at least four, more preferably at least five and most preferably at least six different attributes of a respective carrier are detected/quantified for code recordal.

The identification steps (step (c) and (d)) may be effected by use of any suitable method or apparatus for analysing the detectable/quantifiable attributes of a carrier. Preferably, these steps are effected by flow cytometry, which typically detects optical parameters. For example, a flow cytometer may be used to determine forward scatter (which is a measure of size of a carrier), side scatter (which is sensitive to refractive index and size of a particle (seen Shapiro 1995, “Practical flow cytometry”, 3rd ed. Brisbane, Wiley-Liss)), and fluorescent emission.

As it known in the art, flow cytometry is a high throughput technique for clinical and research use, though as yet unrelated to combinatorial chemistry. It involves rapidly analysing the physical and chemical characteristics of cells or other particles as they pass through the path of one or more laser beams while suspended in a fluid stream. As each cell or particle intercepts the laser beam the scattered light and fluorescent light emitted by each cell or particle is detected and recorded using any suitable tracking algorithm as, for example, described hereinafter.

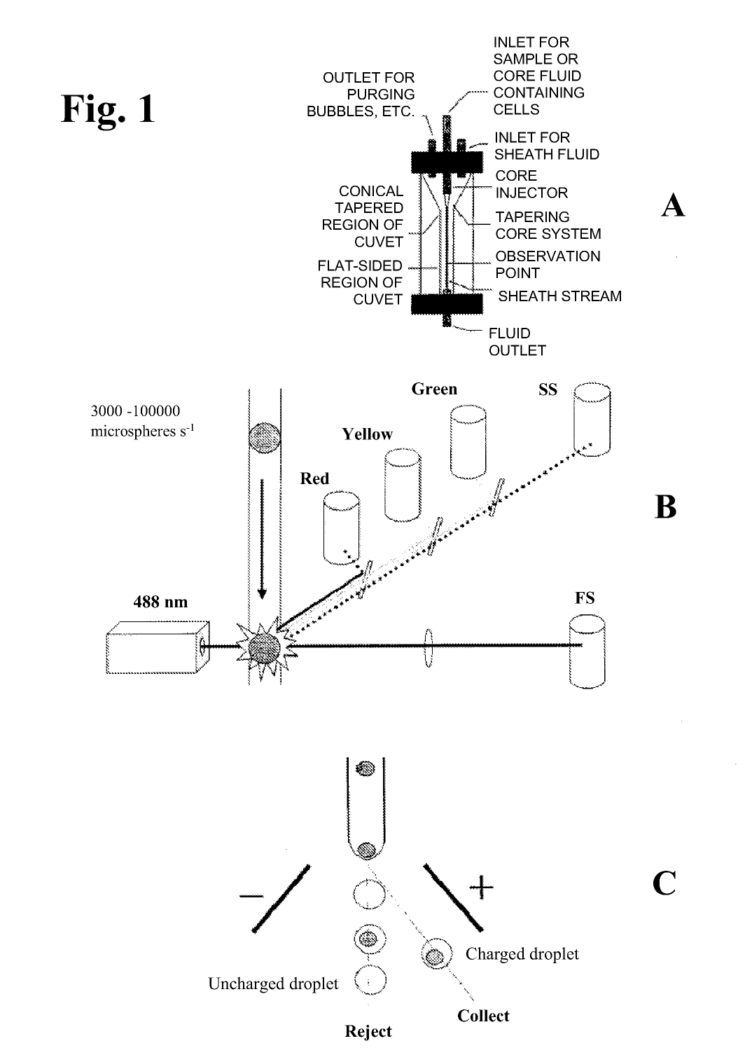

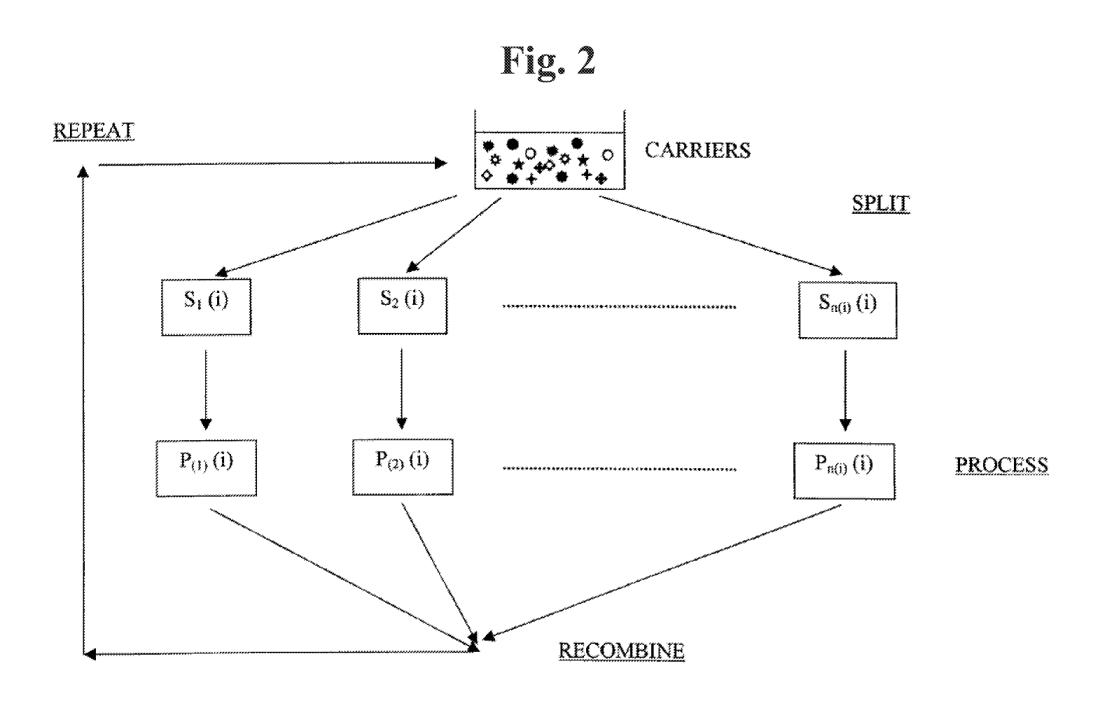

A diagram of a modern flow cytometer is presented in FIG. 1. A modern flow cytometer is able to perform these tasks up to 3,000 cells/particles s⁻¹, with the more advanced flow cytometers capable of processing 100,000 cells/particles s⁻¹. Through the use of an optical array of filters and dichroic mirrors, different wavelengths of fluorescent light can be separated and detected simultaneously. In addition, a number of lasers with different excitation wavelengths may be used. Hence, a variety of fluorophores can be used to target and examine, for example, intra- and extra-cellular properties of individual cells. The scattered light measurements can also classify an individual cell's size, shape and granularity as belonging to a particular population of interest (Shapiro, 1995, supra).

Suitable flow cytometers that may be used in the methods of the invention may measure five optical parameters (see Table B) using a single excitation laser, commonly an argon ion air-cooled laser operating at 15 mW on its 488 nm spectral line. More advanced flow cytometers are capable of using multiple excitation lasers such as a HeNe laser (633 nm) or a HeCd laser (325 nm) in addition to the argon ion laser (488 or 514 nm). Optical parameters, corresponding to different optically detectable/quantifiable attributes, for a carrier, may be measured by a flow cytometer to provide a matrix of qualitative and/or quantitative information, providing a code (or addressability in a multi-dimensional space) for the carrier.

TABLE B
Exemplary optical parameters, which may be measured by a flow
cytometer and which were used in the present investigation

| | | Detection angle | |
|---|---|---|---|
| | | from incident | Wavelength |
| Parameter | Acronym | laser beam | (nm) |
| Forward scattered light | FS | 2-5° | 488* |
| Side scattered light | SS | 90° | 488* |
| “Green” fluorescence | FL1 | 90° | 510-540^{†} |
| “Yellow” fluorescence | FL2 | 90° | 560-580* |
| “Red” fluorescence | FL3 | 90° | >650^{#} |

*using a 488 nm excitation laser
^{†}width of bandpass filter
^{#}longpass filter

For example, Bigos et al. (1999, Cytometry 36: 36-45) have constructed an 11-parameter flow cytometer using three excitation lasers and have demonstrated the use of nine distinguishable fluorophores in addition to forward and side scatter measurements for purposes of immunophenotyping (i.e., classifying) cells. The maximum number of parameters commercially available currently is seventeen: forward scatter, side scatter and three excitation lasers each with five fluorescence detectors. Whether all of the parameters can be adequately used depends heavily on the extinction coefficients, quantum yields and amount of spectral overlap between all fluorophores (Malemed et al, 1990, “Flow cytometry and sorting”, 2nd Ed, New York, Wiley-Liss). However, it will be understood that the present invention is not restricted to any particular flow cytometer or any particular set of parameters. In this regard, the invention also contemplates use in place of a conventional flow cytometer, a microfabricated flow cytometer as for example disclosed by Fu et al. (1999, Nature Biotechnology 17: 1109-1111), which is incorporated herein by reference.

A further advantage of flow cytometry is the ability to physically separate a cell or particle of interest from a heterogeneous population of cells/particles. This is achieved through electrical or mechanical means by collecting desired cells/particles at a point downstream from the laser beam while undesired cells/particles continue to flow into a waste container. A flow cytometer with this capacity to sort is known as a fluorescence-activated cell sorter (FACS). Accordingly, the step of sorting in the present method of obtaining a population of detectably unique carriers may be effected by flow cytometric techniques such as by fluorescence activated cell sorting (FACS), although, with respect to the present invention, FACS is more accurately “fluorescence activated carrier or solid support sorting” (see for example “Methods in Cell Biology”, Vol. 33 (Darzynkiewicz, Z. and Crissman, H. A., eds., Academic Press); and Dangl and Herzenberg, J. Immunol. Methods 52: 1-14 (1982), both incorporated herein by reference).

Any suitable algorithm may be employed to track and/or sort individual detectably unique carriers. Preferably, a real-time algorithm is employed. For example, the real-time algorithm may divide a parameter space, as is hereinafter defined, into smaller pre-defined gridspaces wherein all the gridspaces are registered empty. As carriers from a sample population pass through the flow cytometer in single file, the combination of detectable features belonging to each carrier will correspond to a particular gridspace. Two possible outcomes can then occur:
(a) if the gridspace is registered empty, the carrier is sorted and collected by the flow cytometer and the gridspace is registered full;
(b) if the gridspace is already registered full, the carrier is rejected.

A further refinement of each gridspace is preferably used to avoid the case of a carrier with a range that overlaps multiple gridspaces. An internal sort region is thus established within each gridspace, surrounded by a buffer region defined by the lower, rl, and higher, rh, ranges required for each parameter. Carriers may now only be collected if they fall into the internal sort region of each gridspace. In this manner, a population of detectably unique carriers can be sorted from a raw population.

Suitably, the step of sorting (step (e)) is characterised in that the population of detectably distinct carriers constitutes at least about 50%, preferably at least about 70%, more preferably at least about 90%, and more preferably at least about 95% of the plurality of carriers resulting from step (e).

From the foregoing, a population of detectably unique carriers can be generated from a raw population of carriers using preferably flow cytometric techniques, which population is now pre-encoded for use in combinatorial synthesis.

### 4. Synthesis and Deconvolution of a Combinatorial Compound Library

The invention also resides in a method of synthesising and deconvoluting a combinatorial library. The method comprises (a) apportioning in a stochastic manner among a plurality of reaction vessels a plurality of carriers on which a plurality of different compounds can be synthesised, wherein said plurality of carriers includes a population of detectably distinct carriers each having a code, which distinctively identifies a respective carrier before, during and after said synthesis from other carriers, and which is characterised by at least two detectable and/or quantifiable attributes integrally associated with the carrier, with the proviso that one of said attributes is other than shape, or surface deformation(s) of the carrier, (b) determining and recording the codes of said plurality of carriers in order to track the movement of individual carriers into particular reaction vessels of said plurality of reaction vessels, wherein said codes are determined prior to step (d), (c) reacting the carriers in each reaction vessel with a synthon, (d) pooling the carriers from each reaction vessel, (e) apportioning the carriers in a stochastic manner among the plurality of reaction vessels, (f) reacting the carriers in each reaction vessel with another synthon, (f) recording the codes of said plurality of carriers in order to track the movement of individual carriers into particular reaction vessels of said plurality of reaction vessels, wherein said codes are recorded after step (e) or step (f), (g) pooling the carriers from each reaction vessel and iterating steps (e) through (h) as necessary to create a combinatorial compound library, wherein member compounds of the library are associated with the detectably distinct carriers and wherein codes of the detectably distinct carriers are deconvolutable using tracking data provided by said recordal steps to identify the sequence of reactions experienced by the said detectably distinct carriers. Preferably, the codes are determined by flow cytometric techniques.

In more detail, the codes of the plurality of carriers are determined preferably before the first reaction step, although codes may be determined at any time before the first pooling step (step (d)). Preferably, every time the plurality of carriers is apportioned into reaction vessels, each one of the vessels is analysed to determine which of the detectably distinct carriers are in each reaction vessel. A database of all the carriers (or corresponding gridspaces, supra) can thus be updated to show the synthetic history of the compound synthesised on each carrier.

During a reaction step, the carriers in each reaction vessel are reacted with a synthon required to assemble a particular compound. Assembly of compounds from many types of synthons requires use of the appropriate coupling chemistry for a given set of synthons. Any set of synthons that can be attached to one another in a step-by-step fashion can serve as the synthon set. The attachment may be mediated by chemical, enzymatic, or other means, or by a combination of these. The resulting compounds can be linear, cyclic, branched, or assume various other conformations as will be apparent to those skilled in the art. For example, techniques for solid state synthesis of polypeptides are described, for example, in Merrifield (1963, J. Amer. Chem. Soc. 35: 2149-2156). Peptide coupling chemistry is also described in “The Peptides”, Vol. 1, (eds. Gross, E., and J. Meienhofer), Academic Press, Orlando (1979), which is incorporated herein by reference.

To synthesise the compounds, a large number of the carriers are apportioned among a number of reaction vessels. In each reaction, a different synthon is coupled to the growing oligomer chain. The synthons may be of any type that can be appropriately activated for chemical coupling, or any type that will be accepted for enzymatic coupling. Because the reactions may be contained in separate reaction vessels, even synthons with different coupling chemistries can be used to assemble the oligomeric compounds (see, The Peptides, op. cit). The coupling time for some of the synthon sets may be long. For this reason the preferred arrangement is one in which the synthon reactions are carried out in parallel. After each coupling step, the carriers on which are synthesised the oligomers or compounds of the library are pooled and mixed prior to re-allocation to the individual vessels for the next coupling step. This shuffling process produces carriers with many oligomer sequence combinations. If each synthesis step has high coupling efficiency, substantially all the oligomers on a single carrier will have the same sequence. That sequence is determined by the synthesis pathway (synthon reactions and the order of reactions experienced by the carriers) for any given carrier. The maximum length of the oligomers may be about 20, preferably from 3 to 8 synthons in length, and in some cases a length of 10 to 12 residues is preferred. Protective groups known to those skilled in the art may be used to prevent spurious coupling (see, The Peptides, Vol. 3, (eds. Gross, E., and J. Meienhofer), Academic Press, Orlando (1981), which is incorporated herein by reference).

With enough carriers and efficient coupling it is possible to generate complete sets of certain oligomers, if desired. The appropriate size of the carriers depends on (1) the number of oligomer synthesis sites desired; (2) the number of different compounds to be synthesised (and the number of carriers bearing each oligomer that are needed for screening); and (3) the effect of the size of the carriers on the specific screening strategies e.g., fluorescence-activated cell sorters (FACS) to be used.

In order that the invention may be readily understood and put into practical effect, particular preferred embodiments will now be described by way of the following non-limiting examples.

### EXAMPLES

### Example 1

### Summary of a Flow Cytometric Determination of Combinatorial Reaction Histories According to the Invention

A split-process-recombine procedure involving m steps, say step 1, step 2, . . . , step m, and n(i) processes at step i (i=1,2, . . . , m) may be defined as follows. For i=1,2, . . . , m, let the n(i) processes at step i be P1(i),P2(i), . . . , Pn(i)(i). At each step i=1,2, . . . , m:

the carriers are partitioned, at random but possibly in specific ratios, into n(i) subsets S1(i),S2(i), . . . , Sn(i)(i);

for j=1,2, . . . , n(i) process Pj(i) is performed on the carriers in subset Sj(i);

the carriers are recombined.

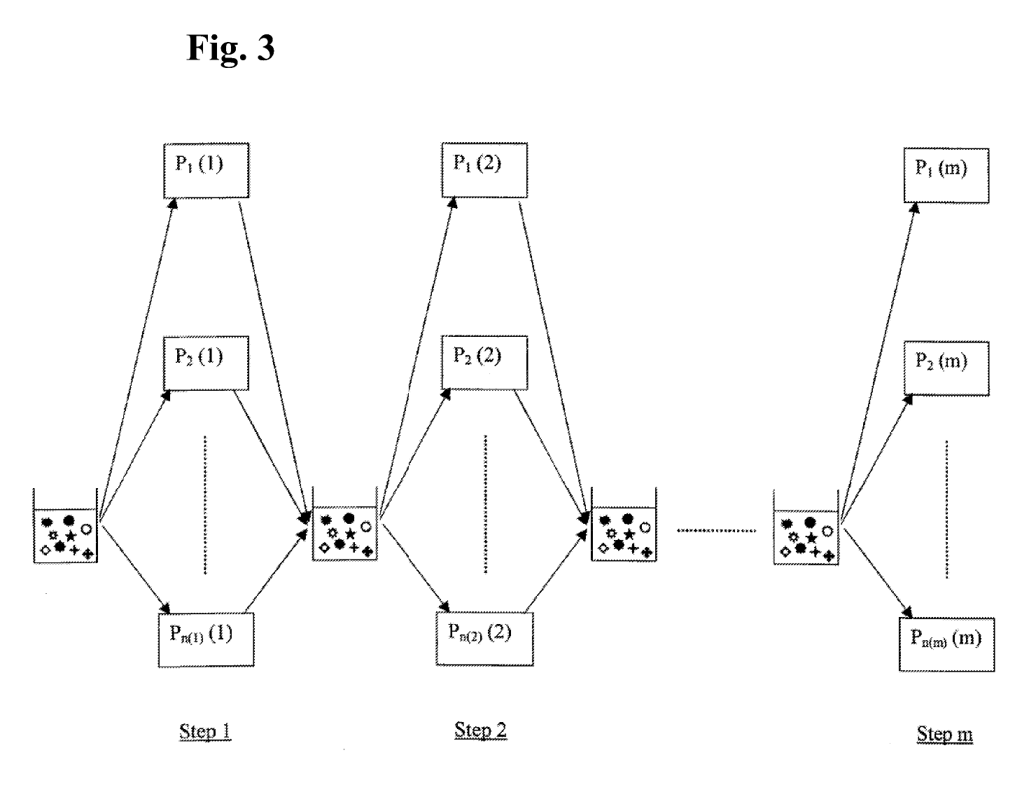

A schematic representation of this procedure is shown in FIGS. 2 and 3.

Examples of such processes include the combinatorial synthesis of oligonucleotide and oligopeptide chains. In these examples, insoluble polymer beads (colloidal particles, typically 1-1000 μm in diameter) may be used as the carriers onto which nucleic or amino acid monomers are attached and sequentially grown. By performing a split-process-recombine procedure repeatedly for a large number of carriers, a large variety of randomly generated oligonucleotide or polypeptide sequences can be synthesised. Each carrier thus contains an attached polymer with a unique sequence, which is defined by the sequence of processing events that the carrier has experienced (i.e., the specific path that the carrier has followed in FIG. 3).

In view of the above, the present invention relates to a novel and convenient method to determine the sequence of processes applied to each of the carriers involved in a split-process-recombine procedure. This procedure involves, for i=1,2, . . . , m and j=1,2, . . . , n(i), passing the carriers in the subset Sj(i) through a flow cytometer to obtain a signature or code for each of the carriers present in the subset. The code of each carrier will be determined by a combination of features of the carriers as described above. The coding data is stored for the purpose of determining the sequence of processes (i.e., reaction history of the carrier) applied to each of the carriers.

The code of a particular carrier for which the process history is required is checked against the list of codes which has been stored for each subset Sj(i). The set of subsets Sj(i) in which the particular carrier's code occurs determines the set of processes Pj(i) which have been performed on the carrier and hence its entire process history.

It is desirable, therefore, that the code of any carrier be reproducible and distinguishable from the code of any other carrier which is used in the split-process-recombine procedure. In this regard, split-process-recombine procedures may be employed in the manufacture of carriers in order to facilitate efficient production of extremely large numbers of distinguishable particles. In a preferred embodiment, flow cytometric techniques are used to sort and remove subpopulations of indistinguishable carriers. However, partial or complete determination of process histories that are sought may be obtained without perfect code distinction and reproducibility. For example, if two particles become detectably indistinguishable in the seventh step of a 10-step split synthesis, and then the reaction history of either particle through steps 8 to 10 may be used to deduce the reaction history for those particles.

The following examples will be discussed with reference to microspheres as the preferred carriers.

### Example 2

### Encoding Strategy

### Optically Unique Microspheres

To positively identify a given microsphere in a population by measurement of its optical properties requires that the given microsphere has a set of optical properties that is unique from every other microsphere in the population. For two microspheres to be optically different, they need only differ in one of their optical properties. That is, all of their respective optical properties could be identical except for one distinguishable difference.

When a flow cytometer measures each optical property or parameter, the electrical current output from the corresponding photomultiplier tube is converted to a relative value or channel number, which is an integer value between 0 and 1023 for an instrument operating in linear mode at a resolution of 1024. Therefore, using only one optical property, e.g., light scattering intensity at 90°, the maximum possible number of unique microspheres would be 1024.

If an additional optical property is made available, each of the original 1024 unique values could be paired with any of the 1024 new values, leading to 1024² possible combinations. For a total of k measurable optical parameters, the maximum number of optically unique combinations would hence be 1024^{k}.

Using set theory (Hrbacek and Jech 1984, “Introduction to set theory” 2^{nd} Ed, New York, M. Dekker), this can be expressed as:

Set of values possible for the ith optical property=Rᵢ={x ε Z⁺|0≦x<max} (2.1)

where Z⁺ is the set of all positive integers including zero. The value of max is equal to the resolution of the instrument, which throughout this study was 1024.

If the instrument can measure k independent optical properties, then each microsphere in the population can be represented by:

Ordered set of k optical properties for a given microsphere=S₁=<r₁, r₂, r₃, . . . , rₖ> (2.2)

where r₁ ε R₁, r₂ ε R₂, r₃ ε R₃, etc. For an unordered collection of microspheres:

Population of n microspheres=P={S₁, S₂, S₃, . . . , Sₙ} (2.3)

where Sᵢ=Sⱼ means that the two microspheres, Sᵢ and Sⱼ, are optically indistinguishable from the k optical properties measured by a flow cytometer (throughout this investigation, the number of optical properties, k, measured by the flow cytometer was five (refer Table B) and typical total population sizes were ≈10⁵ microspheres). The number of optically unique microspheres in the population, P is thus:

|U| where U ⊂ P and (∀Sᵢ,Sⱼ ε U) Sᵢ≠Sⱼ (2.4)

### Optical Diversity

To maximise the number of unique microspheres in the system, an optically diverse population needs to be synthesised.

Optical diversity is a recursive term that is based on the measurement of several independent optical parameters. A population of microspheres is deemed optically diverse over k parameters if a sub-population of microspheres with identical values for one of the parameters is indistinguishable from the total population when both populations are measured using only the remaining (ie. k−1) parameters.

An optically diverse population of microspheres would thus be expressed by:

D ⊃ P and D ⊃ R₁×R₂×R₃ . . . ×Rₖ (2.5)

where R₁×R₂×R₃ . . . ×Rₖ is the parameter space for the k optical parameters. P is a subset of D because not every population is necessarily optically diverse. The parameter space is also a subset of D to allow for the possibility of optically indistinguishable microspheres within an overall diverse population.

### Pre-Screening of Optically Diverse Microspheres

The argument above carries two crucial assumptions:
1. a given microsphere does not vary in any of its intrinsic optical properties, and
2. there is no variation in the detection of each microsphere

A large body of work (Shapiro, H. M., 1995, supra; Melamed et al, 1990, supra; Kettman et al, 1998 Cytometry, 33: 234-243) suggests that both of these assumptions are invalid due to factors such as the effects of photodegradation, solvent polarity, and pH on fluorophores, not to mention the inherent error in any optical and/or electronic detection system.

However, the above argument can be refined by describing each optical property of a given microsphere as a range of values instead of just a single value. The range of values represents the possible variation in repeated measurements of the same microsphere by a flow cytometer.

The maximum number of unique microspheres using only one optical property then becomes equal to the resolution of the instrument divided by the range, with the range expressed in channel numbers.

For k measurable optical properties, the maximum number of unique microspheres would thus equal:

$$\vert U \vert = \frac{{1024}^{k}}{{\prod }_{i = 1}^{k} ( {v}_{i} )} \qquad ( 2.6 )$$

where vᵢ is the range of the ith optical parameter.

Two algorithms for obtaining optically unique microspheres using the above concept of a range were conceived: a post-acquisition and a real-time algorithm. Both these algorithms will be examined further in Example 5, however it shall be seen that the post-acquisition algorithm, although much simpler to implement, has a theoretical size limit of |U| well below the real-time algorithm. Hence, the real-time algorithm is the preferred algorithm.

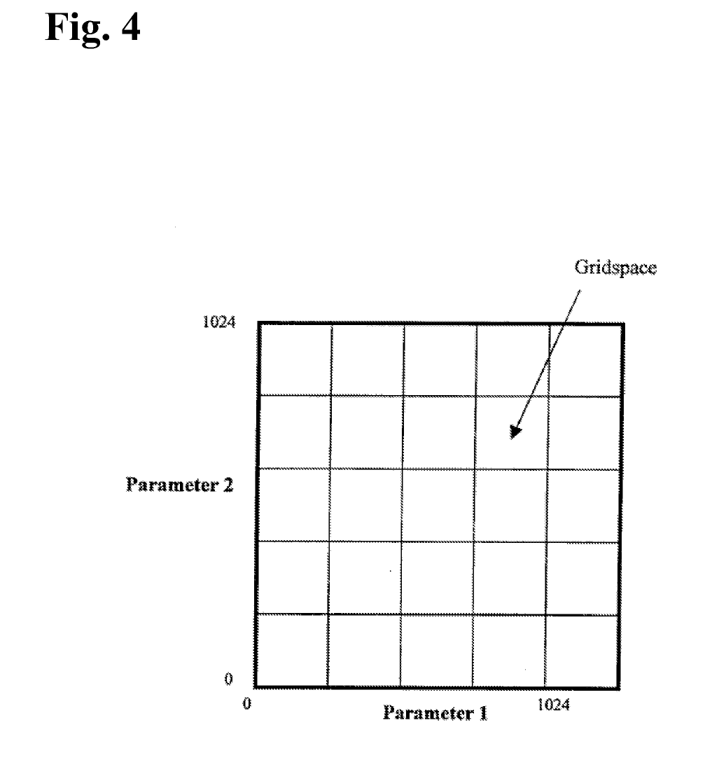

The real-time algorithm divides the parameter space into smaller pre-defined gridspaces (see FIG. 4). Initially all the gridspaces are labelled empty (represented by a zero). As microspheres from a sample population pass through the flow cytometer in single file, the combination of optical properties belonging to each microsphere will correspond to a particular gridspace. Two possible outcomes can then occur:
(a) if the gridspace is labelled as empty, the microsphere is sorted and collected by the flow cytometer and the gridspace label is changed to full (represented by a one);
(b) if the gridspace is already labelled as full, the microsphere is rejected (the total population of each gridspace can never exceed one).

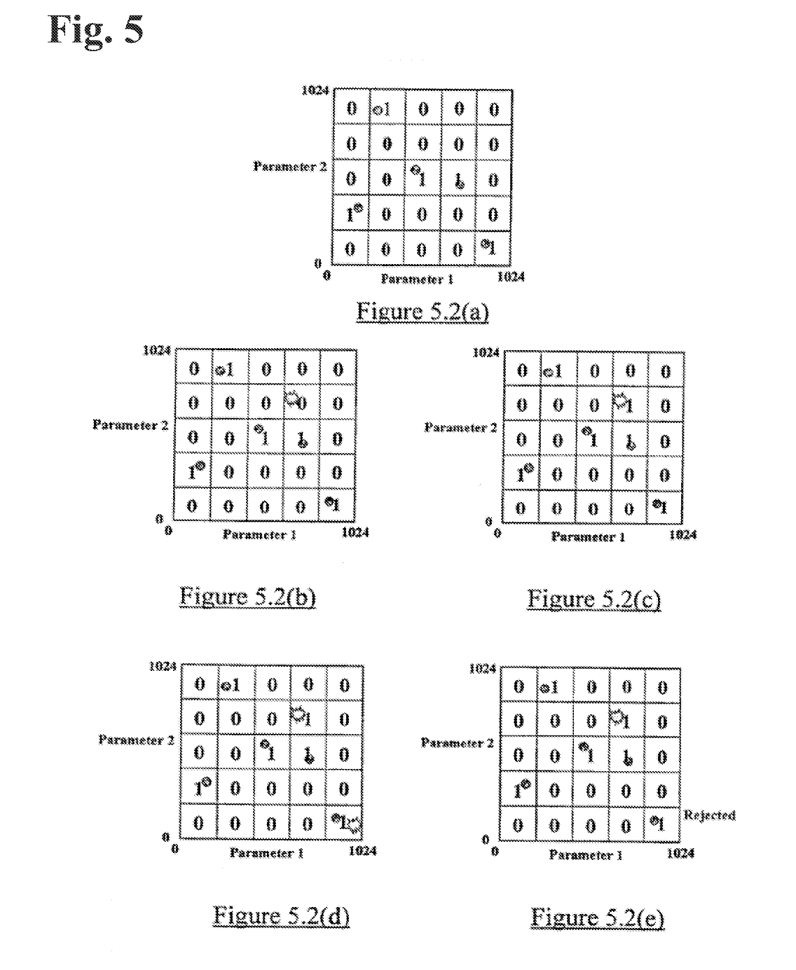

An example of this process is given in FIG. 5. As there is a one-to-one relationship between the microspheres and the gridspaces, each microsphere can be represented by the gridspace it occupies.

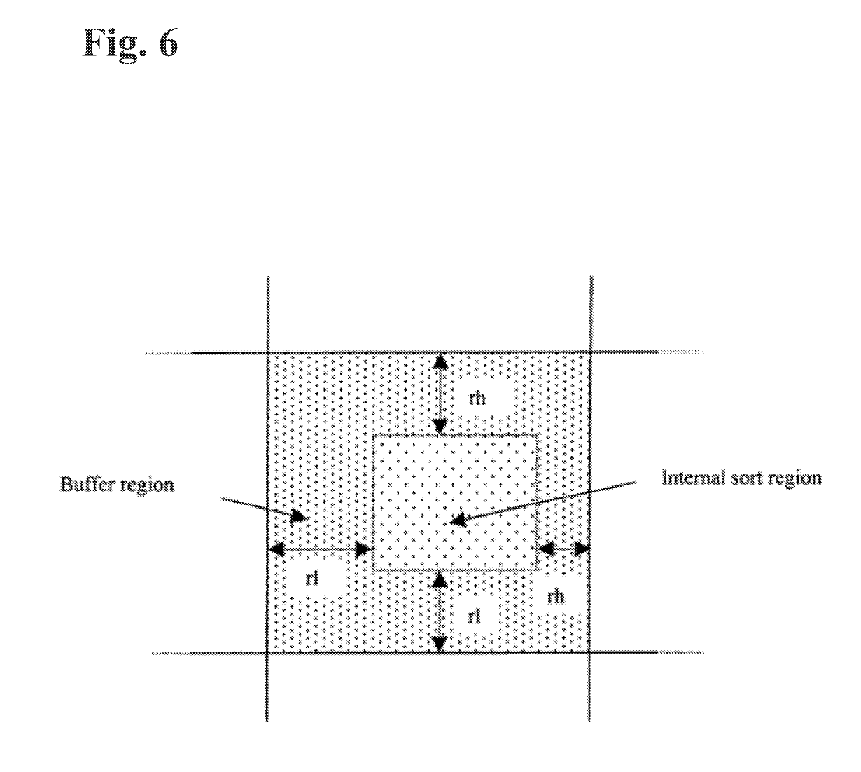

A further refinement of each gridspace is preferably required to avoid the case of a microsphere with a range that overlaps multiple gridspaces. An internal sort region is thus established within each gridspace, surrounded by a buffer region defined by the lower, rl, and higher, rh, ranges required for each parameter (see FIG. 6). Microspheres may now only be collected if they fall into the internal sort region of each gridspace. In this manner, a population of optically unique microspheres can be extracted from a raw population.

### Tracking Microspheres Through Combinatorial Synthesis

Having generated a population of optically unique microspheres from a raw population using the real-time algorithm, the population is now pre-encoded for use in a combinatorial split-and-mix synthesis.

Every time the population is split into m batches, each one of the batches is analysed using a flow cytometer to determine which of the optically unique microspheres are in each batch. A database of all the microspheres (or corresponding gridspaces) can thus be updated to show the synthetic history of the compound synthesised on each microsphere.

Note that the internal sort region is no longer required. Each microsphere should now remain within the confines of its allotted gridspace. Hence, all the microspheres in a given batch can be identified post-acquisition. In fact, the entire synthetic history of every microsphere could be determined at a later stage by compiling all the recorded data from every batch in every cycle of the complete combinatorial synthesis.

At this stage, it becomes clear what the experimental requirements are. Firstly, a population of optically diverse microspheres needs to be synthesised. Secondly, the magnitude of rl and rh for each parameter needs to be determined instrumentally to establish reliable gridspace sizes and lastly, software needs to be developed to handle the real-time sorting and tracking algorithms.

### Example 3

### Silica Microspheres

### Introduction

Silica microspheres or particles have been well studied as model colloidal particles by the work of Iler (Iler R K, 1979, “The chemistry of silica: solubility, polymerization, colloid and surface properties, and biochemistry”. New York, John Wiley & Sons) and others (Bergna H E, 1994, “The colloid chemistry of silica”. Washington D.C., American Chemical Society). Early synthetic processes prepared a colloidal sol of silica by passing a dilute solution of sodium silicate through a bed of hydrogen ion-exchange resin and then raising the pH to 8-9 with addition of alkali. Stable sols of 10 to 130 nm in diameter could be prepared using this process by heating a portion of this solution to 100° C. and slowly adding the remaining portion of the solution as the heated portion became more concentrated through evaporation. As the particles in the heated portion (4-6 nm) were larger than the particles in the remainder of the solution (2-3 nm), all of the smaller particles (<3 nm) were dissolved and deposited on to the larger particles at a uniform rate, a process described as Ostwald ripening. Purification via ion-exchange resin or lengthy dialysis was required to improve sol stability by the removal of soluble salts (Iler R K, 1979, supra).

More recently, monodisperse silica particles up to 800 nm in size have been prepared by Bogush et al. (1988, J Non-Cryst Solids, 104: 95-106) from the hydrolysis and precipitation of tetraethyl orthosilicate (TEOS) in an alcohol-ammonia-water system first demonstrated by Stober et al. (1968, J Colloid Int Sci, 26: 62). Bogush et al. (1988, supra) also provided a non-mechanistic empirical expression of final particle size, d (in nm), from knowledge of reagent concentrations:

d=A[H₂O]²exp(−B[H₂O]^{1/2}) (3.1)
where A=[TEOS]^{1/2}(82−151[NH₃]+1200[NH₃]²−366[NH₃]³)
and B=1.05+0.523[NH₃]−0.128[NH₃]²

This equation was shown to correctly predict within ±20% of measured diameters for 100 samples prepared at 25° C. over the concentration ranges of 0.1-0.5 M TEOS, 0.5-17.0 M H₂O and 0.5-3.0 M NH₃.

Particle nucleation in the Stober synthesis occurs via a two-step reaction in the presence of an ammonia base-catalyst:

Hydrolysis: Si(OC₂H₅)₄+4H₂O→Si(OH)₄+4C₂H₅OH (3.2)

Condensation: Si(OH)₄→SiO₂₍ₛ₎+2H₂O (3.3)

Two models have been developed to explain particle growth. Matsoukas et al. (1991, J Colloid Int Sci, 145: 557) model particle nucleation and growth as a reaction between two hydrolysed monomers, thus particles are only considered to grow by monomer addition. They found that the first-order rate constant of hydrolysis was equal to the first-order rate constant for particle growth, and hence concluded that the particle growth is rate-limited by the hydrolysis. A second model developed by Zukoski et al. (1991, J Colloid Int Sci, 142: 17) describes particle nucleation as the controlled aggregation of nanometre-sized subparticles. At the pH of the system (pH>10), the silica particles are negatively charged due to dissociation of surface silanol groups. Once an aggregate reaches a certain critical radius as described by DLVO theory (Hunter, R J, 1987, supra), the aggregate becomes colloidally stable and further aggregation with larger particles is prevented by electrostatic repulsion. Particle growth thus continues by aggregation with smaller particles that are constantly produced throughout the entire reaction. Zukoski et al. (1991, supra) state that all the TEOS is hydrolysed within the first few minutes, and consider a step in the condensation pathway as rate limiting rather than the hydrolysis.

Van Blaaderen et al. (1992, J Colloid Int Sci, 154: 481) have also investigated the rate constants of hydrolysis and particle growth using ¹³C NMR and static light scattering respectively, and agree with Matsoukas et al. (1991, supra) that the particle growth is rate-limited by the hydrolysis. While they agree with Zukoski et al. (1991, supra) that aggregation is initially responsible for the formation of a colloidally stable particle, they found that final particle size was not affected by addition of LiNO₃ after colloidally stable particles were already formed (ie. upon an increase in turbidity) whereas prior addition of the salt before the addition of TEOS caused an increase in final particle size. They concluded from this result that after a brief induction time where the ionic strength of the reaction medium and particle surface charge have a strong influence, the number of particles remains constant and particle growth occurs by monomer addition. If the critical radius for colloidal stability is large, only a small number of particles are formed and the final particle size will be large.

Many researchers have used the particles formed via the Stober synthesis as seed particles for further growth experiments. Philipse (1994, Langmuir, 10: 4451-4458) and van Bruggen (1998, Langmuir, 14: 2245-2255) have coated boehmite needles (AlOOH) with a silica layer a few nanometres deep through the controlled deposition of sodium silicate to avoid flocculation of the positively-charged needles. Once coated with silica, these needles can be then be used as seed particles for larger growth in a Stober synthesis.

Control of pH is important to keep the pH between 9 and 10.5. If the pH is lower than 9, secondary homogeneous nucleation of silica occurs. This is undesirable as the smaller secondary nuclei are difficult to remove by sedimentation and filtration, and as their total surface area is much greater than the larger seed particles, the secondary nuclei consume a large amount of monomer. A large seed particle concentration is also helpful in suppressing secondary nucleation by increasing the available surface area for condensation, especially as the free energy for heterogeneous nucleation is lower than that for homogeneous nucleation (Hunter, R J, 1987, supra). The seed particle concentration can not be too high though, or silica condensation can make the large number of collisions between particles per second result in aggregation (Philipse et al., 1994, supra)

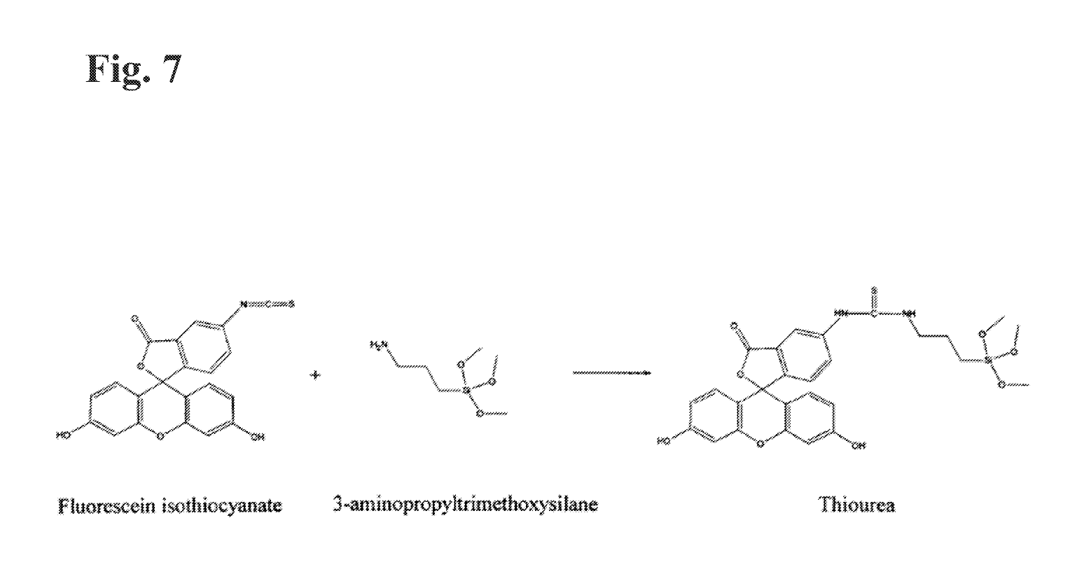

Using seeded growths, van Blaaderen et al. (1992, Langmuir, 8: 2921-2931) and Verhaegh et al. (1994, Langmuir, 10: 1427-1438) have demonstrated the incorporation of the comonomer, 3-aminopropyltrimethoxysilane (APS), into either the core and/or any subsequent shells of a silica particle. This comonomer can be covalently coupled to any isothiocyanate via the reaction given in FIG. 7, or any succinimidyl ester or other amine-reactive derivative of a fluorescent dye. Silica particles containing a number of alternating fluorescent and non-fluorescent shells were synthesised by this method. For fluorescent shells containing fluorescein isothiocyanate (FITC), the fluorescence was red-shifted from 523 nm to 534 nm when the particles were dispersed in DMF compared to ethanol, however this red-shift did not occur when a protective non-fluorescent silica shell was synthesised over the fluorescent shell (518 and 519 nm). Only small additions of TEOS and dye-coupled APS were possible to avoid aggregation due to an increase in ionic strength caused by an increase in the concentration of hydrolysed TEOS during a brief induction period where the rate of condensation does not yet exceed the rate of hydrolysis.

### Experimental

### Design

For eventual use as solid-supports for a combinatorial library, commercial silica microspheres of known size were purchased. Suitable fluorophores could then be incorporated using the method demonstrated by van Blaaderen et al. (1992, supra). To maximise the number of possible unique microspheres and hence the potential size of the combinatorial library, a combinatorial synthesis distinctly different from that required to synthesise the final combinatorial library, was designed to synthesise a population of optically diverse silica microspheres.

This combinatorial synthesis involves the seeded growth of shells containing the same fluorophore on to separate batches of seed microspheres, with a different concentration of the fluorophore for each batch. The batches are then repooled and randomly split into new batches as per FIGS. 2 and 3, whereby different concentrations of a new fluorophore are synthesised as another growth shell on the microspheres in each batch. Through the appropriate choice and concentration of fluorophores, the full range of each fluorescent parameter on a flow cytometer can be utilised; thus this combinatorial synthesis allows the entire parameter space of a flow cytometer to be accessed. Forward scatter and side scatter were chosen as control parameters to select only those microspheres of interest from aggregates, dust and other debris, and hence were not included in this combinatorial synthesis of optical diversity.

As a flow cytometer is used to identify unique microspheres, the size of the microspheres also needed to be larger than the practical lower limit of detection, which for most flow cytometers is 1 μm.

### Materials

Monomers used were tetraethyl orthosilicate (TEOS, Aldrich) and the dye-coupling agent 3-aminopropyltrimethoxysilane (APS, Aldrich). Dyes used were: Alexa 430 (A430, Molecular Probes), fluorescein isothiocyanate (FITC, Sigma) and quinolizino-substituted fluorescein isothiocyanate (QFITC, Sigma). Denatured ethanol, ammonia solution (25%, BDH) and MilliQ™-filtered water were prepared as the alcohol-ammonia-water solvent system immediately before each experiment. Commercial silica microspheres purchased were 2.5 μm non-fluorescent (Bangs Laboratories) and 4 μm blue-greenF, 4 μm blue-redF, 4 μm blue-green-redF, 10 μm greenF, 10 μm redF, 12 μm red-greenF and 15 μm red F (all from Micromod). Each experiment was performed in a 13.5-mL Pyrex screw-cap glass vial with a teflon insert. Each glass vial was cleansed using concentrated nitric acid for at least two hours then rinsed thoroughly with MilliQ™ water before use. All other reagents were used as received.

### Coupling of Fluorescent Dye

Fluorescent dyes were coupled to APS by the reaction given in FIG. 7. For each dye, 5 μmol of the dye was reacted with 250 μmol of APS in 1 mL of ethanol. The reaction was stirred for 2 hours under dark conditions to prevent photobleaching. Due to the high insolubility of the thiourea, an orange precipitate of excess dye-APS formed upon standing that was removed by centrifugation.

### Synthesis of Fluorescent Shells

Fluorescent shells were synthesised on commercial silica microspheres using an adaptation of the method described in van Blaaderen et al. (1992, supra). Three samples were prepared using the 2.5 μm non-fluorescent microspheres. For each sample, 20 mg of microspheres were resuspended in a glass vial with 2.5 mL denatured ethanol and 2.5 mL MilliQ™ water (a ratio found to inhibit secondary nucleation). After sonicating for 2 minutes (van Blaaderen et al. report the formation of a colloidal crystal phase for monodisperse colloids), visual inspection by optical microscopy could not find any significant clumps though there were some doublets and triplets present from the original commercial synthesis. To this suspension, 200 μL of ammonia solution was added in a fume hood and mixed thoroughly. 100 μL of TEOS followed by 10 μL of a particular dye-APS solution (see Table C (S1-3)) were rapidly added to each sample and the glass vials shaken, sealed, wrapped in alfoil and placed in a motorised rotating clamp that prevented sedimentation of the microspheres during the reaction. No aggregates were visible in solution though some nucleation was present on the glass walls.

Nine samples were prepared using the 4 μm blue-greenF and 4 μm blue-redF fluorescent microspheres. The reaction scheme is similar to that for the 2.5 μm microspheres and is given in Table C (R1-R8 and G1-3). For each sample, all reagents except one were kept constant to examine the effect that doubling or halving the concentration of each reagent had on particle stability, fluorescence intensity of the shell and degree of secondary nucleation.

TABLE C
Reaction scheme for the synthesis of fluorescent shells on commercial microspheres

| | | Amount | Ethanol | MilliQ ™ | Ammonia | TEOS | First Coat | Second Coat |
|---|---|---|---|---|---|---|---|---|
| Sample | Microsphere | (mg) | (mL) | (mL) | (μL) | (μL) | (μL) (dye-APS) | (μL) (dye-APS) |
| S1 | 2.5 μm | 20 | 2.5 | 2.5 | 200 | 100 | 10 (FITC-APS) | — |
| S2 | 2.5 μm | 20 | 2.5 | 2.5 | 200 | 100 | 10 (QFITC-APS) | — |
| S3 | 2.5 μm | 20 | 2.5 | 2.5 | 200 | 100 | 10 (A430-APS) | — |
| R1 | 4 μm blue-greenF | 10 | 2.4 | 2.6 | 200 | 100 | 10 (QFITC-APS) | — |
| R2 | 4 μm blue-greenF | 10 | 2.2 | 2.8 | 200 | 100 | 10 (QFITC-APS) | — |
| R3 | 4 μm blue-greenF | 10 | 2.5 | 2.5 | 100 | 100 | 10 (QFITC-APS) | — |
| R4 | 4 μm blue-greenF | 10 | 2.5 | 2.5 | 400 | 100 | 10 (QFITC-APS) | — |
| R5 | 4 μm blue-greenF | 10 | 2.5 | 2.5 | 200 | 50 | 10 (QFITC-APS) | — |
| R6 | 4 μm blue-greenF | 10 | 2.5 | 2.5 | 200 | 200 | 10 (QFITC-APS) | — |
| R7 | 4 μm blue-greenF | 10 | 2.5 | 2.5 | 200 | 100 | 20 (QFITC-APS) | — |
| R8 | 4 μm blue-greenF | 10 | 2.5 | 2.5 | 200 | 100 | 5 (QFITC-APS) | — |
| G1 | 4 μm blue-redF | 10 | 2.5 | 2.5 | 200 | 100 | 10 (FITC-APS) | — |
| G2 | 4 μm blue-redF | 10 | 2.5 | 2.5 | 200 | 100 | 2.5 (FITC-APS) | — |
| G3 | 4 μm blue-redF | 10 | 2.5 | 2.5 | 200 | 100 | 5 (FITC-APS) | — |
| SC1 | 1.25 mL of S3 | — | 1.25 | — | 100 | 50 | — | 5 (QFITC-APS) |
| SC2 | 1.25 mL of S2 | — | 1.25 | — | 100 | 50 | — | 5 (FITC-APS) |
| SC3 | 1.25 mL of S2 | — | 1.25 | — | 100 | 50 | — | 5 (A430-APS) |

After allowing at least 12 hours for the reaction to complete, each sample was transferred to a clean glass vial and underwent the following clean-up procedure six times: centrifugation at 1000 rpm for five minutes, removal of supernatant, resuspension in 5 mL MilliQ™ water and sonication (2 minutes for non-porous 2.5 μm microspheres, 15 seconds for porous 4 μm microspheres). The first supernatant removed from each sample was retained and examined for the presence of any secondary nucleation. The supernatants from R4 and R6 were noticeably more turbid than the other samples. The first supernatants from all twelve samples were also clearly fluorescent, though all subsequent supernatants remained clear.

### Combinatorial Synthesis of Colloidal Dispersions of Fluorescent Silica Particles.

To synthesise a diverse set of particles, a combinatorial split and mix technique is used. At each cycle of the split and mix, separate portions of microspheres are subjected to a seed growth of shells containing the same fluorophore, but with a different concentration of the fluorophore for each portion. By using a different fluorophore at each cycle of the split and mix, and a different concentration of fluorophore at each reaction during a cycle, an optically diverse set of particles can be synthesised.

Cycle 1 of the combinatorial synthesis involves thoroughly mixing three different batches of plain silica core particles, each batch containing a different size range of particles. After mixing, the particles are split into three portions.

Cycle 2 involves reacting a fluorescent red shell of low fluorescence intensity onto the particles in the first portion, a fluorescent red shell of medium fluorescence onto the particles in the second portion, and a fluorescent red shell of high fluorescence intensity onto the particles in the third portion. The particles are then mixed and split into 3 portions.

Cycle 3 involves reacting a fluorescent green shell of low fluorescence intensity onto the particles in the first portion, a fluorescent green shell of medium fluorescence onto the particles in the second portion, and a fluorescent green shell of high fluorescence intensity onto the particles in the third portion. The particles are then mixed and split into 3 portions.

Cycle 4 involves reacting a fluorescent blue shell of low fluorescence intensity onto the particles in the first portion, a fluorescent blue shell of medium fluorescence onto the particles in the second portion, and a fluorescent blue shell of high fluorescence intensity onto the particles in the third portion. After mixing all of the portions, an optically diverse population of particles are present.

In more detail, fluorescent shells are synthesised on the silica microspheres using an adaptation of the method described by van Blaaderen et al. 1992, supra. Monomers used are tetraethyl orthosilicate (TEOS, Aldrich) and the dye-coupling agent 3-aminopropyltrimethoxysilane (APS, Aldrich). Dyes used are: Alexa 430 (blue)(A430, Molecular Probes), fluorescein isothiocyanate (green)(FITC, Sigma) and quinolizino-substituted fluorescein isothiocyanate (red)(QFITC, Sigma). Denatured ethanol, ammonia solution (25%, BDH) and MilliQ™-filtered water are prepared as the alcohol-ammonia-water solvent system immediately before each experiment. Each reaction is performed in a 13.5-mL Pyrex screw-cap glass vial with a Teflon™ insert. Each glass vial is cleansed using concentrated nitric acid for at least two hours then rinsed thoroughly with MilliQ™ water before use. All other reagents are used as received.

Fluorescent dyes are coupled to APS by the reaction described in van Blaaderen et al. 1992, supra. For each dye, 5 μmol of the dye is reacted with 250 μmol of APS in 1 mL of ethanol. The reaction is stirred for 2 hours under dark conditions to prevent photobleaching.

Core particles used in Cycle 1 are plain silica microspheres (Bangs Laboratories) of three different size ranges (0.50-0.99 μm, 1.00-2.49 μm and 2.50-5.00 μm).

20 mg of particles from each size range is combined thoroughly in a vessel and the resulting mixture is split into equal portions (20 mg) by weight.

In Cycle 2, each 20 mg portion of microspheres is suspended in 2.5 mL denatured ethanol and 2.5 mL MilliQ™ water in a glass vial. Each portion is sonicated for 2 minutes in a bath sonicator. To each suspension, 200 μL of ammonia solution is added and mixed thoroughly. The first portion of microspheres is rapidly mixed with 100 μL of TEOS and 5 μL of QFITC-APS solution, the second portion is mixed with 100 μL of TEOS and 10 μL of QFITC-APS solution and the third portion is mixed with 100 μL of TEOS and 20 μL of QFITC-APS solution. The glass vials containing each portion is shaken, sealed, wrapped in alfoil and placed in a motorised rotating clamp that prevents sedimentation of the microspheres during the reaction.

After at least 12 hours, each sample is transferred to a clean glass vial and washed six times by centrifugation at 1000 rpm for five minutes, removal of supernatant, resuspension in 5 mL MilliQ™ water and sonication for 2 minutes. The first supernatant is removed from each sample and examined by fluorescence microscopy for the presence of any secondary nucleation. The portions are mixed thoroughly and then split into three equal portions.

For Cycle 3, each portion of microspheres is gradually transferred to a final 5-mL solution of denatured ethanol and MilliQ™ water (1:1 ratio) in a glass vial. Each portion is sonicated for 2 minutes in a bath sonicator. To each suspension, 200 μL of ammonia solution is added and mixed thoroughly. The first portion of microspheres is rapidly mixed with 100 μL of TEOS and 5 μL of FITC-APS solution, the second portion is mixed with 100 μL of TEOS and 10 μL of FITC-APS solution and the third portion is mixed with 100 μL of TEOS and 20 μL of FITC-APS solution. The glass vials containing each portion is shaken, sealed, wrapped in alfoil and placed in a motorised rotating clamp that prevents sedimentation of the microspheres during the reaction.

After at least 12 hours, each sample is transferred to a clean glass vial and washed six times by centrifugation at 1000 rpm for five minutes, removal of supernatant, resuspension in 5 mL MilliQ™ water and sonication for 2 minutes. The first supernatant is removed from each sample and examined for the presence of any secondary nucleation. The portions are mixed thoroughly and then split into three equal portions.

For Cycle 4, each portion of microspheres is gradually transferred to a final 5-mL solution of denatured ethanol and MilliQ™ water (1:1 ratio) in a glass vial. Each portion is sonicated for 2 minutes in a bath sonicator. To each suspension, 200 μL of ammonia solution is added and mixed thoroughly. The first portion of microspheres is rapidly mixed with 100 μL of TEOS and 5 μL of Alexa430-APS solution, the second portion is mixed with 100 μL of TEOS and 10 μL of Alexa430-APS solution and the third portion is mixed with 100 μL of TEOS and 20 μL of Alexa430-APS solution. The glass vials containing each portion is shaken, sealed, wrapped in alfoil and placed in a motorised rotating clamp that prevents sedimentation of the microspheres during the reaction.

After at least 12 hours, each sample is transferred to a clean glass vial and washed six times by centrifugation at 1000 rpm for five minutes, removal of supernatant, resuspension in 5 mL MilliQ™ water and sonication for 2 minutes. The first supernatant is removed from each sample and examined for the presence of any secondary nucleation. The portions are mixed thoroughly.

The optically diverse particles are then ready to use as desired. The particles can be functionalised, for example with NH₂ groups by synthesising an outer shell with using TEOS and APS (without dye).

Variations to this procedure include the synthesis of non-fluorescent shells between the fluorescent shells by using TEOS without the presence of dye-APS. Fluorescent core particles can also be used at the start of the combinatorial split and mix.

### Microscopy

Fluorescence microscopy photos were taken using a CCD camera (Diagnostic Instruments) on a fluorescence microscope (Olympus IX-70) equipped with filters U-MWU (excitation wavelength λ_{EX}=330-385 nm; emission wavelength λ_{EM}>420 nm), U-MWB (λ_{EX}=450-480 nm; emission wavelength λ_{EM}>515 nm) and U-MWG (λ_{EX}=510-550 nm; emission wavelength λ_{EM}>590 nm).

Scanning electron micrographs were taken on a JEOL 6400 using 2 μL samples dried in an IR preparation cabinet and coated with Pt. Average particle sizes were determined using Image-Pro Plus™ 4.0 and calibrated using the 10 μm scale-bar from the electron micrographs.

### Results and Discussion

### Single Fluorescent Shells

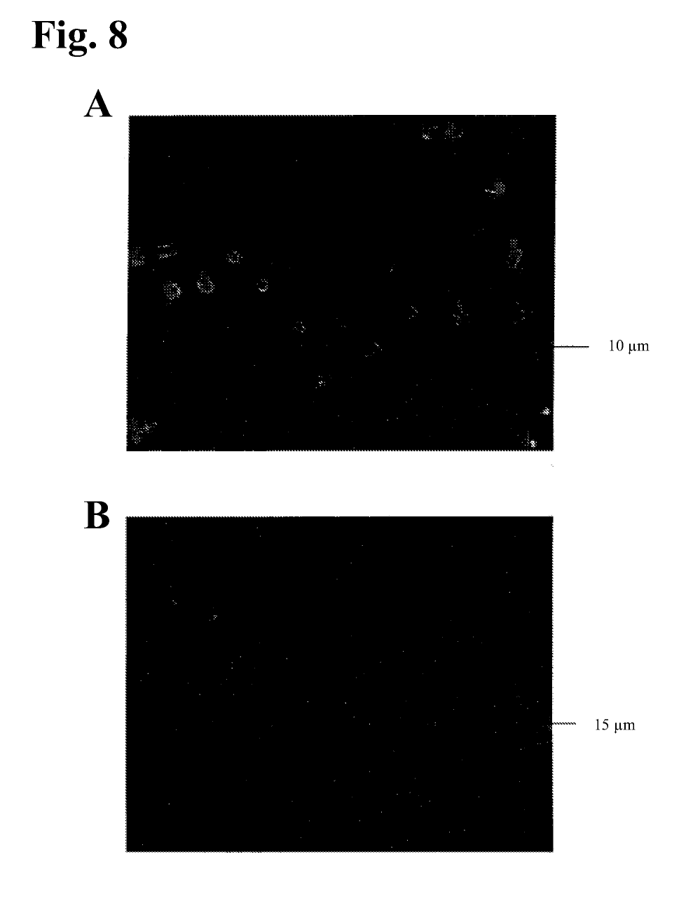

Samples R1-8 and G1-3 were still fluorescent after undergoing extensive clean-up as described above. Fluorescence micrographs of samples S1 and S2 are given in FIG. 8. Fluorescence of the non-fluorescent 2.5 μm microspheres was negligible. For both sizes, the FITC-coated and QFITC-coated microspheres were brightly fluorescent using the U-MWB and U-MWG filters respectively.

The concentration of water in R2 ([H₂O]=30.35 M) was shown to inhibit nucleation as predicted by equation 3.1 (d<6 nm). The higher concentrations of NH₃ and TEOS in R4 and R6 respectively, resulted in aggregation between seed microspheres and the presence of secondary nuclei. This is due to an increase in hydrolysed TEOS, causing rapid deposition of monomer and allowing homogeneous nucleation to occur. Different concentrations of fluorophore-APS (R1, R7 and R8 as well as G1-3) did not seem to affect the overall seeded growth, and the resulting fluorescence intensity was shown to be proportional to the fluorophore-APS concentration (see Example 4 “Measurement of fluorescently coated microspheres” for details). Four possibilities exist for the presence of these fluorescent “shells”:
1. The fluorophore-APS is simply adsorbed to the surface of each microsphere;
2. The fluorophore-APS diffuses through the silica matrix and remains internally stained; or
3. The fluorophore-APS is incorporated into a seeded growth shell as suggested by van Blaaderen et al.

To exclude the possibility of adsorption, non-APS-coupled QFITC was added to uncoated 4 μm blue-greenF microspheres using the same alcohol-water-ammonia system as the other samples, though in the absence of any TEOS or APS. Although initially fluorescent, after an extensive clean up these microspheres were no longer fluorescent, as confirmed by fluorimetry and flow cytometric measurements.

Giesche et al. (1991, Dyes and Pigments, 17: 323-340) has amino-modified the surface of silica particles before coupling to fluorophores such as Acid Blue and Methyl Red. The surface area of these fluorophores at saturation concentrations was found to be 110-140 per molecule. It was therefore suggested by Giesche et al. (1991, supra) that these large aromatic molecules lie flat on the surface. As FITC and QFITC are similarly planar polyaromatic molecules, it is hence unlikely the fluorophore-APS diffuses through the silica matrix.

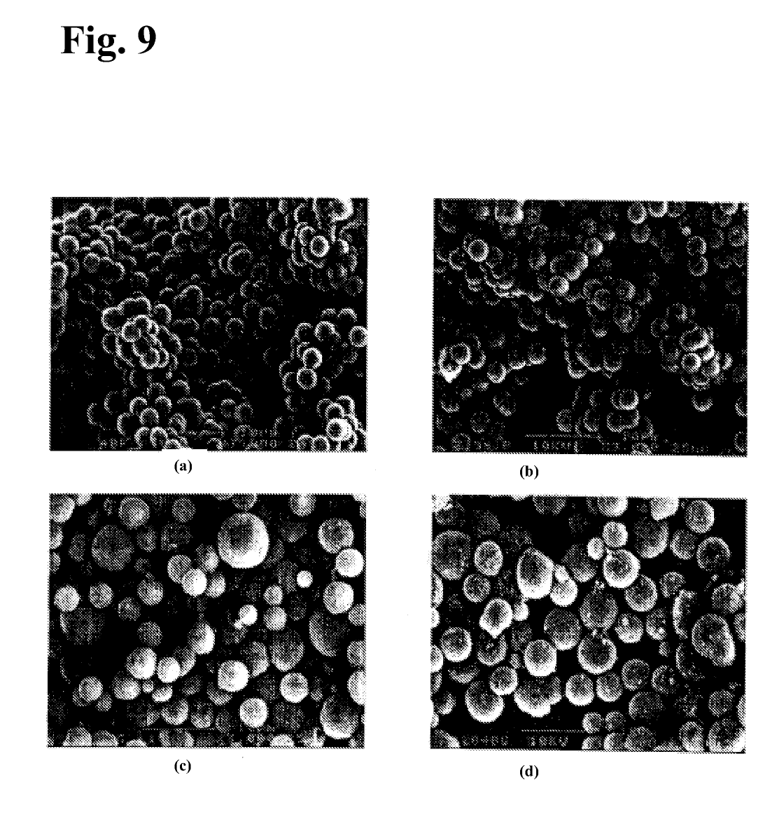

SEM micrographs of uncoated and QFITC-coated 2.5 μm and 4 μm microspheres are provided in FIG. 9. The small particles visible on the coated microspheres are due to aggregated secondary nuclei that have only become attached to the microspheres upon drying. There is no other evidence of a change in surface morphology between uncoated and coated microspheres. Using equation 3.1, the final particle size of any secondary nuclei at the reagent concentrations for these samples (i.e., [TEOS]=0.166 M, [NH₃]=0.496 M, [H₂O]=27.26 M) would be 6.7 nm. At these sizes, any physical attachment with a seed microsphere would be aggregative. Particle size analyses from these micrographs did not show a definite increase in size for FITC- or QFITC-coated 2.5 μm microspheres compared to uncoated 2.5 μm microspheres. Although there is an increase in the average radius of the microspheres (≈30 nm), the standard error associated with these measurements does not allow a significant result to be obtained (Table D). Giesche et al. found a similar increase in particle size of 20-25 nm for the seeded growth of an aminosilane on silica.

TABLE D
SEM particle size measurements for coated
and uncoated 2.5 μm microspheres

| SAMPLE | Average radius (μm) |
|---|---|
| Uncoated | 1.293 ± 0.062 |
| S1 | 1.333 ± 0.034 |
| S2 | 1.322 ± 0.030 |

### Multiple Fluorescent Shells

A combinatorial procedure is described above for preparing microspheres with shells of varying fluorescence intensities and different combinations of fluorescent dyes. When heterogeneous microspheres of varying size and shape are used as cores for shell formation, a very diverse population of microspheres results, which diversity can be used to track individual microspheres in combinatorial compound synthesis.

### Conclusions

Whether by an aggregative or monomer addition mechanism, the fluorophore-APS is permanently bound to the microspheres. Three fluorophores were successfully incorporated in these experiments, however any amine-reactive fluorophore could also be used. No increase in particle radius was found, indicating that the thickness of the shell is less than 30 nm. By modifying the surface of the fluorophore-APS coated microspheres with appropriate groups, e.g., steric-stabilisers, in order to replicate the surface properties of the uncoated microspheres, coagulation may be avoided in successive seeded growth experiments.

### Example 4

### Flow Cytometry Measurements

### Introduction

The most common optical properties measured in a flow cytometer are forward light scatter, side light scatter and fluorescence intensity at different excitation and emission wavelengths. Of these optical properties, fluorescence offers the most potential for encoding microspheres, due to the wide variety of available fluorophores from the UV, visible or near-infra red spectrums (Haugland R P, 1996, supra). As each fluorophore can be covalently incorporated into the microspheres using similar reagents and synthesis, the encoding strategy can be upgraded to include additional fluorophores.

### Light Scatter Measurements

Forward light scatter measurements of spherical micrometre-sized cells or particles can be predicted using Mie's theory of scattering and are often used as an estimation of cell or particle size. Although forward light scatter has been used to differentiate damaged cells from live cells, the dependence of the scattering intensity on surface morphology, changes in refractive index and absorption at the illumination wavelength limits its usefulness as an independent reproducible parameter (Shapiro, 1995, supra). In addition, forward scatter measurements are also dependent on instrumental parameters such as the flow rate, diameter and composition of the hydrodynamically focused sample stream (Kettman et al., 1998, supra).

In contrast, side scatter is independent of most of these instrumental factors, although it is extremely sensitive to the refractive index and size of the particle. Fortin et al. (1999, Cytometry, 36: 27-35) used small non-fluorescent polystyrene microspheres (0.1 to 0.5 μm) coated with monoclonal antibodies to detect the presence of particular antigens on the surface of sample cells. Upon binding to their specific antigen on the surface of the cells, the coated microspheres induced a well-defined shift in the side scatter measurements. Of particular interest, Kettman et al. (1998, supra) routinely use side scatter measurements to identify single microspheres from debris, dust and aggregates in their microsphere-based immunoassays. Hence, forward and side scatter are best used as control parameters to select only those microspheres of interest, while the many fluorescent parameters available provide the optical encoding for each microsphere.

### Fluorescence Measurements

Upon absorption of an incident photon, a fluorophore will undergo a transition from a ground state to an excited singlet state. The fluorophore can then be deactivated back to the ground state via three main pathways important to flow cytometry measurements:

Fluorescence: The fluorescence intensity of a fluorophore is related to its extinction coefficient at the excitation wavelength, its quantum yield (often environment sensitive) and its concentration. Haugland (1994, “Spectra offluorescent dyes used inflow cytometry”. Chapter 37 in Methods in Cell Biology, vol 42. Academic Press, Inc.) notes that most organic dyes have symmetrical absorption spectra whose extinction coefficients decrease by ≈50% at ±10-20 nm and by ≈90% at ±20-40 nm from the absorption peak. It is therefore important to choose fluorophores that absorb near the excitation lasers used in the flow cytometer (usually 488 nm argon ion or 633 nm red HeNe laser although other lasers are available).

The amount of spectral overlap between fluorophores is also of importance in flow cytometry. For each excitation laser there may be up to five detectors, each measuring a specific range of wavelengths as dictated by the optical filters and dichroic mirrors used in the optical array. Fluorophores are usually chosen that: (a) absorb strongly at the excitation wavelength and (b) are specific to the emission wavelength range measured by a given detector. As organic dyes have typically broad emissions though (Fortin et al., 1999, supra), a number of other fluorophores may contribute to the total intensity measured by a given detector. Although desirable to choose fluorophores with minimal overlap between their emission spectra, it is rarely possible, particularly if five detectors are used with the same excitation laser.

It is possible however, to compensate for overlapping spectra by analysing microspheres that only contain one fluorophore and determining the amount of “spillover” fluorescence from that fluorophore on to the other detectors, a process known as fluorescence compensation. The aim is to find the percentage of the fluorescence intensity measured by the correct detector (for that fluorophore) that needs to be subtracted from each of the other detectors to equal zero intensity. This may either be achieved at run-time using analogue compensation or post-hoc using software digital compensation, but it is not yet possible to perform run-time digital compensation (Bigos et al., 1999, Cytometry, 36:36-45). Effective fluorescence compensation, preferably run-time digital compensation, is essential for the proposed encoding strategy in order to utilise as much of the available parameter space as possible.

Fluorescence Resonance Energy Transfer: Scott et al. (1997, Bioorg Medicinal Chem Lett, 7(12): 1567-1572) has demonstrated for polystyrene-based microspheres covalently attached to the fluorophore, dansyl, that while fluorescence intensity is directly proportional to the amount of dansyl loaded onto each microsphere for low levels of loading (<1%), above a 5% loading the fluorescence intensity decreases sharply. This effect is caused by fluorescence resonance energy transfer (FRET).

FRET is a non-radiative process in which an excited donor molecule attached to one site in a microsphere transfers energy to an acceptor molecule attached at a second site, through a dipole-dipole coupling that is inversely proportional to the sixth power of the distance between the two molecules (Selvin, 1999, “Applied fluorescence in chemistry, biology and medicine”, Chapter 19, W Rettig, New York, Springer). The efficiency of energy transfer, E, is given by the ratio of the energy transfer rate constant, k_{T}, to the total sum of the rates of all processes by which the donor molecule can return to its ground state (Clegg R M, 1996, “Fluorescence resonance energy transfer”, Chapter 7 in Fluorescence imaging spectroscopy and microscopy (Ed. Wang X F):

$$E = \frac{{k}_{T}}{{k}_{T} + {\sum }_{i \neq T}^{ } {k}_{i}} = \frac{1}{1 + {( R / {R}_{0} )}^{6}} \qquad ( 4.1 )$$

where R is the distance between the two molecules and Rₒ is the critical distance for effective energy transfer, given by E=0.5 (ie. when R=Rₒ). Rₒ is typically 20-55 Å for organic dyes. Scott et al. also found that Rₒ increases with an increasing Stoke's shift between the donor and acceptor molecules.

FRET thus places an upper limit on the concentration of fluorophore that can be loaded onto a given microsphere, i.e., higher concentrations of fluorophore will not result in an increase in fluorescence intensity and will in fact cause a decrease in measured intensity.

Photodegradation: Each time a fluorophore is excited, there is a finite probability that it will undergo a change and be rendered non-fluorescent. This can occur through either a chemical reaction between the fluorophore and other reactive molecules such as molecular oxygen and free radicals, or through a direct photochemical reaction of the fluorophore itself (International Application No PCT/AU98/00944). Although fluorophores are usually only excited for a short time by the laser in a flow cytometer (≈10-20 μs, depending on sample flow rate and width of the focused laser beam), this allows time for ≈100 excitation-emission cycles to be performed. Fluorophores such as fluorescein, that are well known to suffer from photodegradation, can undergo 10⁴-10⁵ excitation-emission cycles before degrading (Melamed et al., 1990, “Flow Cytometry and Sorting”, 2^{nd} edition, New York, Wiley-Liss). As the microspheres in the proposed encoding strategy need to be re-analysed by a flow cytometer in every cycle of the split-and-mix process in addition to the pre-encoding and final screening analyses, it is imperative that the fluorophores incorporated in the microspheres are relatively photostable in order to reliably encode each microsphere based on the magnitude of its fluorescence intensity.

### Experimental

### Instrument

Samples were run on a Becton Dickinson FACSort™ (BD FACS) flow cytometer (15 mW, 488 nm argon ion laser) equipped with 525, 575 and 650 nm detectors, and acquired using CellQuest™ software. Data analysis was performed using WinMDI™ 2.7 and FCS Express. Linear forward light scatter (FSC), side light scatter (SSC) and fluorescences (FL1, FL2 and FL3) were recorded for each event using a MED flow rate (see Table C).

### Calibration

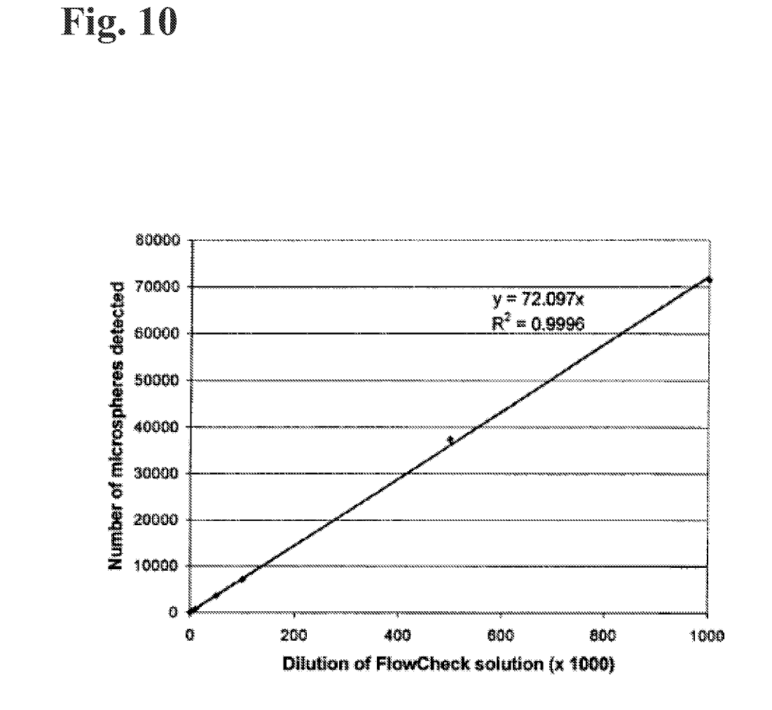

To assess the accuracy of the flow cytometer in detecting microspheres of interest, eight different dilutions of a solution of Coulter Flow-Check™ 6 μm microspheres (known concentration of 1.0×10⁶ microspheres mL⁻¹) were sampled for two minutes. Total counts of microspheres detected (using a polygonal gate on a bivariate plot of FL1 and FL3) were found to be linearly dependent (R²=0.9996) on dilution over a 1:1000 to 1:1 range (refer FIG. 10).

### Population Classification and Sorting

A population of three different microspheres was prepared by dispersing 1.0 mg of 10 μm greenF, 1.3 mg of 10 μm redF and 1.1 mg of 12 μm red-greenF microspheres (all from Micromod) each in 2 mL of MilliQ™ water. 700 μL, 650 μL and 800 μL from the 10 μm greenF, 10 μm redF and 12 μm red-greenF dispersions respectively were then combined in a BD FACS sample tube and sonicated for ten minutes. A similar mix was also prepared and added to 50 mL of MilliQ™ water in a BD FACS vial used for collecting sorted cells.

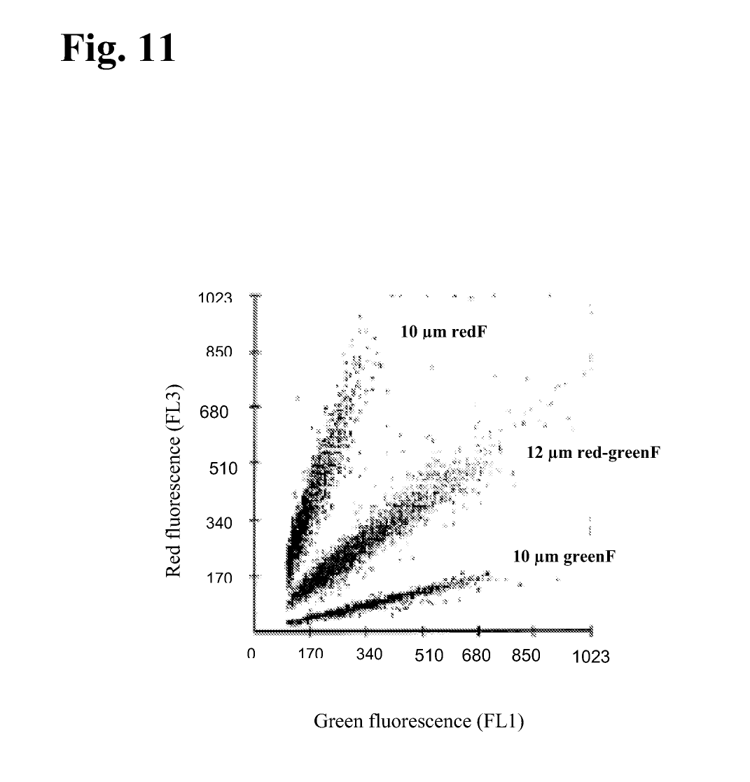

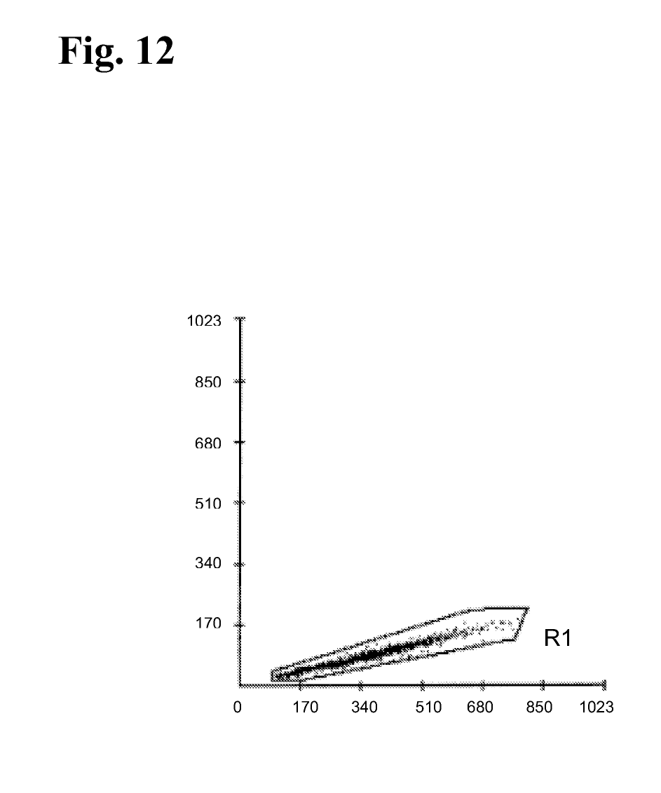

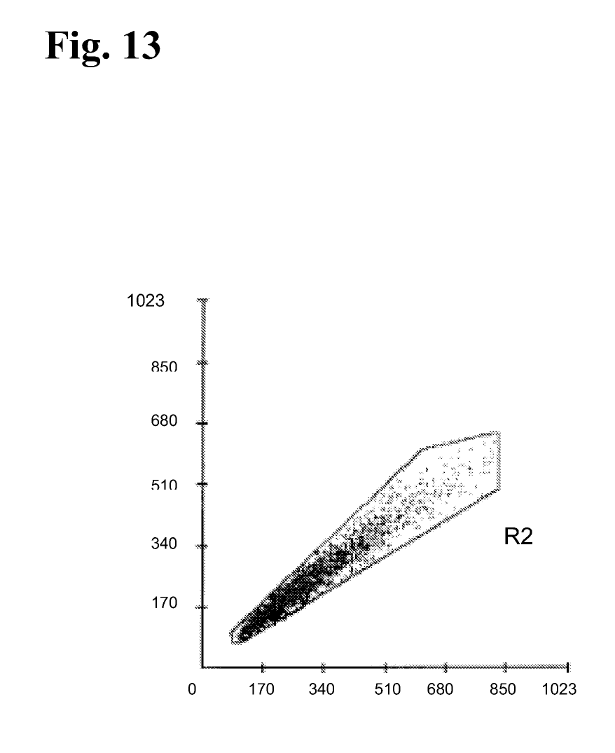

By setting appropriate PMT voltages for FL1 and FL3 it was possible to classify each of the three different microspheres into distinct populations (FIG. 11). Gates were then used to collect 100 000 microspheres from the 10 μm greenF population and 100 000 microspheres from the 12 μm red-greenF into separate BD FACS 50 mL vials (FIG. 12) and FIG. 13).

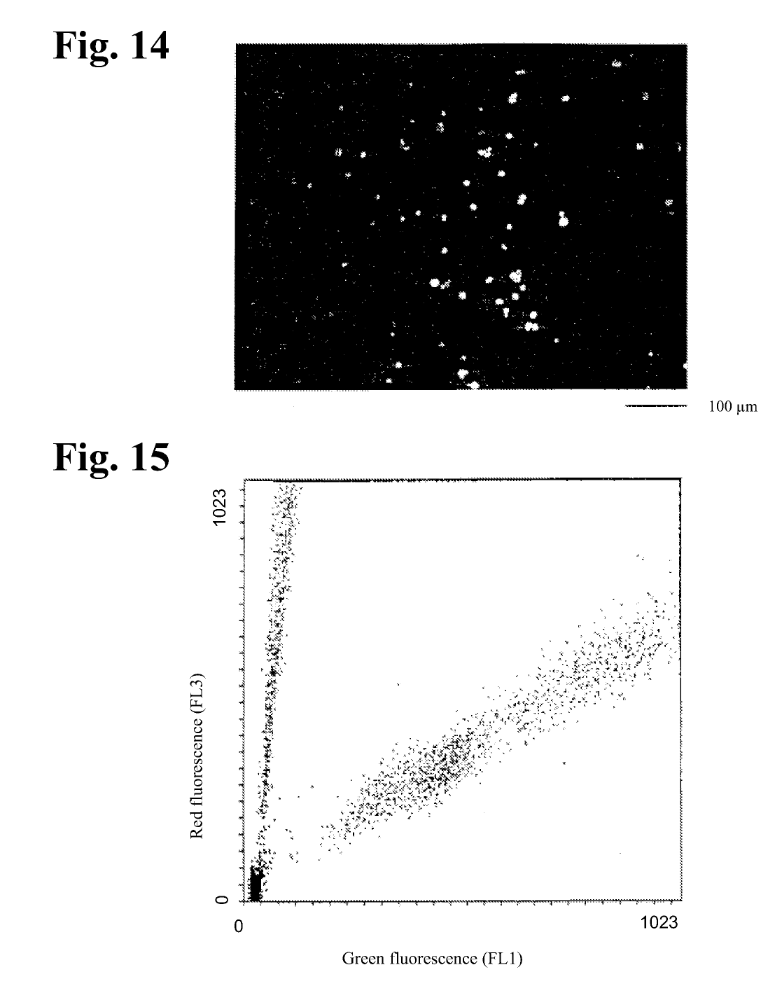

The three 50-mL solutions (original mixture, 10 μm greenF and 12 μm red-greenF) were passed through a Millipore 0.8 μm filter using a manual 60 mL syringe. Fluorescence microscopy photos were then taken of each filter to visually determine the purity of the sort as compared to the original mixture (FIG. 14). No microspheres were observed in the filtrate, indicating that Millipore 0.8 μm filters provide an effective method of concentrating microspheres for viewing purposes. Interestingly, microspheres displayed great affinity for the ink grid present on the filter.

### Measurement of Fluorescently-Coated Microspheres

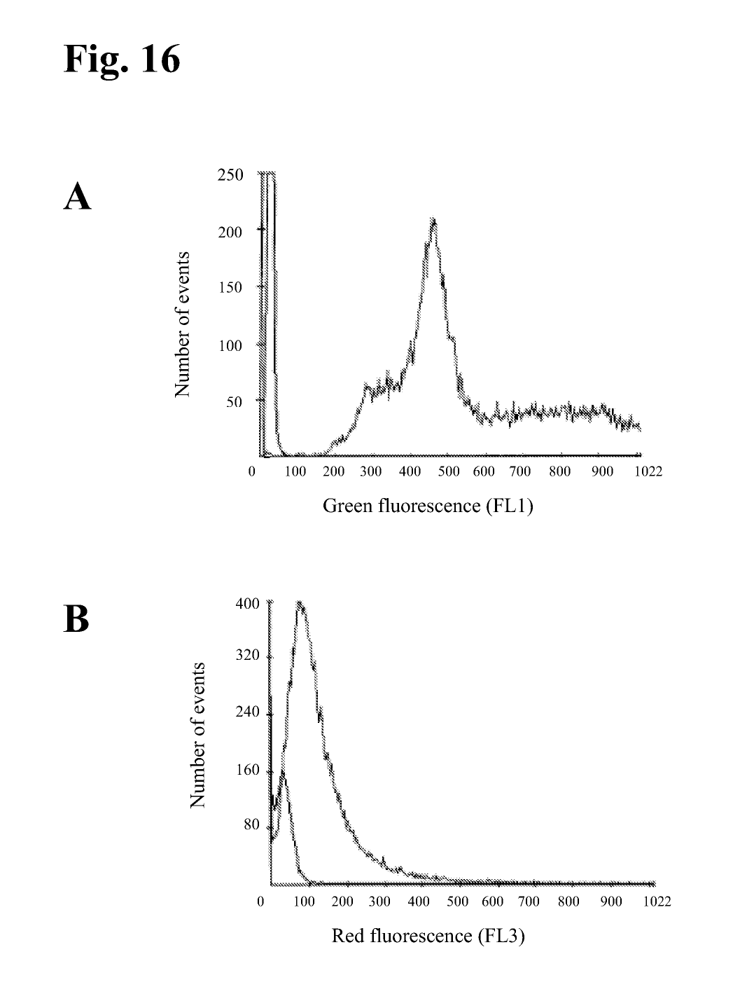

Samples S1 (FITC), S2 (QFITC) (refer Table C) and a dispersion of uncoated 2.5 μm microspheres (all dispersed in MilliQ™ water) were analysed using FL1 and FL3 to determine if there was any measurable difference between the uncoated microspheres and each of the coated microspheres. There was a clear distinction between all three populations using FL1 and FL3 (FIG. 15). Histograms of S1 on FL1 and S2 on FL3 show a distribution of fluorescence intensity about a mean value significantly higher than the uncoated microspheres (refer FIG. 16).

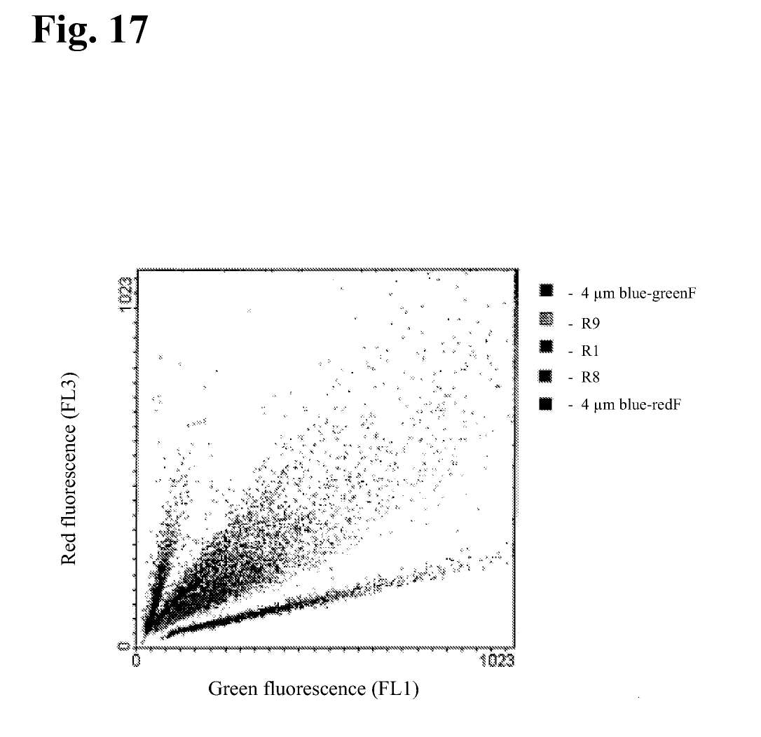

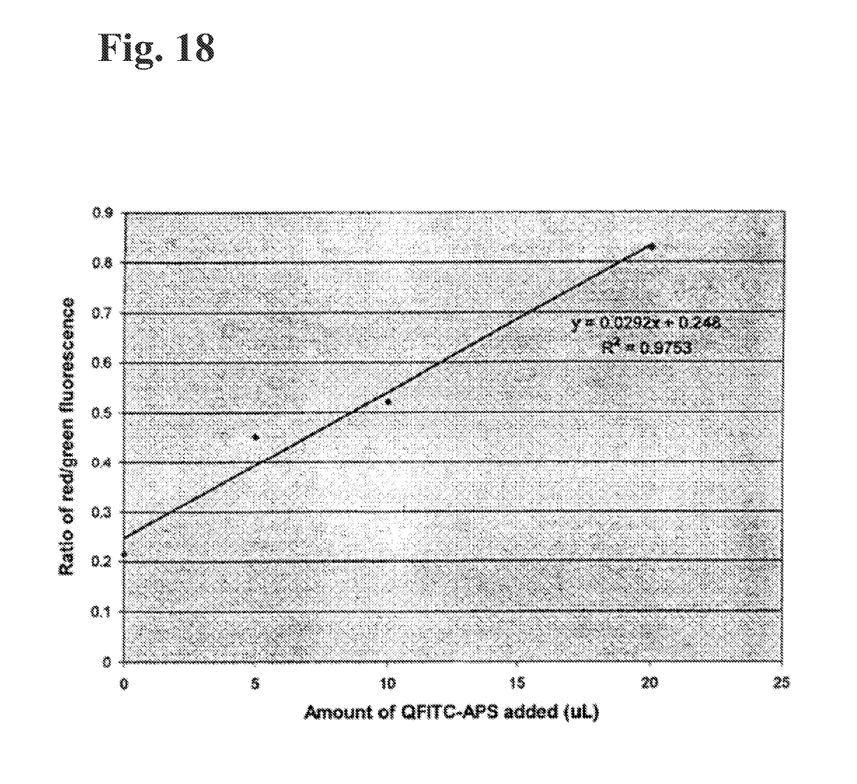

Samples R1, R7 and R8 (Table C), and a dispersion of uncoated 4 μm blue-greenF microspheres (all dispersed in MilliQ™ water) were also analysed using FL1 and FL3 to measure the change in average fluorescence intensity against the concentration of QFITC. The presence of fluorescence resonance energy transfer would also be evident if any non-linearity existed at the higher concentrations of QFITC. Bivariate plots of FL1 and FL3 for all four samples are presented in FIG. 17. A graph of the ratio of FL3 intensity to FL1 intensity against the amount of QFITC added (in μL) is given in FIG. 18. The linearity of the graph (R²=0.9753) suggests that energy transfer is not occurring.

### Precision Measurements

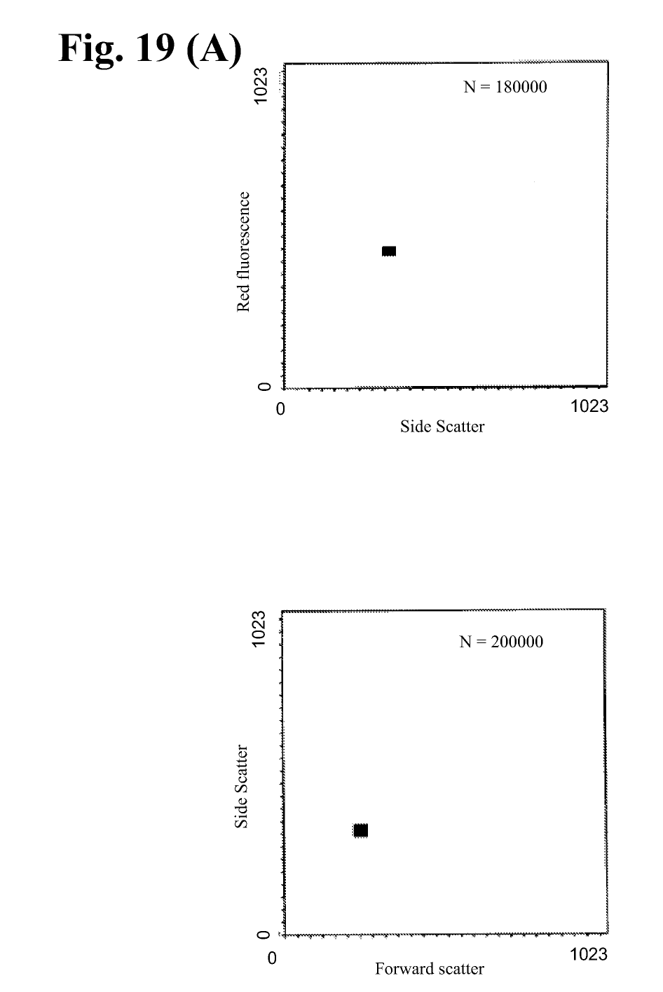

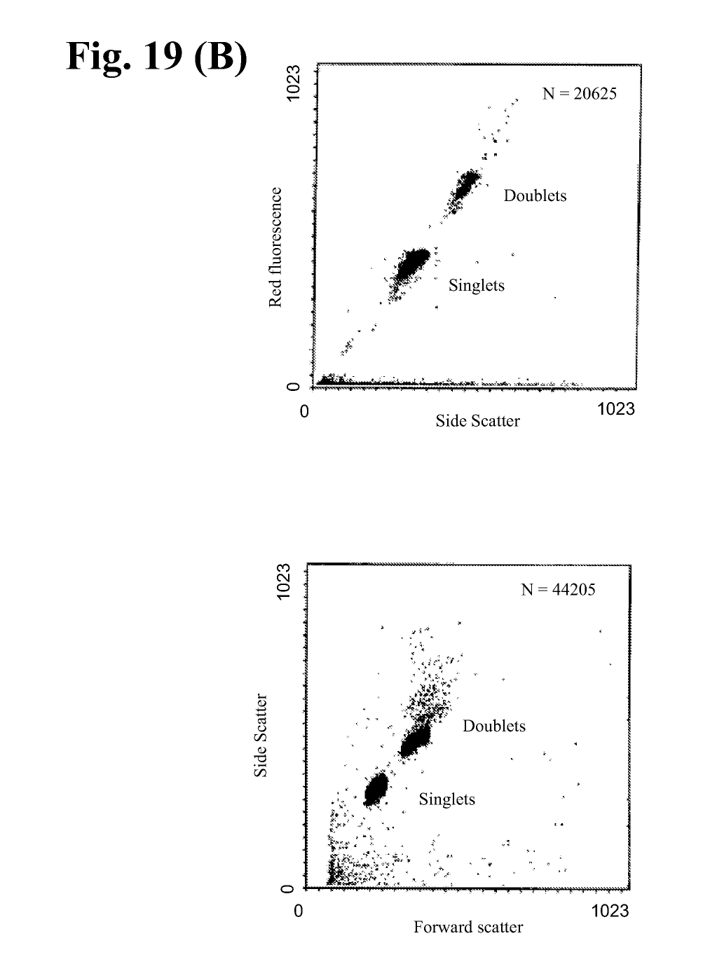

A population of Coulter Flow-Check™ 6 μm microspheres was sorted and re-analysed to experimentally determine the values of rl and rh (defined in Example 2 under “Pre-encoding optically diverse microspheres”) for three parameters (FS, SS and FL3) using linear values (log values are incompatible with the software developed in Example 5). Parameters were evaluated in pairs by using a double-gated approach. Microspheres were first broadly gated on the parameter not being evaluated (e.g., FL3) before a well-defined gate was established on the two parameters under evaluation (e.g., FS and SS). This allowed only single microspheres to be collected. Aggregates were undesirable as they could potentially have a different orientation with respect to the laser beam on re-analysis, whereas the single microspheres were spherical. Two populations of 200000 microspheres each were collected in 50 mL BD FACS vials: one using a well-defined FS and SS gate and the other using a well-defined SS and FL3 gate (FIG. 19(a)).

As a FACSort™ uses mechanical sorting, the sorted microspheres were heavily diluted (≈1:5000). The 50 mL solutions were concentrated back down to 0.5 mL by partitioning the solution into eight smaller culture tubes, centrifuging at <1000 rpm for 5 minutes and carefully removing the supernatant so that only ≈0.25 mL remained in each culture tube. A well-formed pellet of microspheres, though small, was clearly visible in each culture tube. The remaining solution from all culture tubes was washed and combined into a single BD FACS tube (total volume now 3 mL). This tube was also centrifuged at <1000 rpm for 5 minutes and had its supernatant carefully removed so that ≈0.5 mL remained. This volume was then analysed in its entirety using identical instrument settings to when it was first sorted except that no gate was applied, ie every event was recorded. Bivariate plots of the two re-analyses are given in FIG. 19(b).

Data analysis was performed using Microsoft Excel™ to construct a frequency histogram of the deviation of each microsphere (expressed as a number of channel numbers) below or above the original well-defined gates for each parameter. Values for rl and rh for FS, SS and FL3 (Table E) were then determined by finding the maximum deviation within which >99.9% of all microspheres returned.

Data analysis was performed using Microsoft Excel™ to construct a frequency histogram of the deviation of each microsphere (expressed as a number of channel numbers) below or above the original well-defined gates for each parameter. Values for rl and rh for FS, SS and FL3 (refer Table E) were then determined by finding the maximum deviation within which >99.9% of all microspheres returned.

TABLE E
Values for rl and rh for the three parameters evaluated above under
the section entitled “Precision measurements”^{†}

| Parameter | rl | rh |
|---|---|---|
| FS | 33 | 15 |
| SS (FS) | 45 | 7 |
| SS (FL3) | 38 | 12 |
| FL3 | 47 | 0 |

^{†}The Flow-Check microspheres did not fluoresce in the remaining two parameters (FL1 and FL2).

### Discussion

### Optically Diversity

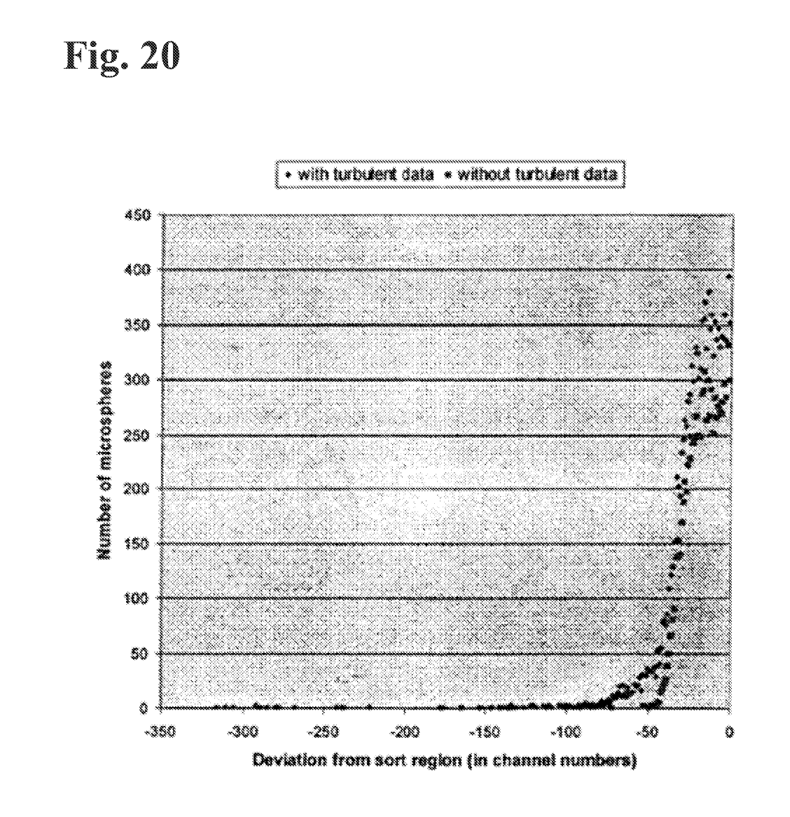

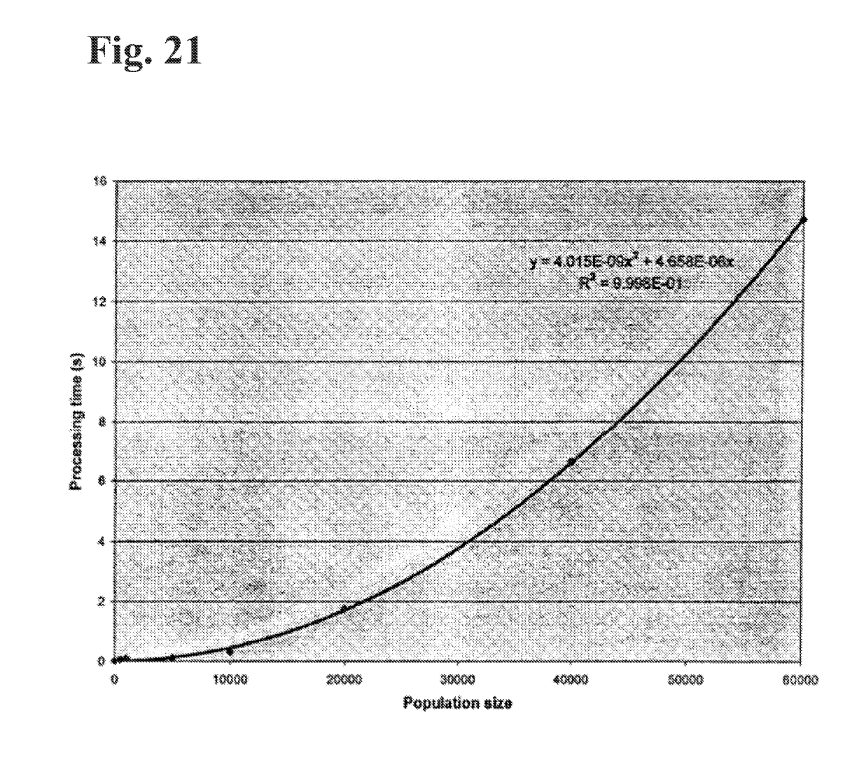

For different concentrations of a given fluorophore, the emission spectra may change in maximum intensity but the shape of the emission spectra will remain constant for low concentrations of that fluorophore. Thus, the ratio of fluorescence intensity for two different wavelengths or regions will remain constant. This can be seen in the correlation between microspheres from the same population in FIGS. 12 and 20. There is also a strong correlation between forward light scatter and fluorescence intensity for all fluorescence parameters (i.e., microspheres with low fluorescence intensities have low forward scatter intensities), hence forward scatter is not an independent parameter.

In contrast, FIG. 17 demonstrates that red and green fluorescence are independent parameters with respect to each other. The linear relationship between the ratio of red to green fluorescence and the amount of QFITC-APS added in FIG. 18 suggests that, at the concentrations of QFITC used, negligible fluorescence resonance energy transfer is occurring. The fixed location of each fluorophore in the fluorescent shell may also prevent effective orientation of the donor and acceptor molecules. It is therefore possible to synthesise a population of microspheres with any desired average ratio of red to green fluorescence between the two limits defined by the average slope of the uncoated 4 μm blue-greenF and 4 μm blue-redF microspheres.

Fluorescence compensation between FL1 (green) and FL3 (red) is not possible on a BD FACS. To illustrate the need for effective fluorescence compensation between all parameters, consider the combinations of red and green fluorescence that are outside these limiting slopes in FIG. 17. To maximise the number of unique microspheres that can be encoded, the entire parameter space should be utilised. This may require the use of a fluorescence compensation matrix for all fluorophores used as described in Roederer et al. (1997, Cytometry, 29, 328-339) and Bigos et al. (1999, supra), which are incorporated herein by reference.

### Resolution

The resolution of the flow cytometer and the stability of the fluorophores incorporated into each microsphere are the major factors in the reproducible measurement of the optical parameters for each microsphere. FIG. 10 demonstrates that the number of microspheres detected is directly proportional to the number of microspheres in the sample population, hence the detection of each microsphere is not affected by the concentration of the population within the range of concentrations examined (i.e., up to 1×10⁶ microspheres mL⁻¹) at a sample flow rate of 35±5 μL min⁻¹. Therefore the detection of each microsphere can be considered in isolation.

The possible sources of variation in the measurement of optical parameters for each microsphere arise from either the flow cytometer, e.g., laser power fluctuation, optical alignment, electronic noise, or from the microspheres themselves, e.g., effect of photodegradation, solvent polarity and pH on fluorophores. Other important factors include variation in scattering or fluorescence intensity induced by the compounds (eg. polypeptides, oligonucleotides) synthesised on to the surface of the microspheres, as well as aggregation of the microspheres due to colloidal instability in organic solvents required for the combinatorial synthesis.

The stochastic (i.e., random in time) processes of: (a) fluorescence emission of a photon and (b) liberation of photoelectrons in the detectors represent a theoretical minimum CV of 1% (Selvin et al., 1999, supra). Certainly, the re-analysed populations in FIG. 19(b) do not approach this degree of resolution, however analysis of the data provides further insight. The majority of the noise can be removed by a polygonal gate on FL1 and FL3 to filter out noise caused by bubbles and debris, as these entities are rarely fluorescent (this is evident in the population of “microspheres” at low intensities of red fluorescence in FIG. 19(b)). Aggregates (eg. doublets and triplets) were caused by the centrifugation required to reduce the volume of the sorted microspheres from 50 mL to the 0.5 mL required for practical reanalysis. This centrifugation and subsequent aggregation could be avoided by using an electrical droplet sorter rather than a mechanical sorter. However, by gating the aggregate population on FS and SS as well as on FL1 and FL3, aggregates can be filtered out. Thus, through the use of gates such as those used in FIGS. 12 and 13, debris and aggregates can be removed, allowing only single microspheres to be analysed.

The values of rl and rh obtained for FS, SS and FL3 in Table E indicate a definite shift to lower values upon reanalysis. Although FL1 and FL2 were not specifically evaluated, the optical collection system, detectors and electronics are very similar to those used for FL3. A lower shift for FL3 is expected due to photodegradation, however forward and side scatter were expected to shift to both higher and lower values. This overall downward shift can be explained by considering the change in solvent from a surfactant solution used for longtime storage of the microspheres, into a solution heavily diluted with sheath fluid (ie. MilliQ™ water) after being sorted. It is expected that further reanalyses of the population would not continue to shift downwards after this initial change in solvent.

### Conclusions

A population of QFITC-coated microspheres that is approaching optical diversity has been analysed using flow cytometry. As energy transfer is not occurring at the concentrations used, it is possible to synthesise a population of microspheres with any desired ratio of red to green fluorescence using QFITC-APS and 4 μm blue-greenF microspheres.

### Example 5

### Software Development

### Introduction

In order to process microspheres at the rate provided by high-speed flow cytometers (eg. 100,000 events s⁻¹), an algorithm had to be designed that could achieve two important tasks:
1. obtain parameter values for each microsphere and make a decision to collect or reject a given microsphere on the basis of its parameter values
2. record synthetic history of microspheres through the combinatorial split-and-mix process

Two algorithms were developed and programmed to handle these tasks: a post-acquisition and a real-time algorithm. Both algorithms make use of the concept of gridspaces as defined in Example 2 (“Pre-encoding of optically diverse microspheres”). The post-acquisition algorithm is a static algorithm (i.e., no time dependency) that uses dynamic allocation of gridspaces, whereas the real-time algorithm is a dynamic algorithm (i.e., time dependent) that uses a static allocation of gridspaces. It is the dynamic aspect of each algorithm that is most difficult.

### Method

FCS 2.0 file data (Dean et al., 1990, Cytometry, 11: 321-322) for the sample populations in Table D were acquired using the method described in Example 4 (“Measurement of fluorescently-coated microspheres”). A total of 100 000 events was recorded for each sample. A number of random data files were also created usual Microsoft Excel™ to simulate a population with ideal optical diversity.

To analyse the flow cytometry data using the algorithms, parameter values for all FCS 2.0 files were extracted using FCS Express™ and imported into Microsoft Excel™. This allowed the data to be saved as a tab delimited text file without a header, and also allowed the data to be sorted in ascending order on any desired parameter.

Both algorithms were programmed using the C programming language (Kelley and Pohl, 1995, “A book on C”, 3^{rd} ed., New York, Addison-Wesley) and compiled using a gcc for DOS compiler.

Measurements of algorithm speed were made on a Dell 400 MHz PC using system calls to the DOS command time. Small modifications to each algorithm were also made when necessary to obtain additional information about the performance of each algorithm.

### Post-Acquisition Algorithm

### Objective

The main objective of this algorithm was to obtain optical data of a population of microspheres and generate a list of optically unique microspheres within that population. As the instrument used in this study was not available to be modified, the algorithm was developed such that it did not require any modification of the instrument.

### Theory

A microsphere, Mᵢ, was deemed optically unique if:

(∀Mⱼ)(∃p)|Mⱼ(p)−Mᵢ(p)|>Eₚ (5.1)

where Mⱼ is any other microsphere in the population, p is any parameter measured by the instrument, M(p) is the value for parameter p for a particular microsphere, and Eₚ is a user-defined value based on the precision of repeated measurements of the same population for that parameter.

### Requirements

The post-acquisition algorithm was developed for use with four parameter data only. The data must first be sorted in ascending order on the first parameter (to improve algorithm efficiency), and any header information removed. Data must also be saved as a tab-delimited text file in the following format:
<integer><\t><integer><\t><integer><\t><integer><\t><integer><\n>

The first integer is the number given to each microsphere in the order they were recorded by the instrument, and the following four integers correspond to each of the four parameter values.

Description The post-acquisition algorithm is implemented after acquiring data for a given population. It starts with the first microsphere recorded in the population, and determines if it is optically unique using equation 5.1. If a given microsphere is optically unique, it is added to another linked list known as the master list. The master list allows a unique microsphere to be identified if present in a subset of the population.

If a given microsphere is not optically unique, it and all other microspheres from which it is optically indistinguishable are labelled as duplicates. Duplicates are not added to the list of unique microspheres, however it is important to realise that no microspheres are rejected from the population. Duplicate microspheres continue to undergo the combinatorial synthesis along with the unique microspheres in the population, however their synthetic history is not recorded by the post-acquisition algorithm.

The unique microspheres, on the other hand, are tracked through the split-and-mix process. To determine which of the unique microspheres are in which batch during a given cycle of the split-and-mix process, each batch of microspheres is reanalysed by the flow cytometer, and the data recorded under exactly the same instrument conditions for each batch.

When the data from each batch is processed using the post-acquisition algorithm, the new data is compared to the master list. The algorithm is then reversed to determine which of the microspheres in the new data is optically indistinguishable from those in the master list. As the master list contains only unique microspheres, if a microsphere from the new data is optically indistinguishable with a microsphere from the master list, then it is highly likely that it is the same microsphere. The master list is then updated to show that the microsphere was present in this particular batch during a given cycle of the split-and-mix process. In this manner, optically unique microspheres can be tracked through the combinatorial synthesis.

Provision must be given for erroneous microspheres that are recorded as being optically indistinguishable from an optically unique microsphere. In this case, as it cannot be shown which is the erroneous microsphere, the unique microsphere is removed from the master list. Therefore, correct assignment of the user-defined precision values, Eₚ, is essential to the effectiveness of this algorithm.

### Results

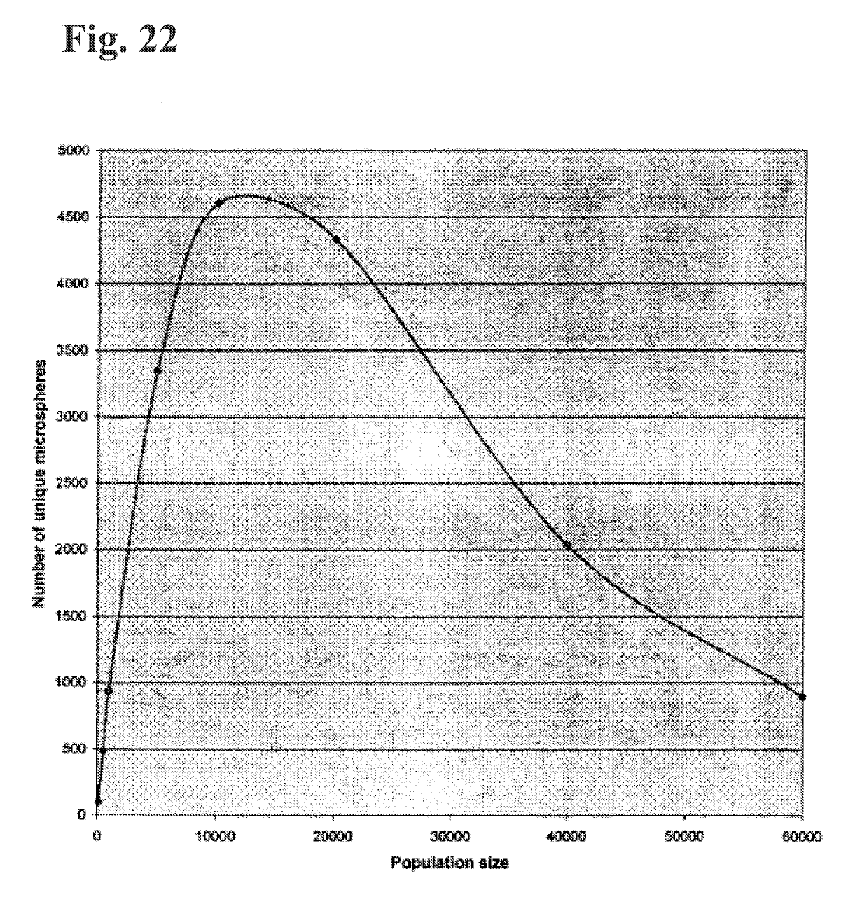

Time measurements for the main loop in CreateMaster™ were undertaken to determine the relationship between algorithm processing time and population size during the generation of the master list. It was predicted using orders of magnitude (Stubbs et al., 1993, “Data structures with abstract data types”, Boston, PWS) that the relationship was O(n²), i.e., processing time is proportional to the population size squared, as each microsphere must be compared to every other microsphere in the population. FIG. 21 is the result of measurements on random data of different population sizes. As predicted, algorithm processing time is proportional to the population size squared, with a binomial fit to the curve of R²=0.9998.

In addition, the number of unique microspheres in a population as a function of population size is presented in FIG. 22. Using a value of Eₚ=50 for each parameter (see the section entitled “Theory” relating to “Real-time algorithm”), this clearly shows a maximum number of unique microspheres of ≈4700 after approximately 12000 microspheres have been processed.

This effect is to be expected however, and represents a theoretical limit to the maximum number of unique microspheres it is possible to obtain from a given population using this algorithm. The limit arises from the fact that although initially there is an almost linear relationship (i.e., each new microsphere processed is unique), after ≈1000 microspheres have been processed any further microspheres have an increased probability of being optically indistinguishable from previously unique microspheres, resulting in a marked decrease after ≈12000 microspheres have been processed.

### Conclusions—Post-Acquisition Algorithm

The post-acquisition algorithm does not require any instrumental modifications and has been tested and shown to successfully generate a master unique list from a population of microspheres. Furthermore, unique microspheres can be identified as being present in subsequent batches during the combinatorial synthesis. The O(n²) relationship between algorithm processing time and population size though, means that for large population sizes (>100 000 microspheres) the processing time becomes prohibitive. However, as it is a static algorithm rather than a dynamic algorithm, rapid processing time is not essential. A more restricting factor is the self-limiting nature of the algorithm, whereby the number of unique microspheres decreases as the population size increases beyond an optimal size (dependent on the value of Eₚ).

### Real-Time Algorithm

### Objective

The main objective of this algorithm was to extract optically unique microspheres from a population by sorting based on desired optical properties. In order to be used in the synthesis of large combinatorial libraries, it also had to overcome the limitations of the post-acquisition algorithm, ie. O(n²) relationship and self-limiting nature.

### Theory

Unlike the post-acquisition algorithm, the real-time algorithm creates pre-defined gridspaces and then selects microspheres whose parameter values are located inside these gridspaces. The two distinct uses of the algorithm are to: (a) create an optically unique population of microspheres, and (b) record the synthetic history of all the microspheres in this population.

For (a) only, an internal sorting region is required (refer FIG. 6). Gridspaces and their internal sorting regions are created and labelled as empty before the population of microspheres is analysed. A microsphere is then deemed optically unique if its parameter values correspond to a gridspace that is labelled as empty. The gridspace is subsequently labelled as full. For a more complete definition, refer to the main loop in WriteArray™.

This algorithm also makes use of integer division to conveniently determine which microsphere corresponds to which gridspace. Integer division is similar to normal division, except the answer is rounded down to the nearest integer, e.g., 213/100=2 or 14/15=0.

### Requirements

The real-time algorithm was developed for use with any number of parameters and is currently implemented for the five parameters available in this study. Any header information must be removed and data must also be saved as a tab-delimited text file in the following format:
<integer><\t><integer><\t><integer> . . . etc. . . . <\n>
   where each integer is the value for a particular parameter. Unlike the post-acquisition algorithm, no identification numbers are required for the first integer, as the data from each microsphere is not stored internally.

A further, as yet unfulfilled, requirement is to provide real-time control of the sorting mechanism of the flow cytometer via the computer running the real-time algorithm.

### Description

Pre-encoding of microspheres: The real-time algorithm is applied during the analysis of the population of microspheres. User input is required to select the number of parameters and the width of the gridspaces on each parameter in order to create the array of integers. As described in Example 2 (“Pre-encoding of optically diverse microspheres”), all the gridspaces are initially empty and so their corresponding integer in the array is equal to zero.

As each microsphere is detected and analysed by the flow cytometer, the real-time algorithm determines which gridspace it corresponds to by using integer division of its parameter values to index the multidimensional array. If it is within the internal sorting region of the corresponding gridspace, and the gridspace is labelled empty (ie. zero), then a sort decision is made to collect that microsphere (hence the need for real-time control of the sorting mechanism). The label for that gridspace is then changed to full (ie. one). If it is outside the internal sorting region or if the gridspace is labelled full already, then a sort decision is made to reject that microsphere. In this manner, only optically unique microspheres are collected from the total population of microspheres. Note that the time taken to make this sort decision must be less than the time for the microsphere to travel from the observation point to the droplet break-off point.

Recording synthetic history of microspheres: To keep track of these unique microspheres through the combinatorial synthesis, the real-time algorithm is applied when each batch is re-analysed by the flow cytometer. As the internal sorting region was only necessary for the creation of an optically unique population, the algorithm now only needs to determine which microspheres correspond to which gridspace for a given batch task. An array of character strings of length n (where n is the number of cycles of the split-and-mix process and each character represents a particular reagent) with a one-to-one correspondence with the array of gridspaces can then be updated to include the synthetic history of each microsphere. These tasks can be performed post-hoc however, and do not need to be performed during the analysis.

### Results

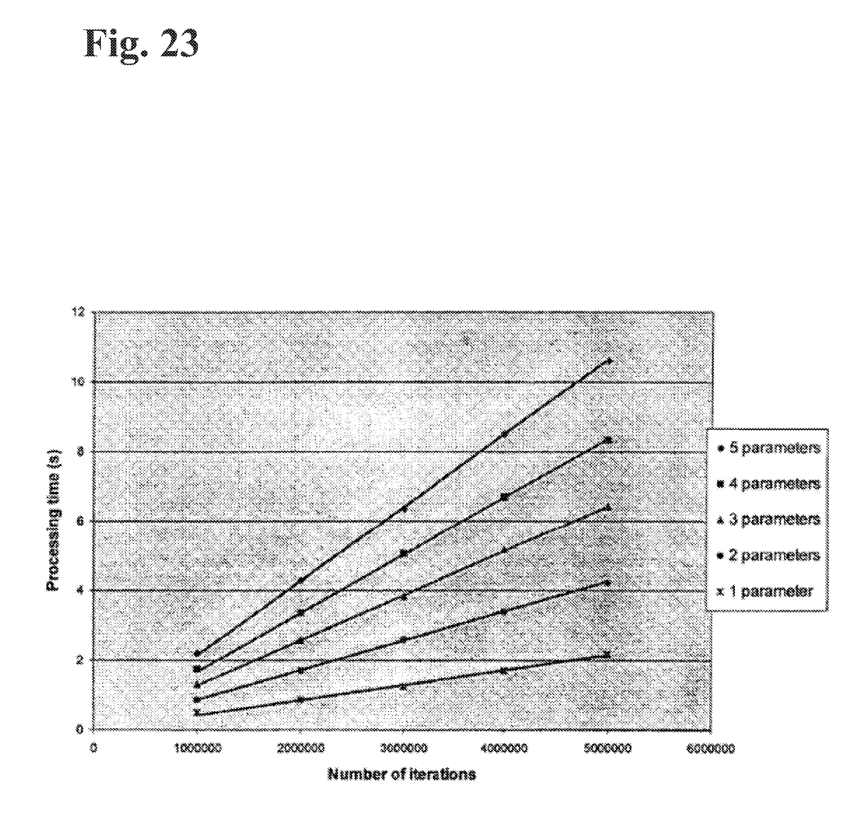

Time measurements for the main loop in WriteArray™ were undertaken to determine if the processing time for each microsphere was constant, and thus independent of population size. It was predicted using orders of magnitude (Stubbs et al., 1993, supra) that the relationship between processing time and the number of iterations of the main loop (equivalent to population size) is O(n). FIG. 23 is the result of measurements using different numbers of iterations for different numbers of parameters. As predicted, algorithm processing time is proportional to the number of iterations, with a linear fit of R²=0.9981 or better for each of the different numbers of parameters.

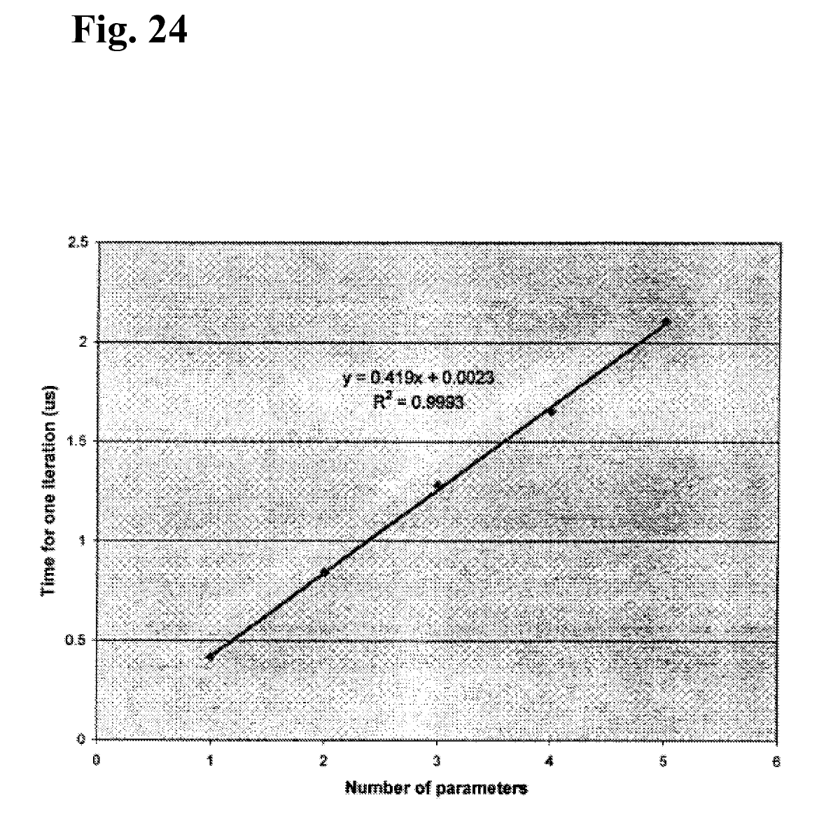

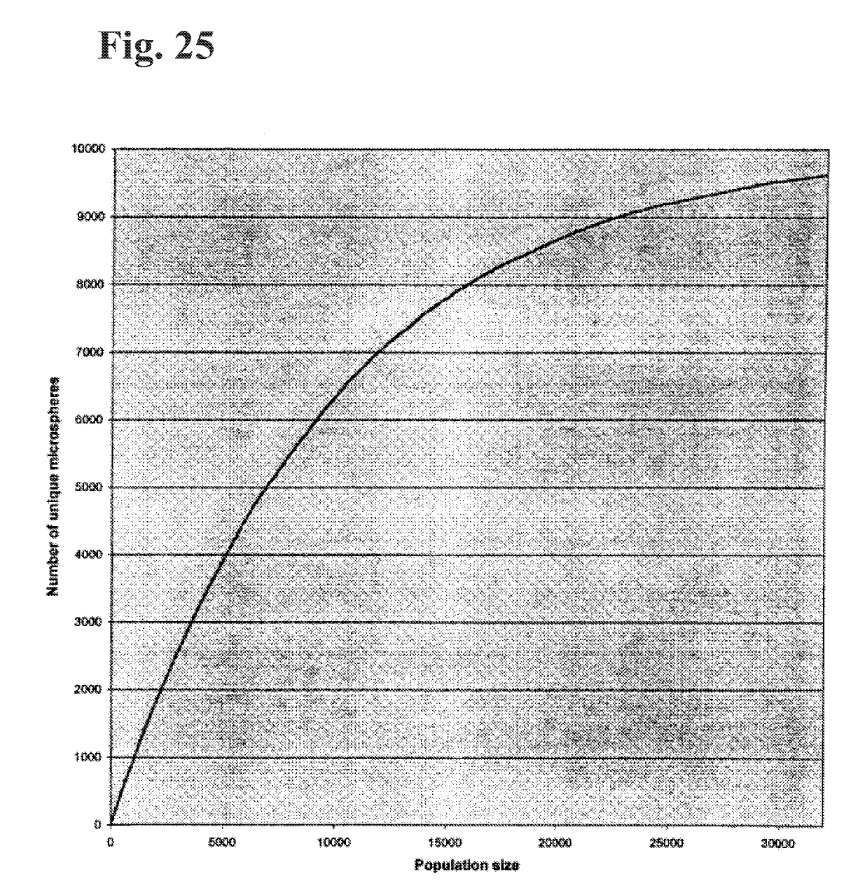

By plotting the slopes from FIG. 23 against the number of parameters, a second plot was obtained in FIG. 24 that gives an equation for the time for one iteration:

y=0.419x+0.0023 (5.2)

where y is the time in microseconds for one iteration and x is the number of parameters. Thus for seventeen parameters (maximum commercially available), the total time for one iteration is a constant 7.125 μs. This number is favourably comparable to the sort decision time required in high-speed flow cytometer sorters (eg. 6.5 μs for Coulter Elite™).

The only theoretical limit of this algorithm is the maximum number of gridspaces capable of existing within the entire parameter space. This is demonstrated in FIG. 25, in which the number of unique microspheres from a randomly generated population is plotted against population size.

The general form of this curve is given by:

y=A(1−e^{-kt}) (5.3)

where A is equal to the total number of available gridspaces, which in this case is given by four parameters each subdivided into ten regions (10⁴=10000).

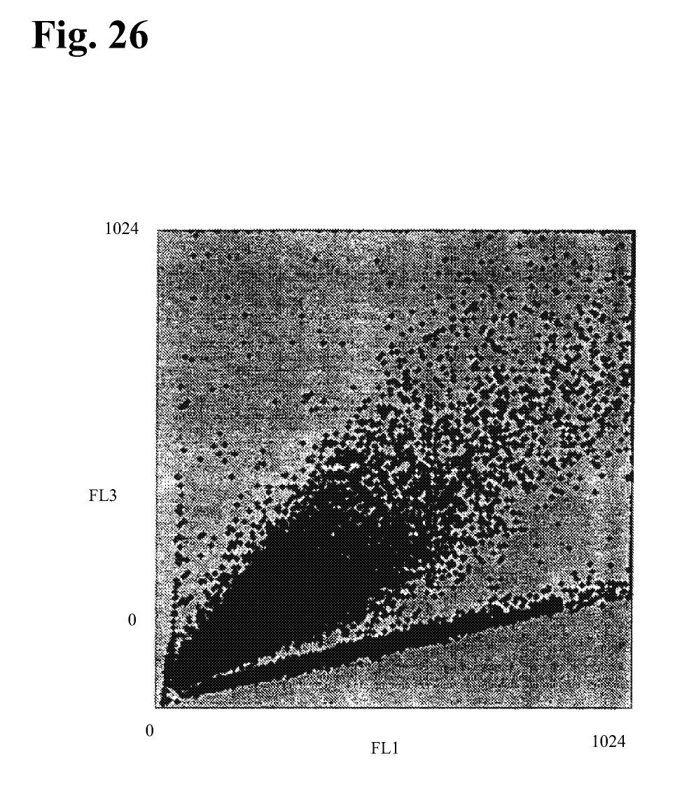

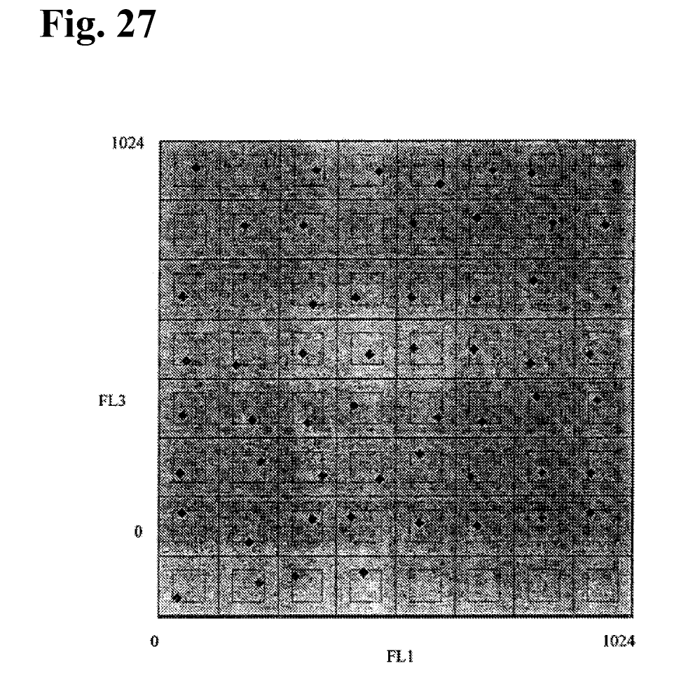

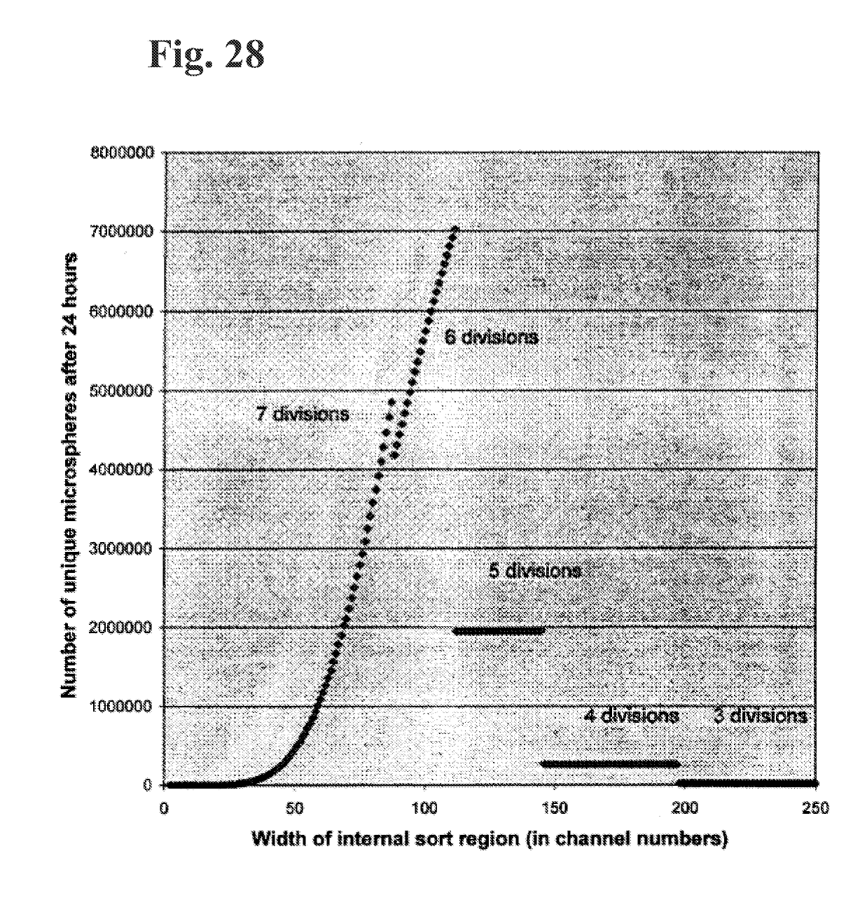

Data from an optically diverse mixture of QFITC-coated 4 μm blue-greenF microspheres from Example 4 (see FIG. 26) was pre-encoded in a two-parameter simulation to demonstrate the real-time algorithm. Using eight divisions along each parameter and user-defined values of rl=rh=30 channel numbers, the parameter space was divided into gridspaces each of width 128×128 channel numbers (ie. 1024/8=128), with an internal sorting region of 68×68 channel numbers. As the QFITC-coated microspheres are only optically diverse for FL1 and FL3, the remaining parameters (FS, SS and FL2) were made identical for each microsphere in order to negate their influence. Hence, the maximum number of unique microspheres is 64. The real-time algorithm was modified to save the parameter data from optically unique microspheres into a text file that was later plotted and overlaid with a graphical representation of the gridspaces (FIG. 27). Fifty-six of the available 64 internal sorting regions of the gridspaces were successfully occupied by a single micro sphere extracted from the total population using the real-time algorithm.

### Conclusions—Real-Time Algorithm

The real-time algorithm has the potential to handle the large number of microspheres required for large combinatorial libraries. It provides a constant sort decision time given by equation 5.2 that is independent of population size and dependent only on the number of parameters. Even for seventeen parameters the sort decision time is capable of processing high sorting rates (7.125 μs microsphere⁻¹). In addition, the maximum number of unique microspheres is equal to the number of available gridspaces. As the volume occupied by the available gridspaces is equal to the entire parameter space, this is therefore the highest possible number.

In order to implement fully this algorithm though, an interface needs to be established between the flow cytometer electronics and a computer. Although these needs are highly specific, previous research by Dvorak et al. (1991, J Microcomputer Appl, 14: 327-341) and Leary et al. (1993, U.S. Pat. No. 5,199,576; 1993, U.S. Pat. No. 5,204,884; 1997, Cytometry, 27: 233-238; 1997, Proc SPIE: Int Soc Opt Eng, 2982: 342-352) may prove to be useful. Dvorak et al. (1991, supra) describe an electronic interface between a flow cytometer and a microcomputer, and offer to supply complete working drawings for non-commercial use. This would be useful for determining sort decision times and developing supporting software in the future. Leary et al. (1993-1997, supra) have developed and patented a modified high-speed sorter that is dynamically “trained” to select the optimal sort characteristics such as drop delay and pulse integration time in order to obtain a given number of rare cells (eg. occurrence of 1 in 10⁶ cells) within a given assurance level, eg. 95%. Some detailed workings of the modified high-speed sorter are also provided for possible assistance (Dvorak et al., 1991, supra; Leary et al., 1993, supra). Alternatively, both Kettman et al. (1998, supra) and Bigos et al. (1999, supra) have successfully modified the electronics of a flow cytometer to suit their specific needs.

### Conclusions

In summary, the post-acquisition algorithm can be used without any modification to a flow cytometer to track optically unique microspheres through a combinatorial synthesis. Due to the O(n²) relationship between processing time and population size, and the self-limiting nature of the algorithm, it is recommended that it is unsuitable for the intended application of handling large combinatorial libraries.

### General Conclusions

The present method is predicated at least in part on the maximum library size that can be encoded and the sample throughput (i.e., number of samples processed per day). The number of optically unique microspheres that are extracted as a function of population size follows an asymptotic curve similar to FIG. 25. As the number of microspheres detected per second is approximately constant, the population size can be expressed in units of time instead. A predictive equation for the number of optically unique microspheres, U, extracted from a population as a function of time has been developed and has the following general form:

U=N(1−e^{-kαβt}) (5.4)

The variables in this equation can all be obtained from the equations and relationships defined throughout this study. Equation 5.4 is based on the general form of Equation 5.3, and N is thus equal to the total number of available gridspaces, given by a slight modification of Equation 2.6:

$$N = \frac{{1024}^{p}}{{\prod }_{i = 1}^{p} ( {v}_{i} )} \qquad ( 5.5 )$$

where p is equal to the number of available parameters and vᵢ is the width of each gridspace for the ith parameter. The width of each gridspace equals:

vᵢ=rlᵢ+rhᵢ+wᵢ (5.6)

where rlᵢ and rhᵢ are the lower and higher ranges as defined in Example 2 (and experimentally determined in Example 4) and wᵢ is the width of the internal sort region in each gridspace for the ith parameter.

The value of wᵢ is also important for calculation of α, which represents the percentage of each gridspace occupied by the internal sort region. In FIG. 25, rl and rh were equal to zero and hence α=1. This represents a maximum case where every microsphere that occupies a vacant gridspace is extracted. In more realistic scenarios where α<1, only microspheres that occupy the internal sort region of a vacant gridspace are extracted. Hence, α is a multiplying factor given by:

$$α = {\prod }_{i = 1}^{p} ( \frac{{w}_{i}}{{v}_{i}} ) \qquad ( 5.7 )$$

The value of β equals the number of microspheres processed per second, and therefore βt equals the population size. The maximum value of β is given by the inverse of Equation 5.2, i.e., the number of microspheres of processed per second using the real-time algorithm.

The exponential coefficient, k, is directly proportional to the optical diversity, σ, of the population of microspheres and inversely proportional to N:

k≈σN⁻¹ (5.8)

where σ=1 for random data (highest possible optical diversity) and σ=0.28 for the mixture of QFITC-coated and uncoated 4 μm blue-greenF microspheres (experimentally determined by varying N).

This cohesive series of equations allows the number of optically unique microspheres to be predicted for a given period of time. This is a valuable relationship as it allows the maximum library size (which is proportional to the number of unique microspheres) to be optimised by altering the variables involved in Equation 5.4. In addition, each of the variables, e.g., rl, rh, β, p, can be determined or estimated using the concepts and experiments described in this study.

Therefore, the feasibility of the proposed strategy can be predicted using Equation 5.4. Using the number of fluorescence parameters from Bigos et al. (1999, supra), p=9, while the values for rl and rh for these fluorophores can be estimated from Table E, thus rl=50 and rh=10. The value of β for nine parameters as given by Equation 5.2 is 265000 microspheres s⁻¹, however current maximum sorting rates in commercial flow cytometers are approximately 25000 microspheres s⁻¹, hence β=25000 microspheres s⁻¹. The value of k=0.28N for the QFITC-coated microspheres is representative of the optical diversity attainable using the synthetic methods in Example 3. As α and N are dependent on the width of the internal sort region, wᵢ, FIG. 28 displays the number of unique microspheres, U, as a function of w₁. The value oft is considered to be twenty-four hours for simplicity.

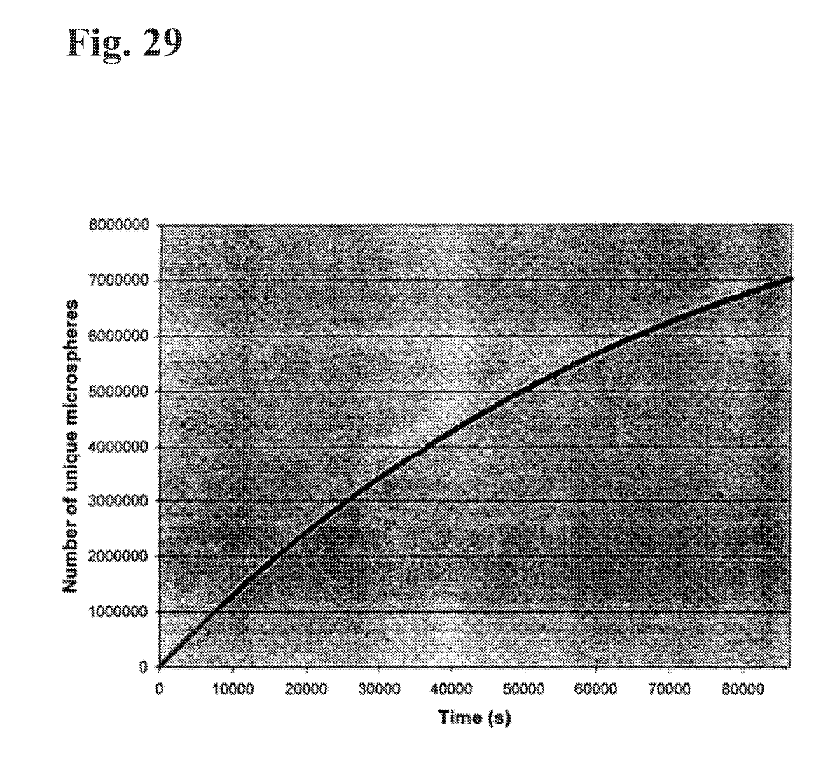

The maximum value of U for the above conditions therefore corresponds to an internal sort region width of 110. Note the sharp decrease from w₁=110 to wᵢ=111. The discontinuities present in FIG. 28 are due to the integer divisions required in Equation 32. Using wᵢ=110, the number of unique microspheres is expressed as a function of time over a 24 hour period in FIG. 29. Hence, after 24 hours, 7.02×10⁶ unique microspheres could be extracted. The practicalities of maintaining a flow cytometer at 25000 microspheres s⁻¹ for 24 hours would be difficult to overcome, e.g., a constant supply of sheath fluid and sample would be required. However, 2.00×10⁶ unique microspheres could be extracted in only 4½ hours, a much more realistic time frame. The time for all further analyses is equal to U/β seconds as every microsphere is collected. Hence it is the pre-encoding step that is rate-determining for the proposed strategy.

Two million optically unique microspheres will allow for the combinatorial synthesis of all 65536 possible oligonucleotides of eight nucleotides in length. This library could then be used for DNA sequencing by hybridisation. The presence of multiple or redundant microspheres improves the overall robustness of the proposed strategy, as all the redundant microspheres with the same compound should return similar results in the final screening process. In order to increase the maximum library size, smaller values of rl and rh, as well as a higher degree of optical diversity would be necessary. This could be achieved by more effective fluorescence compensation and redispersion of the microspheres in the same solvent that is used as sheath fluid to avoid the initial downward shift for all parameters after the first sort.

### Example 6

### Reproducibility Between Runs of Seven Aliquots of the Same Sample

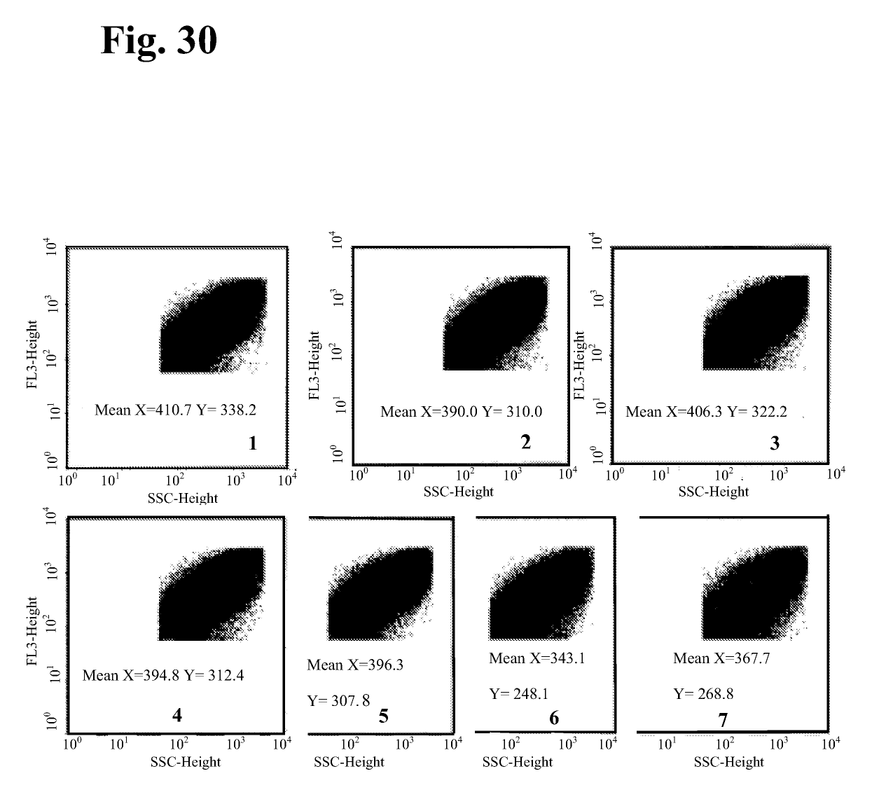

A sample of 15 μm fluorescent silica microspheres in Milli-Q™ water (Micromod, Cat. No. 40-15401, 10 μg/mL, NH₂ functionalised) was prepared and passed through a FACSCalibur™ flow cytometer (Becton Dickinson). Scattering and fluorescence signals inside a region (FIG. 30) for one million events were recorded. This was repeated with the same sample another six times, separated by 10 seconds between each run. The mean FL3 (red fluorescence), forward scatter and side scatter values were determined from all seven data sets. The average side scatter was 387 (standard deviation=23, 6%), the average forward scatter was 3003 (standard deviation=153, 5%) and the average FL3 value was 301 (standard deviation=31, 10%). These results indicate that there is a small variation in the mean values of the scattering/fluorescence signals from chosen sample.

### Example 7

### Non Fluorescent Microspheres Collected and Repassed Through the Flow Cytometer Give Reproducible Scattering Values

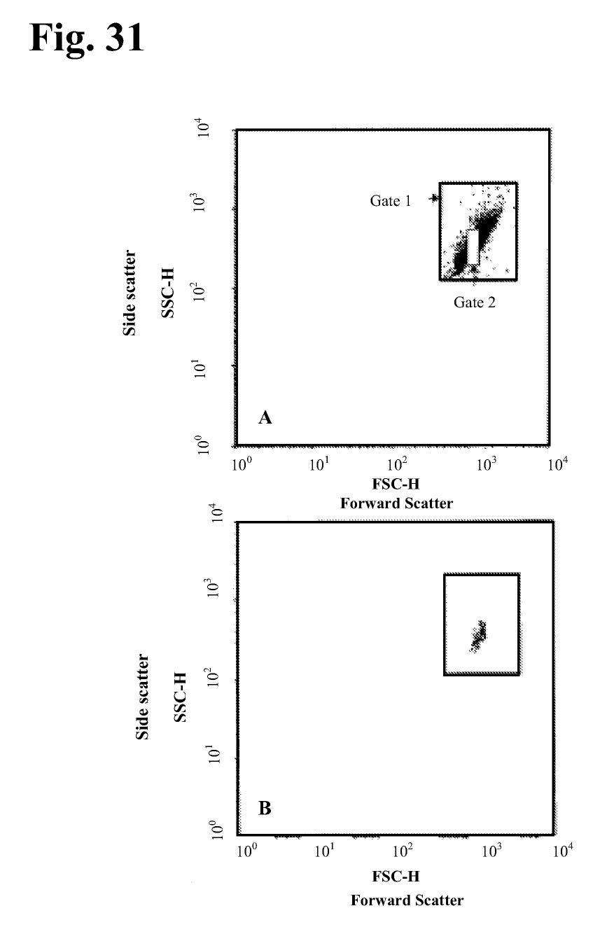

A sample of 10.2 μm polystyrene/divinylbenzene microspheres (Duke Scientific Corp., Cat. No. 7510A, CV=14.7%, 10 μg/mL in water) was passed through the flow cytometer. Two regions were set up. Microspheres in Region 1 were detected as events (FIG. 31, Panel A), but all were run to waste, except those in Region 2. The microspheres inside Region 2 were collected, reconcentrated by filtration in a size 5 filter (pore size 4-10 μm) and repassed through the flow cytometer (FIG. 31, Panel B) after removing the Region 2 gate. The microspheres were then free to appear anywhere inside Region 1. As shown in Panel B of this figure, the microspheres reappeared in the place where Region 2 was removed.

### Example 8

### Polystyrene 10.2 and 21 μm Microsphere Mixtures Collected and Repassed Through the Flow Cytometer Give Reproducible Scattering and Fluorescence Values

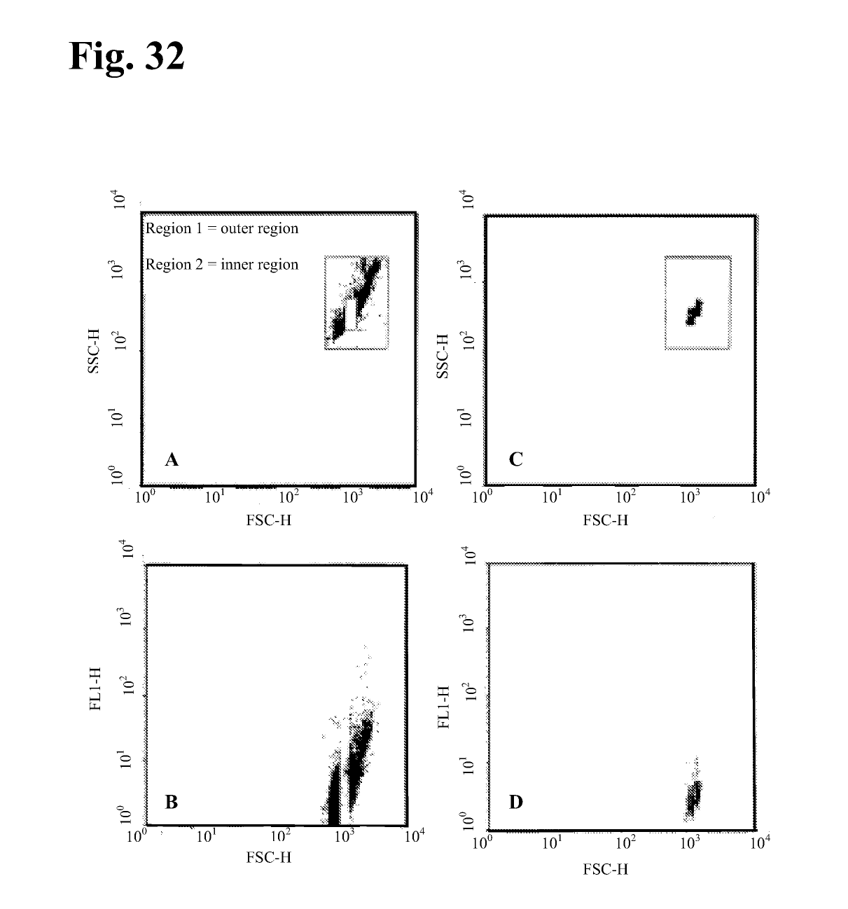

A mixture containing 10.2 μm polystyrene/divinylbenzene microspheres (Duke Scientific Corp., Cat. No. 7510A, CV=14.7%, 10 μg/mL in water) and 21 μm polystyrene/divinylbenzene microspheres (Duke Scientific Corp., Cat. No. 7520A, CV=14.7%, 10 μg/mL in water) was passed through the flow cytometer. Two regions were set up. Microspheres in Region 1 were detected as events (FIG. 32, Panels A, B), but all were run to waste, except those in. Region 2. The microspheres inside Region 2 were collected, reconcentrated by filtration in a size 5 filter (pore size 4-10 μm) and repassed through the flow cytometer (FIG. 32, Panels C, D) after removing the Region 2 gate. The microspheres were then free to appear anywhere inside Region 1. As shown in Panel B of FIG. 32, the microspheres reappeared in the place where Region 2 was removed. These results show that microspheres can be collected and repassed through the flow cytometer reproducibly using light scattering as an attribute.

### Example 9

### Fluorescent Green Polystyrene Microspheres Collected and Repassed Through the Flow Cytometer Give Reproducible Scattering and Fluorescence Values

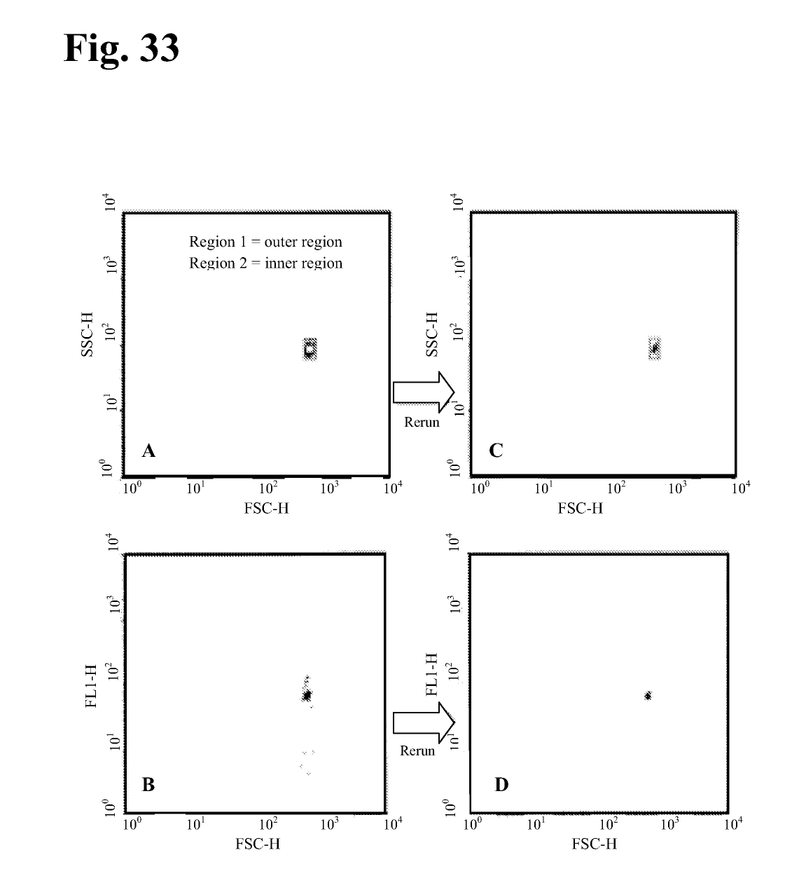

A sample of fluorescent green polystyrene microspheres (6 μm, Becton Dickinson Calibrite microspheres) was passed through the flow cytometer. Two regions were set up. Microspheres in Region 1 were detected as events (FIG. 33, Panel A and B), but all were run to waste, except those in Region 2. The microspheres inside Region 2 were collected, reconcentrated by filtration in a size 5 filter (pore size 4-10 μm) and repassed through the flow cytometer (FIG. 33, Panel C and D) after removing the Region 2 gate. The microspheres were then free to appear anywhere inside Region 1. As shown in Panel C, the microspheres reappeared in the place where Region 2 was removed. This shows that microspheres can be collected and repassed through the flow cytometer reproducibly using fluorescence as an attribute.

### Example 10

Non Fluorescent Polystyrene/Divinvlbenzene (DVB) Microspheres Swelled in DMF for 3 Hours and Returned to Milli-Q Water Give Scattering Values Similar to Those that have not been Subjected to DMF.

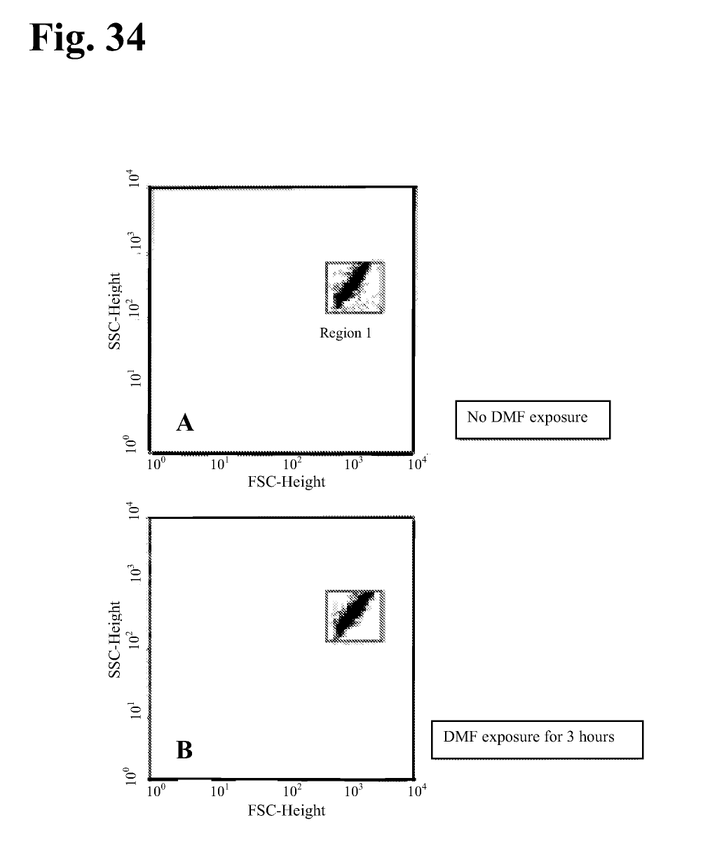

A sample of 10.2 μm polystyrene/divinylbenzene microspheres (Duke Scientific Corp., Cat. No. 7510A, CV=14.7%, 10 μg/mL in Milli-Q™ water) was passed through the flow cytometer and the side scatter and forward scatter of 10000 events inside Region 1 were recorded (FIG. 34, Panel A). The mean side scatter value was 1194 and the mean forward scatter value was 316.

A second sample of 10.2 μm polystyrene/divinylbenzene microspheres (Duke Scientific Corp., Cat. No. 7510A, CV=14.7%) was stirred in pure DMF for three hours before being transferred gradually back into Milli-Q™ water. The sample (10 μg/mL in water) was passed through the flow cytometer and the side scatter and forward scatter of 10000 events inside Region 1 were recorded (FIG. 34, Panel B). The mean side scatter value was 1224 and the mean forward scatter value was 316.

The mean forward scatter value for both samples was the same. The mean side scatter values were in close agreement, taking into account that a logarithmic scale was used and this normal kind of variation occurs in multiple runs of a sample.

### Example 11

Fluorescent Red Silica Microspheres Swelled in DMF for 3 Hours and Returned to Milli-Q Water Give Scattering and Fluorescence Values Similar to Those that have not been Subjected to DMF.

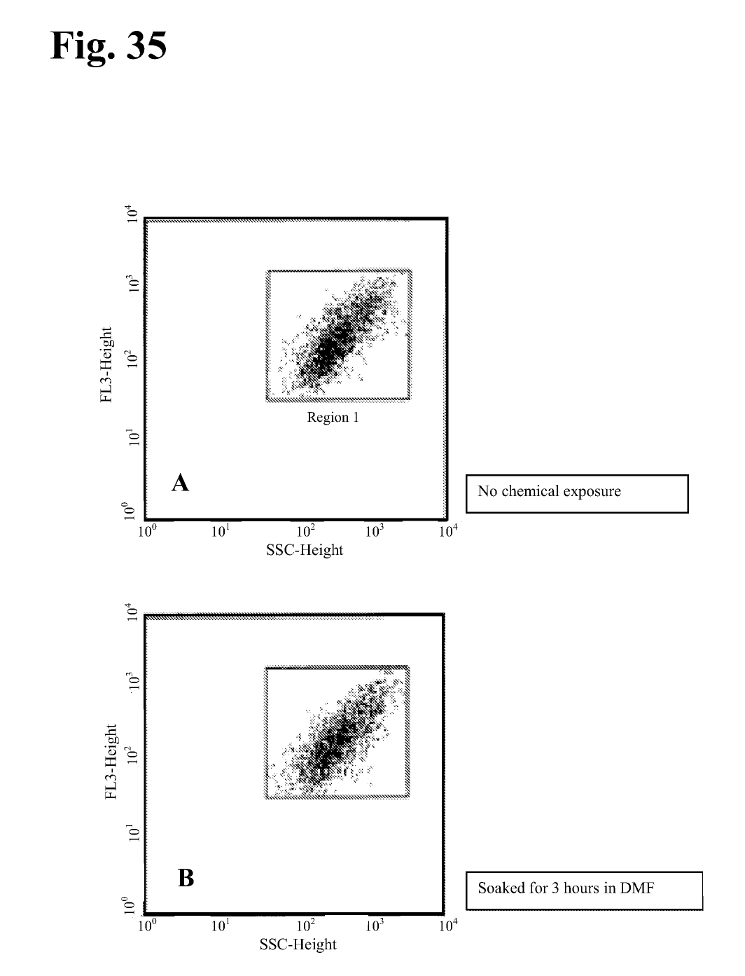

A sample of 15 μm fluorescent silica microspheres (Micromod, Cat. No. 40-15401, 10 μg/mL in water, NH₂ functionalised) was passed through the flow cytometer and the side scatter and FL3 (red fluorescence) of 10000 events inside Region 1 were recorded (FIG. 35, Panel A). Rhodamine B dye had been incorporated into the silica microspheres during microsphere synthesis. The mean FL3 (red fluorescence) value was 376 and the mean side scatter value was 253.

A second sample of 15 μm fluorescent silica microspheres (Micromod, Cat. No. 40-15401, 10 μg/mL in water, NH₂ functionalised) was stirred in pure DMF for three hours before being transferred gradually back into Milli-Q™ water. The sample (10 μg/mL in water) was passed through the flow cytometer and the side scatter and forward scatter of 10000 events inside Region 1 were recorded (FIG. 35, Panel B). The mean FL3 (red fluorescence) value was 379 and the mean side scatter value was 218.

### Example 12

Polystyrene/DVB Microspheres that have Undergone Amino Acid Couplings Give Similar Scattering and Fluorescence Values to Those that have not been Subjected to Coupling.

A sample of 20 μm Tentagel microspheres (Rapp Polymere GmbH, Tentagel M-NH₂, Cat. no. M 30 202, 10 mg) in Milli-Q™ water was prepared. This was carried out by first sonicating the microspheres in DCM for 10 minutes, transferring them gradually to

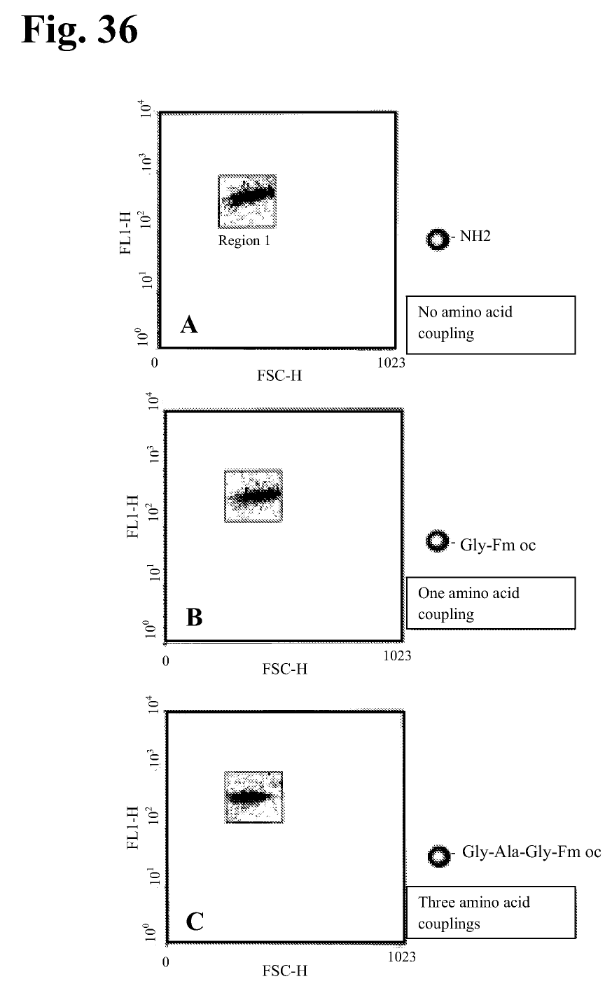

DMF, followed by gradual transfer to Milli-Q™ water. This method prevented clumping of the microspheres. The sample was passed through the flow cytometer and those in Region 1 were collected (FIG. 36, Panel A).

A second sample of 20 μm Tentagel microspheres (Rapp Polymere GmbH, Tentagel M-NH₂, Cat. no. M 30 202, 10 mg) was subjected to an amino acid coupling and then run through the flow cytometer. To prepare the sample, the microspheres were sonicated in DCM for 10 minutes and transferred gradually to DMF. Amino acid coupling to microspheres was performed using normal Fmoc chemistry (10 minutes with 150 mg Fmoc-Glycine-OH (Novabiochem), 1 mL HBTU and 120 μL DIEA). The microspheres were washed with DMF and gradually transferred to Milli-Q water. The microspheres reappeared inside region 1 when passed through the flow cytometer using the same instrument settings (FIG. 36, Panel B).

A third sample of 20 μm Tentagel microspheres (Rapp Polymere GmbH, Tentagel M-NH₂, Cat. no. M 30 202, 10 mg) was subjected to three amino acid couplings and then run through the flow cytometer. To prepare the sample, the microspheres were sonicated in DCM for 10 minutes and transferred gradually to DMF. Amino acid coupling to microspheres was performed using normal Fmoc chemistry (10 minutes with 150 mg Fmoc-Glycine-OH (Novabiochem), 1 mL HBTU and 120 μL DIEA). The microspheres were washed with DMF and the Fmoc protecting group was removed from the microspheres using piperidine/DMF (1:1) for 6 minutes. After washing with DMF, a second amino acid coupling was performed using normal Fmoc chemistry (10 minutes with 160 mg Fmoc-Alanine-OH (Novabiochem), 1 mL HBTU and 120 μL DIEA), followed by more DMF washing. The deprotection using piperidine/DMF was repeated and a third coupling was performed (10 minutes with 150 mg Fmoc-Glycine-OH (Novabiochem), 1 mL HBTU and 120 μL DIEA). After washing with DMF, the microspheres were transferred gradually to Milli-Q™ water and run through the flow cytometer. The microspheres reappeared inside region 1 when passed through the flow cytometer using the same instrument settings (FIG. 36, Panel C).

### Example 13

### Fluorescent Red Silica Microspheres Collected, Reacted With an Amino Acid and Repassed Through the Flow Cytometer Give Side Scatter and Red Fluorescence Values Before and After Coupling.

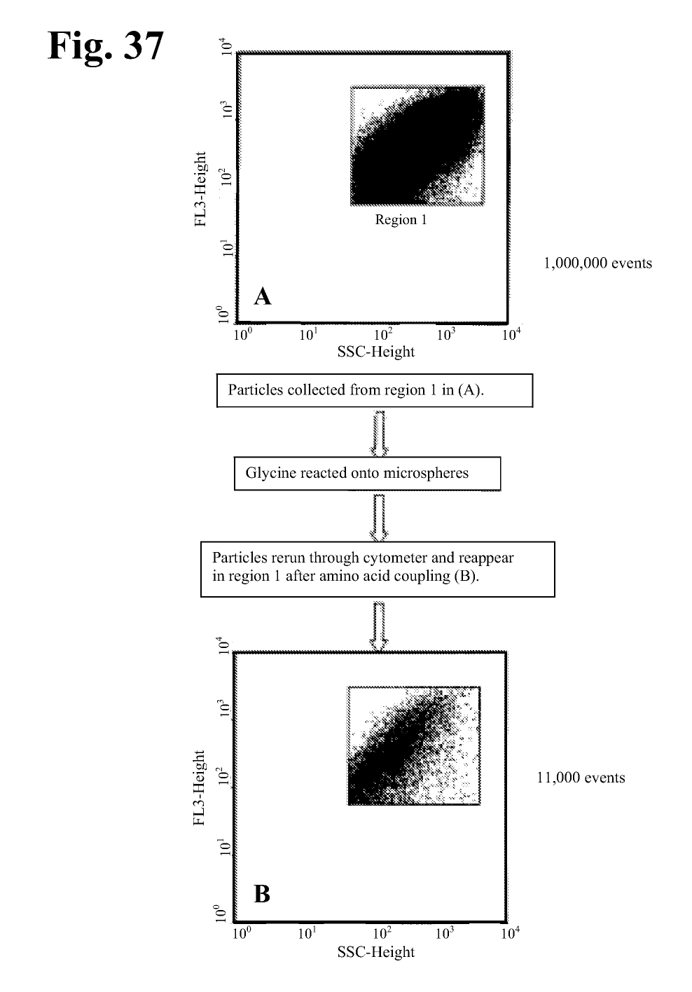

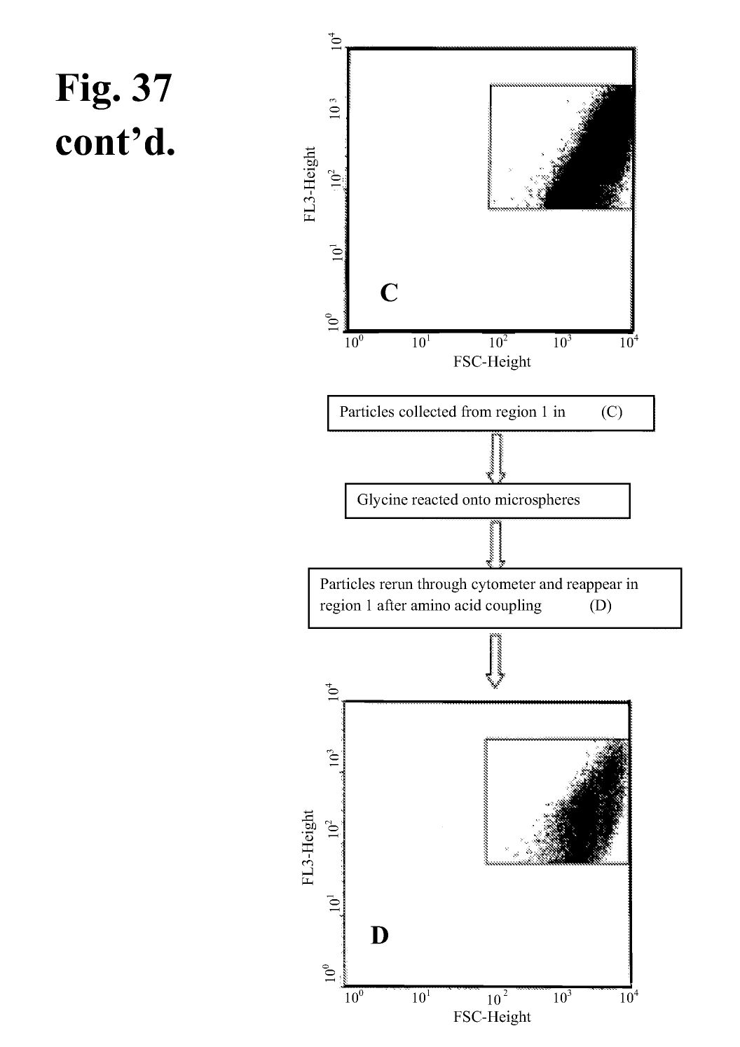

A sample of 15 μm fluorescent silica microspheres in Milli-Q™ water (Micromod, Cat. No. 40-15401, 10 μg/mL, NH₂ functionalised) was prepared and passed through the flow cytometer. Scattering and fluorescence signals inside Region 1 (FIG. 37, Panels A and C; microcapsglyrerun and microcapsglyrerunfs) for one million events were recorded and these particles were collected in a 50-mL centrifuge tube. The microspheres were concentrated by filtering through a size 5 filter (pore size 4-10 μm) and gradually transferred to DMF. Amino acid coupling to microspheres was performed using normal Fmoc chemistry (10 minutes with 150 mg Fmoc-Glycine-OH (Novabiochem), 1 mL HBTU and 120 μL DIEA). The microspheres were washed with DMF and gradually transferred to Milli-Q™ water. The microspheres reappeared inside region 1 when passed through the flow cytometer using the same instrument settings (Panels B and D).

### Example 14

### Method of Increasing Optodiversity by Permanently Attaching Small Fluorescent Microspheres to Carriers.

Polystyrene/divinylbenzene microspheres (10.2 μm Duke Scientific Corp., Cat. No. 7510A, CV=14.7%, 10 μg/mL in Milli-Q™ water) are mixed with green fluorescent microspheres (0.2 μm, Molecular Probes, latex, 20 μL). The red microspheres adhere to the larger microspheres and the excess small microspheres are removed by washing with Milli-Q™ water (5×20 mL).

To increase adherence, the fluorescent microspheres are coated with multilayers of polyelectrolyte prior to mixing with the 10.2 μm carriers. The procedure for coating the microspheres involves soaking for 24 hours in a 1% solution of polyethyleneimine (a positively charged polyelectrolyte), washing with Milli-Q™ water, soaking for 24 hours in a 1% solution of polyacrylic acid (a negatively charged polyelectrolyte), and washing.

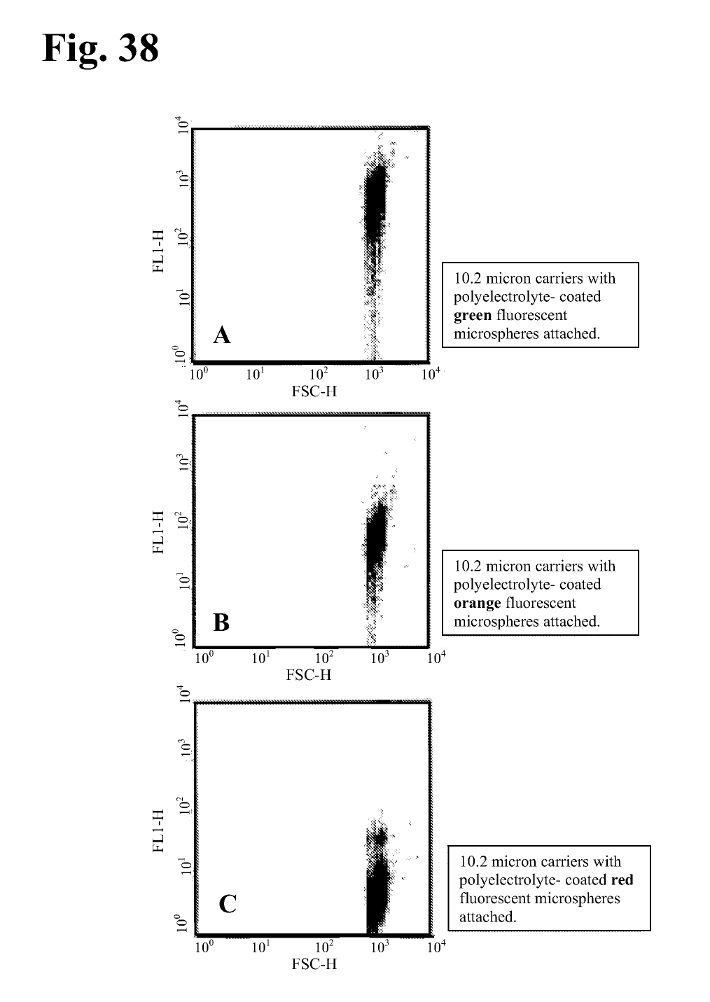

The carriers with the small fluorescent particles attached are passed through the flow cytometer and FL1 (green fluorescence) and forward scatter are measured (FIG. 38, Panel A). If orange or red fluorescent microspheres are used instead of green, the FL1 values of the carriers change (FIG. 38, Panel B and C).

Throughout the specification the aim has been to describe the preferred embodiments of the invention without limiting the invention to any one embodiment or specific collection of features. Those of skill in the art will therefore appreciate that, in light of the instant disclosure, various modifications and changes can be made in the particular embodiments exemplified without departing from the scope of the present invention. All such modifications and changes are intended to be included within the scope of the appendant claims.

1-62. (canceled)

63. A method of synthesizing and deconvoluting a combinatorial compound library comprising the steps of:
(a) apportioning in a stochastic manner among a plurality of reaction vessels a plurality of carriers on which a plurality of different compounds can be synthesized, said plurality of carriers comprising a population of detectably distinct carriers, each carrier pre-encoded with a code that distinctively identifies the carrier from other carriers and that is characterized by at least two detectable and/or quantifiable attributes integrally associated with the carrier, each of said attributes detectably varying among a plurality of individual carriers within the population of carriers, wherein one of said attributes is not shape or surface deformation of the carrier, and wherein said at least two detectable attributes comprise at least two light-emanating attributes comprising a light scattering feature and a molecular fluorescence feature,
wherein individual carriers comprise all the attributes that define their corresponding code before step (c);
(b) determining and recording the codes of said plurality of carriers in order to track the movement of individual detectably distinct carriers into particular reaction vessels of said plurality of reaction vessels, wherein said codes are determined prior to step (d);
(c) reacting the carriers of step (a) in each reaction vessel with a synthon;
(d) pooling the carriers from each reaction vessel;
(e) apportioning the pooled carriers of (d) in a stochastic manner among the plurality of reaction vessels;
(f) reacting the carriers in each reaction vessel of (e) with another synthon;
(g) recording the codes of said plurality of carriers in order to track the movement of individual detectably distinct carriers into particular reaction vessels of said plurality of reaction vessels, wherein said codes are recorded after step (e) or step (f);
(h) pooling the carriers from each reaction vessel; and
(i) iterating steps (e) through (h) to create a combinatorial compound library, wherein member compounds of the library are associated with the detectably distinct carriers and wherein codes of the detectably distinct carriers are deconvolutable using tracking data provided by said recordal steps (b) and (g) to identify the sequence of reactions experienced by the said detectably distinct carriers.

64. The method of claim 63, wherein at least one of said attributes of a respective carrier is within or internal to the carrier.

65. The method of claim 63, wherein in step (b), at least three different detectable and/or quantifiable attributes integrally associated with the carrier are detected and/or quantified for code recordal.

66. The method of claim 63, wherein at least one of said attributes of a respective carrier is an electromagnetic radiation-related attribute.

67. The method of claim 66, wherein in steps (b) and (g), the electromagnetic radiation-related attribute is selected from the group consisting of fluorescence emission, luminescence, phosphorescence, infrared radiation, electromagnetic scattering including light and X-ray scattering, light transmittance, light absorbance and electrical impedance.

68. The method of claim 67, wherein in steps (b) and (g), the electromagnetic radiation-related attribute is interrogated by illuminating the carrier with incident light of one or more selected wavelengths or of one or more selected vectors.

69. A method of producing a population of detectably distinct carriers on which a plurality of different polymers can be synthesized, each carrier pre-encoded with a code that distinctively identifies the carrier from other carriers in said population, comprising the steps of:
(a) preparing a plurality of carriers having a plurality of different codes, wherein each carrier has a code that identifies that carrier, said code characterized by at least two detectable and/or quantifiable attributes integrally associated with the carrier, each of said attributes detectably varying among a plurality of different individual carriers within the plurality of carriers, wherein one of said attributes is not shape or surface deformation of the carrier, and wherein said at least two detectable attributes comprise at least two light-emanating attributes comprising a light scattering feature and a molecular fluorescence feature;
(b) detecting said attributes of each carrier, thereby determining a code for each individual carrier;
(c) identifying a population of carriers having distinctive codes;
(d) identifying carriers having non-distinctive codes; and
(e) separating the carriers having distinctive codes from the carriers having non-distinctive codes to provide a population of detectably-distinct carriers.

70. The method of claim 69, wherein in step (a) said least two attributes of a respective carrier result from a split-process recombine procedure.

71. The method of claim 70, wherein in step (a), one or more of the said at least two attributes of a respective carrier is layered onto the carrier.

72. The method of claim 69, wherein at least one of said attributes of a respective carrier is within or internal to the carrier.

73. The method of claim 69, wherein in step (b), at least three different attributes of each carrier are detected.

74. The method of claim 69, wherein at least one of said attributes of a respective carrier is an electromagnetic radiation-related attribute.

75. The method of claim 74, wherein said electromagnetic radiation-related attribute is selected from the group consisting of fluorescence emission, luminescence, phosphorescence, infrared radiation, electromagnetic scattering including light and X-ray scattering, light transmittance, light absorbance and electrical impedance.

76. The method of claim 74, wherein in step (b), said electromagnetic radiation-related attribute is interrogated by illuminating the carrier with incident light of one or more selected wavelengths.

77. A method for directing the synthesis of a combinatorial library of oligomers, said method comprising the steps of:
(a) prior to coupling, assigning a predetermined oligomer sequence to each of a plurality of carriers, wherein each of said plurality of carriers comprises a distinguishable feature;
(b) sorting said plurality of carriers into a plurality of reaction vessels, wherein the vessel into which each carrier is sorted is determined by the oligomer assigned to each carrier based on said distinguishable feature, and wherein each carrier is sorted independently of the other carriers;
(c) performing a reaction to couple a chemical moiety to each carrier in each vessel, wherein the chemical moiety is the same or different in different vessels; and
(d) repeating steps (b) and (c) at least once, wherein, in each step, a subsequent chemical moiety is coupled to the previously added chemical moiety to produce a plurality of oligomers, thereby directing the synthesis of a combinatorial library of oligomers.

78. The method of claim 77, further comprising the step, between steps (c) and (d), of pooling the carriers in each of said vessels.

79. The method of claim 77, wherein each carrier in said plurality of carriers comprises a unique distinguishable feature.

80. The method of claim 77, wherein said chemical moiety comprises a deoxyribonucleotide, a ribonucleotide, an amino acid, a saccharide, a peptide nucleic acid, a carbonate, a sulphone, a sulfoxide, a nucleoside, a carbohydrate, a urea, a phosphonate, a lipid, or an ester.

81. The method of claim 77, wherein prior to step (c), a cleavable linker is coupled to each of said plurality of carriers.

82. The method of claim 81, further comprising step (e), cleaving at least one of said plurality of oligomers from one of said plurality of carriers.
